(19) United States
(12) Patent Application Publication
(10) Pub. No.: US 2023/0137523 A1
(43) Pub. Date: May 4, 2023

(54) Transport Block over Multiple Slots

(71) Applicant: Alireza Babaei, Fairfax, VA (US)

(72) Inventor: Alireza Babaei, Fairfax, VA (US)

(21) Appl. No.: 17/977,077

(22) Filed: Oct. 31, 2022

Related U.S. Application Data
(60) Provisional application No. 63/274,863, filed on Nov. 2, 2021.

(51) Int. Cl. H04W 72/04

(52) U.S. Cl. CPC H04W 72/042; H04W 72/0446

(57) ABSTRACT

A wireless device may receive downlink control information indicating scheduling information for transmission of a TB via a cell and processing the TB for transmission over multiple slots. The wireless device may determine a time alignment timer, associated with the cell, is running at least until a first slot of the multiple slots. Based on the determination, the wireless device may transmit the TB over the multiple slots.

### CROSS-REFERENCE TO RELATED APPLICATIONS

This application claims the benefit of U.S. Provisional Application No. 63/274,863, filed Nov. 2, 2021, which is hereby incorporated by reference in its entirety.

### BRIEF DESCRIPTION OF THE DRAWINGS

FIG. 1A and FIG. 1B show examples of mobile communications systems in accordance with several of various embodiments of the present disclosure.

FIG. 2A and FIG. 2B show examples of user plane and control plane protocol layers in accordance with several of various embodiments of the present disclosure.

FIG. 3 shows example functions and services offered by protocol layers in a user plane protocol stack in accordance with several of various embodiments of the present disclosure.

FIG. 4 shows example flow of packets through the protocol layers in accordance with several of various embodiments of the present disclosure.

FIG. 5A shows example mapping of channels between layers of the protocol stack and different physical signals in downlink in accordance with several of various embodiments of the present disclosure.

FIG. 5B shows example mapping of channels between layers of the protocol stack and different physical signals in uplink in accordance with several of various embodiments of the present disclosure.

FIG. 6 shows example physical layer processes for signal transmission in accordance with several of various embodiments of the present disclosure.

FIG. 7 shows examples of RRC states and RRC state transitions in accordance with several of various embodiments of the present disclosure.

FIG. 8 shows an example time domain transmission structure in NR by grouping OFDM symbols into slots, subframes and frames in accordance with several of various embodiments of the present disclosure.

FIG. 9 shows an example of time-frequency resource grid in accordance with several of various embodiments of the present disclosure.

FIG. 10 shows example adaptation and switching of bandwidth parts in accordance with several of various embodiments of the present disclosure.

FIG. 11A shows example arrangements of carriers in carrier aggregation in accordance with several of various embodiments of the present disclosure.

FIG. 11B shows examples of uplink control channel groups in accordance with several of various embodiments of the present disclosure.

FIG. 12A, FIG. 12B and FIG. 12C show example random access processes in accordance with several of various embodiments of the present disclosure.

FIG. 13A shows example time and frequency structure of SSBs and their associations with beams in accordance with several of various embodiments of the present disclosure.

FIG. 13B shows example time and frequency structure of CSI-RSs and their association with beams in accordance with several of various embodiments of the present disclosure.

FIG. 14A, FIG. 14B and FIG. 14C show example beam management processes in accordance with several of various embodiments of the present disclosure.

FIG. 15 shows example components of a wireless device and a base station that are in communication via an air interface in accordance with several of various embodiments of the present disclosure.

FIG. 16 shows an example process in accordance with several of various embodiments of the present disclosure.

FIG. 17 shows an example process in accordance with several of various embodiments of the present disclosure.

FIG. 18 shows an example process in accordance with several of various embodiments of the present disclosure.

FIG. 19 shows an example process in accordance with several of various embodiments of the present disclosure.

FIG. 20 shows an example process in accordance with several of various embodiments of the present disclosure.

FIG. 21 shows an example process in accordance with several of various embodiments of the present disclosure.

FIG. 22 shows an example process in accordance with several of various embodiments of the present disclosure.

FIG. 23 shows an example process in accordance with several of various embodiments of the present disclosure.

FIG. 24 shows an example process in accordance with several of various embodiments of the present disclosure.

FIG. 25 shows an example process in accordance with several of various embodiments of the present disclosure.

FIG. 26 shows an example process in accordance with several of various embodiments of the present disclosure.

FIG. 27 shows an example flow diagram in accordance with several of various embodiments of the present disclosure.

FIG. 28 shows an example flow diagram in accordance with several of various embodiments of the present disclosure.

FIG. 29 shows an example flow diagram in accordance with several of various embodiments of the present disclosure.

FIG. 30 shows an example flow diagram in accordance with several of various embodiments of the present disclosure.

FIG. 31 shows an example flow diagram in accordance with several of various embodiments of the present disclosure.

FIG. 32 shows an example flow diagram in accordance with several of various embodiments of the present disclosure.

FIG. 33 shows an example flow diagram in accordance with several of various embodiments of the present disclosure.

FIG. 34 shows an example flow diagram in accordance with several of various embodiments of the present disclosure.

FIG. 35 shows an example flow diagram in accordance with several of various embodiments of the present disclosure.

### DETAILED DESCRIPTION

The exemplary embodiments of the disclosed technology enable transmission and/or reception of a transport block over multiple slots (TBoMS) by a wireless device and/or one or more base stations. The exemplary disclosed embodiments may be implemented in the technical field of wireless communication systems. More particularly, the embodiments of the disclosed technology may enhance processes associated with TBoMS, including TBoMS transmission, dropping/cancellation of at least a portion of TBoMS based on one or more conditions, control information transmission with TBoMS, logical channel data multiplexing in TBoMS, uplink time alignment, etc.

The devices and/or nodes of the mobile communications system disclosed herein may be implemented based on various technologies and/or various releases/versions/amendments of a technology. The various technologies include various releases of long-term evolution (LTE) technologies, various releases of 5G new radio (NR) technologies, various wireless local area networks technologies and/or a combination thereof and/or alike. For example, a base station may support a given technology and may communicate with wireless devices with different characteristics. The wireless devices may have different categories that define their capabilities in terms of supporting various features. The wireless device with the same category may have different capabilities. The wireless devices may support various technologies such as various releases of LTE technologies, various releases of 5G NR technologies and/or a combination thereof and/or alike. At least some of the wireless devices in the mobile communications system of the present disclosure may be stationary or almost stationary. In this disclosure, the terms “mobile communications system” and “wireless communications system” may be used interchangeably.

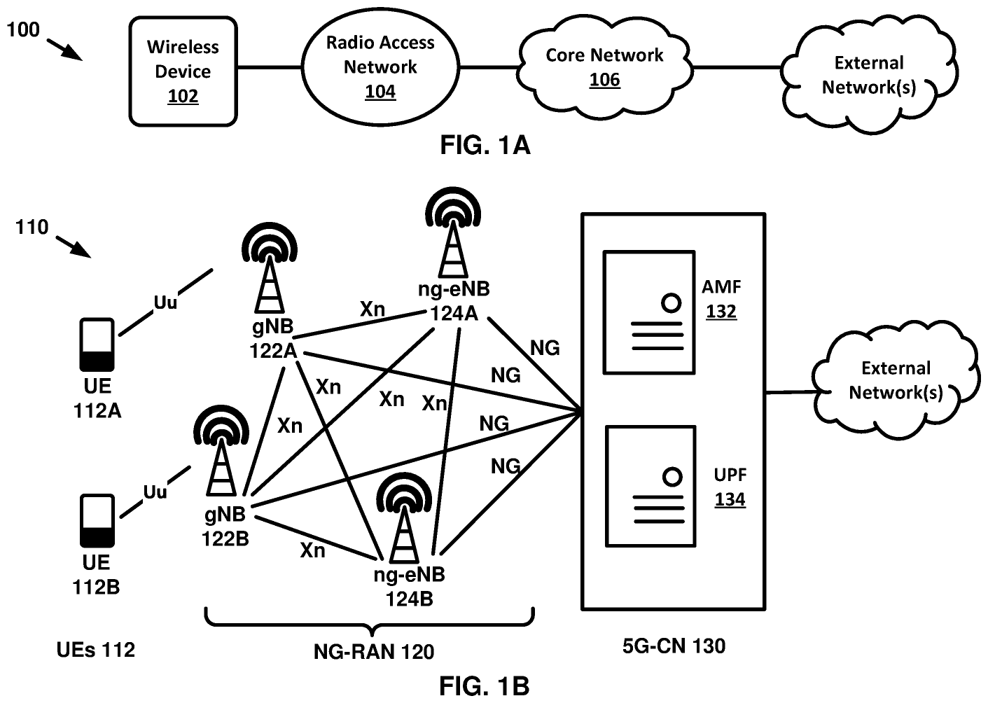

FIG. 1A shows an example of a mobile communications system 100 in accordance with several of various embodiments of the present disclosure. The mobile communications system 100 may be, for example, run by a mobile network operator (MNO) or a mobile virtual network operator (MVNO). The mobile communications system 100 may be a public land mobile network (PLMN) run by a network operator providing a variety of service including voice, data, short messaging service (SMS), multimedia messaging service (MMS), emergency calls, etc. The mobile communications system 100 includes a core network (CN) 106, a radio access network (RAN) 104 and at least one wireless device 102.

The CN 106 connects the RAN 104 to one or more external networks (e.g., one or more data networks such as the Internet) and is responsible for functions such as authentication, charging and end-to-end connection establishment. Several radio access technologies (RATs) may be served by the same CN 106.

The RAN 104 may implement a RAT and may operate between the at least one wireless device 102 and the CN 106. The RAN 104 may handle radio related functionalities such as scheduling, radio resource control, modulation and coding, multi-antenna transmissions and retransmission protocols. The wireless device and the RAN may share a portion of the radio spectrum by separating transmissions from the wireless device to the RAN and the transmissions from the RAN to the wireless device. The direction of the transmissions from the wireless device to the RAN is known as the uplink and the direction of the transmissions from the RAN to the wireless device is known as the downlink. The separation of uplink and downlink transmissions may be achieved by employing a duplexing technique. Example duplexing techniques include frequency division duplexing (FDD), time division duplexing (TDD) or a combination of FDD and TDD.

In this disclosure, the term wireless device may refer to a device that communicates with a network entity or another device using wireless communication techniques. The wireless device may be a mobile device or a non-mobile (e.g., fixed) device. Examples of the wireless device include cellular phone, smart phone, tablet, laptop computer, wearable device (e.g., smart watch, smart shoe, fitness trackers, smart clothing, etc.), wireless sensor, wireless meter, extended reality (XR) devices including augmented reality (AR) and virtual reality (VR) devices, Internet of Things (IoT) device, vehicle to vehicle communications device, road-side units (RSU), automobile, relay node or any combination thereof. In some examples, the wireless device (e.g., a smart phone, tablet, etc.) may have an interface (e.g., a graphical user interface (GUI)) for configuration by an end user. In some examples, the wireless device (e.g., a wireless sensor device, etc.) may not have an interface for configuration by an end user. The wireless device may be referred to as a user equipment (UE), a mobile station (MS), a subscriber unit, a handset, an access terminal, a user terminal, a wireless transmit and receive unit (WTRU) and/or other terminology.

The at least one wireless device may communicate with at least one base station in the RAN 104. In this disclosure, the term base station may encompass terminologies associated with various RATs. For example, a base station may be referred to as a Node B in a 3G cellular system such as Universal Mobile Telecommunication Systems (UMTS), an evolved Node B (eNB) in a 4G cellular system such as evolved universal terrestrial radio access (E-UTRA), a next generation eNB (ng-eNB), a Next Generation Node B (gNB) in NR and/or a 5G system, an access point (AP) in Wi-Fi and/or other wireless local area networks. A base station may be referred to as a remote radio head (RRH), a baseband unit (BBU) in connection with one or more RRHs, a repeater or relay for coverage extension and/or any combination thereof. In some examples, all protocol layers of a base station may be implemented in one unit. In some examples, some of the protocol layers (e.g., upper layers) of the base station may be implemented in a first unit (e.g., a central unit (CU)) and some other protocol layer (e.g., lower layers) may be implemented in one or more second units (e.g., distributed units (DUs)).

A base station in the RAN 104 includes one or more antennas to communicate with the at least one wireless device. The base station may communicate with the at least one wireless device using radio frequency (RF) transmissions and receptions via RF transceivers. The base station antennas may control one or more cells (or sectors). The size and/or radio coverage area of a cell may depend on the range that transmissions by a wireless device can be successfully received by the base station when the wireless device transmits using the RF frequency of the cell. The base station may be associated with cells of various sizes. At a given location, the wireless device may be in coverage area of a first cell of the base station and may not be in coverage area of a second cell of the base station depending on the sizes of the first cell and the second cell.

A base station in the RAN 104 may have various implementations. For example, a base station may be implemented by connecting a BBU (or a BBU pool) coupled to one or more RRHs and/or one or more relay nodes to extend the cell coverage. The BBU pool may be located at a centralized site like a cloud or data center. The BBU pool may be connected to a plurality of RRHs that control a plurality of cells. The combination of BBU with the one or more RRHs may be referred to as a centralized or cloud RAN (C-RAN) architecture. In some implementations, the BBU functions may be implemented on virtual machines (VMs) on servers at a centralized location. This architecture may be referred to as virtual RAN (vRAN). All, most or a portion of the protocol layer functions (e.g., all or portions of physical layer, medium access control (MAC) layer and/or higher layers) may be implemented at the BBU pool and the processed data may be transmitted to the RRHs for further processing and/or RF transmission. The links between the BBU pool and the RRHs may be referred to as fronthaul.

In some deployment scenarios, the RAN 104 may include macrocell base stations with high transmission power levels and large coverage areas. In other deployment scenarios, the RAN 104 may include base stations that employ different transmission power levels and/or have cells with different coverage areas. For example, some base station may be macrocell base stations with high transmission powers and/or large coverage areas and other base station may be small cell base stations with comparatively smaller transmission powers and/or coverage areas. In some deployment scenarios, a small cell base station may have coverage that is within or has overlap with coverage area of a macrocell base station. A wireless device may communicate with the macrocell base station while within the coverage area of the macrocell base station. For additional capacity, the wireless device may communicate with both the macrocell base station and the small cell base station while in the overlapped coverage area of the macrocell base station and the small cell base station. Depending on their coverage areas, a small cell base station may be referred to as a microcell base station, a picocell base station, a femtocell base station or a home base station.

Different standard development organizations (SDOs) have specified, or may specify in future, mobile communications systems that have similar characteristics as the mobile communications system 100 of FIG. 1A. For example, the Third-Generation Partnership Project (3GPP) is a group of SDOs that provides specifications that define 3GPP technologies for mobile communications systems that are akin to the mobile communications system 100. The 3GPP has developed specifications for third generation (3G) mobile networks, fourth generation (4G) mobile networks and fifth generation (5G) mobile networks. The 3G, 4G and 5G networks are also known as Universal Mobile Telecommunications System (UMTS), Long Term Evolution (LTE) and 5G system (5GS), respectively. In this disclosure, embodiments are described with respect to the RAN implemented in a 3GPP 5G mobile network that is also referred to as next generation RAN (NG-RAN). The embodiments may also be implemented in other mobile communications systems such as 3G or 4G mobile networks or mobile networks that may be standardized in future such as sixth generation (6G) mobile networks or mobile networks that are implemented by standards bodies other than 3GPP. The NG-RAN may be based on a new RAT known as new radio (NR) and/or other radio access technologies such as LTE and/or non-3GPP RATs.

FIG. 1B shows an example of a mobile communications system 110 in accordance with several of various embodiments of the present disclosure. The mobile communications system 110 of FIG. 1B is an example of a 5G mobile network and includes a 5G CN (5G-CN) 130, an NG-RAN 120 and UEs (collectively 112 and individually UE 112A and UE 112B). The 5G-CN 130, the NG-RAN 120 and the UEs 112 of FIG. 1B operate substantially alike the CN 106, the RAN 104 and the at least one wireless device 102, respectively, as described for FIG. 1A.

The 5G-CN 130 of FIG. 1B connects the NG-RAN 120 to one or more external networks (e.g., one or more data networks such as the Internet) and is responsible for functions such as authentication, charging and end-to-end connection establishment. The 5G-CN has new enhancements compared to previous generations of CNs (e.g., evolved packet core (EPC) in the 4G networks) including service-based architecture, support for network slicing and control plane/user plane split. The service-based architecture of the 5G-CN provides a modular framework based on service and functionalities provided by the core network wherein a set of network functions are connected via service-based interfaces. The network slicing enables multiplexing of independent logical networks (e.g., network slices) on the same physical network infrastructure. For example, a network slice may be for mobile broadband applications with full mobility support and a different network slice may be for non-mobile latency-critical applications such as industry automation. The control plane/user plane split enables independent scaling of the control plane and the user plane. For example, the control plane capacity may be increased without affecting the user plane of the network.

The 5G-CN 130 of FIG. 1B includes an access and mobility management function (AMF) 132 and a user plane function (UPF) 134. The AMF 132 may support termination of non-access stratum (NAS) signaling, NAS signaling security such as ciphering and integrity protection, inter-3GPP access network mobility, registration management, connection management, mobility management, access authentication and authorization and security context management. The NAS is a functional layer between a UE and the CN and the access stratum (AS) is a functional layer between the UE and the RAN. The UPF 134 may serve as an interconnect point between the NG-RAN and an external data network. The UPF may support packet routing and forwarding, packet inspection and Quality of Service (QoS) handling and packet filtering. The UPF may further act as a Protocol Data Unit (PDU) session anchor point for mobility within and between RATs.

The 5G-CN 130 may include additional network functions (not shown in FIG. 1B) such as one or more Session Management Functions (SMFs), a Policy Control Function (PCF), a Network Exposure Function (NEF), a Unified Data Management (UDM), an Application Function (AF), and/or an Authentication Server Function (AUSF). These network functions along with the AMF 132 and UPF 134 enable a service-based architecture for the 5G-CN.

The NG-RAN 120 may operate between the UEs 112 and the 5G-CN 130 and may implement one or more RATs. The NG-RAN 120 may include one or more gNBs (e.g., gNB 122A or gNB 122B or collectively gNBs 122) and/or one or more ng-eNBs (e.g., ng-eNB 124A or ng-eNB 124B or collectively ng-eNBs 124). The general terminology for gNBs 122 and/or an ng-eNBs 124 is a base station and may be used interchangeably in this disclosure. The gNBs 122 and the ng-eNBs 124 may include one or more antennas to communicate with the UEs 112. The one or more antennas of the gNBs 122 or ng-eNBs 124 may control one or more cells (or sectors) that provide radio coverage for the UEs 112.

A gNB and/or an ng-eNB of FIG. 1B may be connected to the 5G-CN 130 using an NG interface. A gNB and/or an ng-eNB may be connected with other gNBs and/or ng-eNBs using an Xn interface. The NG or the Xn interfaces are logical connections that may be established using an underlying transport network. The interface between a UE and a gNB or between a UE and an ng-eNBs may be referred to as the Uu interface. An interface (e.g., Uu, NG or Xn) may be established by using a protocol stack that enables data and control signaling exchange between entities in the mobile communications system of FIG. 1B. When a protocol stack is used for transmission of user data, the protocol stack may be referred to as user plane protocol stack. When a protocol stack is used for transmission of control signaling, the protocol stack may be referred to as control plane protocol stack. Some protocol layer may be used in both of the user plane protocol stack and the control plane protocol stack while other protocol layers may be specific to the user plane or control plane.

The NG interface of FIG. 1B may include an NG-User plane (NG-U) interface between a gNB and the UPF 134 (or an ng-eNB and the UPF 134) and an NG-Control plane (NG-C) interface between a gNB and the AMF 132 (or an ng-eNB and the AMF 132). The NG-U interface may provide non-guaranteed delivery of user plane PDUs between a gNB and the UPF or an ng-eNB and the UPF. The NG-C interface may provide services such as NG interface management, UE context management, UE mobility management, transport of NAS messages, paging, PDU session management, configuration transfer and/or warning message transmission.

The UEs 112 and a gNB may be connected using the Uu interface and using the NR user plane and control plane protocol stack. The UEs 112 and an ng-eNB may be connected using the Uu interface using the LTE user plane and control plane protocol stack.

In the example mobile communications system of FIG. 1B, a 5G-CN is connected to a RAN comprised of 4G LTE and/or 5G NR RATs. In other example mobile communications systems, a RAN based on the 5G NR RAT may be connected to a 4G CN (e.g., EPC). For example, earlier releases of 5G standards may support a non-standalone mode of operation where a NR based RAN is connected to the 4G EPC. In an example non-standalone mode, a UE may be connected to both a 5G NR gNB and a 4G LTE eNB (e.g., a ng-eNB) and the control plane functionalities (such as initial access, paging and mobility) may be provided through the 4G LTE eNB. In a standalone of operation, the 5G NR gNB is connected to a 5G-CN and the user plane and the control plane functionalities are provided by the 5G NR gNB.

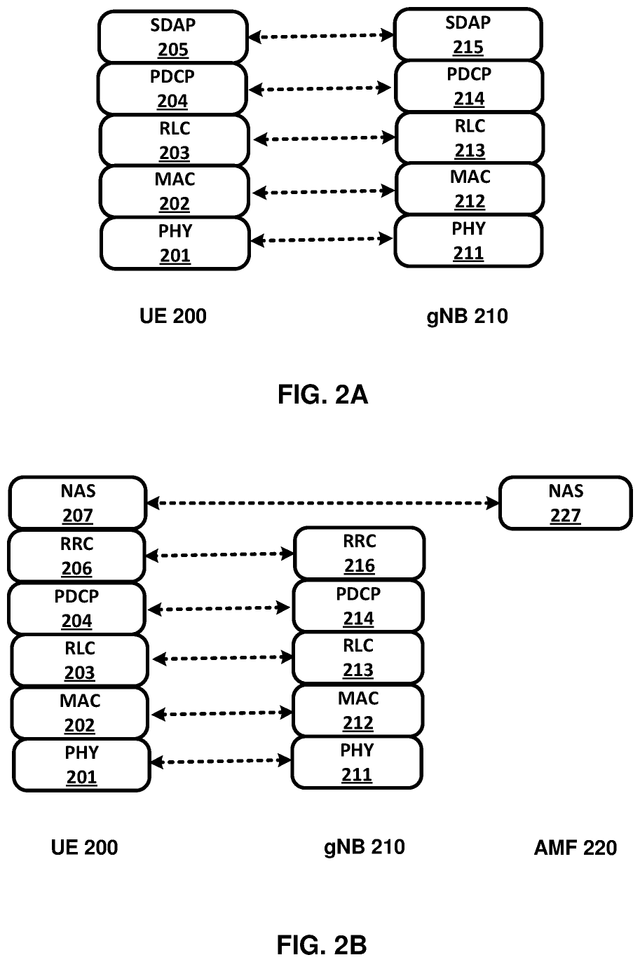

FIG. 2A shows an example of the protocol stack for the user plan of an NR Uu interface in accordance with several of various embodiments of the present disclosure. The user plane protocol stack comprises five protocol layers that terminate at the UE 200 and the gNB 210. The five protocol layers, as shown in FIG. 2A, include physical (PHY) layer referred to as PHY 201 at the UE 200 and PHY 211 at the gNB 210, medium access control (MAC) layer referred to as MAC 202 at the UE 200 and MAC 212 at the gNB 210, radio link control (RLC) layer referred to as RLC 203 at the UE 200 and RLC 213 at the gNB 210, packet data convergence protocol (PDCP) layer referred to as PDCP 204 at the UE 200 and PDCP 214 at the gNB 210, and service data application protocol (SDAP) layer referred to as SDAP 205 at the UE 200 and SDAP 215 at the gNB 210. The PHY layer, also known as layer 1 (L1), offers transport services to higher layers. The other four layers of the protocol stack (MAC, RLC, PDCP and SDAP) are collectively known as layer 2 (L2).

FIG. 2B shows an example of the protocol stack for the control plan of an NR Uu interface in accordance with several of various embodiments of the present disclosure. Some of the protocol layers (PHY, MAC, RLC and PDCP) are common between the user plane protocol stack shown in FIG. 2A and the control plan protocol stack. The control plane protocol stack also includes the RRC layer, referred to RRC 206 at the UE 200 and RRC 216 at the gNB 210, that also terminates at the UE 200 and the gNB 210. In addition, the control plane protocol stack includes the NAS layer that terminates at the UE 200 and the AMF 220. In FIG. 2B, the NAS layer is referred to as NAS 207 at the UE 200 and NAS 227 at the AMF 220.

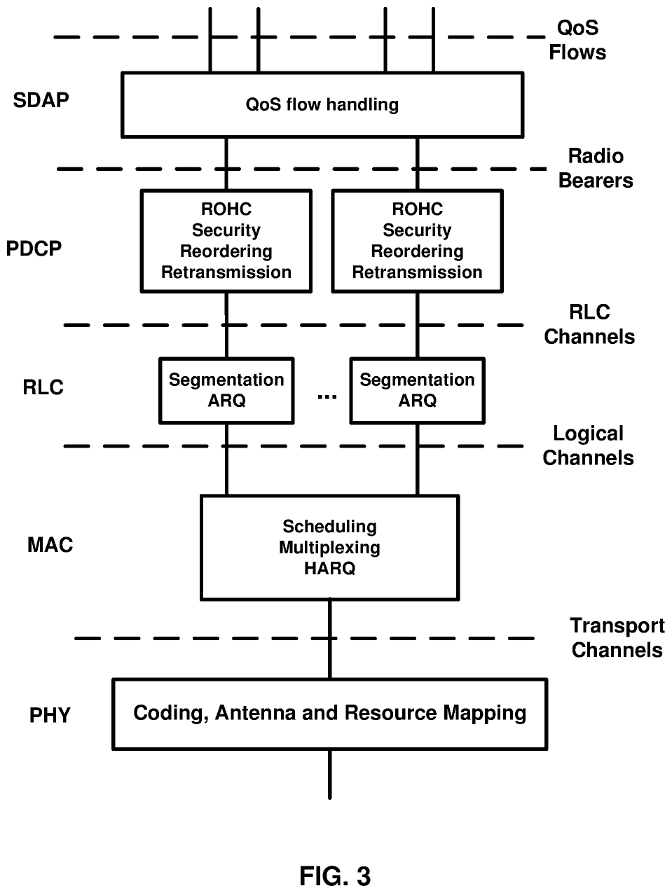

FIG. 3 shows example functions and services offered to other layers by a layer in the NR user plane protocol stack of FIG. 2A in accordance with several of various embodiments of the present disclosure. For example, the SDAP layer of FIG. 3 (shown in FIG. 2A as SDAP 205 at the UE side and SDAP 215 at the gNB side) may perform mapping and de-mapping of QoS flows to data radio bearers. The mapping and de-mapping may be based on QoS (e.g., delay, throughput, jitter, error rate, etc.) associated with a QoS flow. A QoS flow may be a QoS differentiation granularity for a PDU session which is a logical connection between a UE 200 and a data network. A PDU session may contain one or more QoS flows. The functions and services of the SDAP layer include mapping and de-mapping between one or more QoS flows and one or more data radio bearers. The SDAP layer may also mark the uplink and/or downlink packets with a QoS flow ID (QFI).

The PDCP layer of FIG. 3 (shown in FIG. 2A as PDCP 204 at the UE side and PDCP 214 at the gNB side) may perform header compression and decompression (e.g., using Robust Header Compression (ROHC) protocol) to reduce the protocol header overhead, ciphering and deciphering and integrity protection and verification to enhance the security over the air interface, reordering and in-order delivery of packets and discarding of duplicate packets. A UE may be configured with one PDCP entity per bearer.

In an example scenario not shown in FIG. 3, a UE may be configured with dual connectivity and may connect to two different cell groups provided by two different base stations. For example, a base station of the two base stations may be referred to as a master base station and a cell group provided by the master base station may be referred to as a master cell group (MCG). The other base station of the two base stations may be referred to as a secondary base station and the cell group provided by the secondary base station may be referred to as a secondary cell group (SCG). A bearer may be configured for the UE as a split bearer that may be handled by the two different cell groups. The PDCP layer may perform routing of packets corresponding to a split bearer to and/or from RLC channels associated with the cell groups.

In an example scenario not shown in FIG. 3, a bearer of the UE may be configured (e.g., with control signaling) with PDCP packet duplication. A bearer configured with PDCP duplication may be mapped to a plurality of RLC channels each corresponding to different one or more cells. The PDCP layer may duplicate packets of the bearer configured with PDCP duplication and the duplicated packets may be mapped to the different RLC channels. With PDCP packet duplication, the likelihood of correct reception of packets increases thereby enabling higher reliability.

The RLC layer of FIG. 3 (shown in FIG. 2A as RLC 203 at the UE side and RLC 213 at the gNB side) provides service to upper layers in the form of RLC channels. The RLC layer may include three transmission modes: transparent mode (TM), Unacknowledged mode (UM) and Acknowledged mode (AM). The RLC layer may perform error correction through automatic repeat request (ARQ) for the AM transmission mode, segmentation of RLC service data units (SDUs) for the AM and UM transmission modes and re-segmentation of RLC SDUs for AM transmission mode, duplicate detection for the AM transmission mode, RLC SDU discard for the AM and UM transmission modes, etc. The UE may be configured with one RLC entity per RLC channel.

The MAC layer of FIG. 3 (shown in FIG. 2A as MAC 202 at the UE side and MAC 212 at the gNB side) provides services to the RLC layer in form of logical channels. The MAC layer may perform mapping between logical channels and transport channels, multiplexing/demultiplexing of MAC SDUs belonging to one or more logical channels into/from transport blocks (TBs) delivered to/from the physical layer on transport channels, reporting of scheduling information, error correction through hybrid automatic repeat request (HARQ), priority handling between UEs by means of dynamic scheduling, priority handling between logical channels of one UE by means of logical channel prioritization and/or padding. In case of carrier aggregation, a MAC entity may comprise one HARQ entity per cell. A MAC entity may support multiple numerologies, transmission timings and cells. The control signaling may configure logical channels with mapping restrictions. The mapping restrictions in logical channel prioritization may control the numerology(ies), cell(s), and/or transmission timing(s)/duration(s) that a logical channel may use.

The PHY layer of FIG. 3 (shown in FIG. 2A as PHY 201 at the UE side and PHY 211 at the gNB side) provides transport services to the MAC layer in form of transport channels. The physical layer may handle coding/decoding, HARQ soft combining, rate matching of a coded transport channel to physical channels, mapping of coded transport channels to physical channels, modulation and demodulation of physical channels, frequency and time synchronization, radio characteristics measurements and indication to higher layers, RF processing, and mapping to antennas and radio resources.

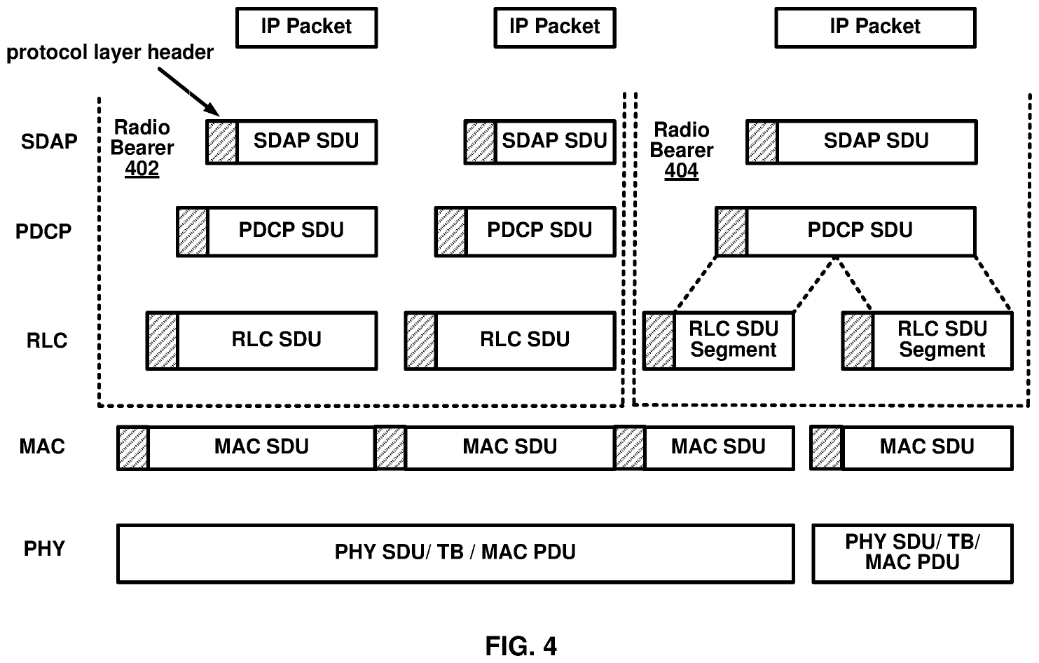

FIG. 4 shows example processing of packets at different protocol layers in accordance with several of various embodiments of the present disclosure. In this example, three Internet Protocol (IP) packets that are processed by the different layers of the NR protocol stack. The term SDU shown in FIG. 4 is the data unit that is entered from/to a higher layer. In contrast, a protocol data unit (PDU) is the data unit that is entered to/from a lower layer. The flow of packets in FIG. 4 is for downlink. An uplink data flow through layers of the NR protocol stack is similar to FIG. 4. In this example, the two leftmost IP packets are mapped by the SDAP layer (shown as SDAP 205 and SDAP 215 in FIG. 2A) to radio bearer 402 and the rightmost packet is mapped by the SDAP layer to the radio bearer 404. The SDAP layer adds SDAP headers to the IP packets which are entered into the PDCP layer as PDCP SDUs. The PDCP layer is shown as PDCP 204 and PDCP 214 in FIG. 2A. The PDCP layer adds the PDCP headers to the PDCP SDUs which are entered into the RLC layer as RLC SDUs. The RLC layer is shown as RLC 203 and RLC 213 in FIG. 2A. An RLC SDU may be segmented at the RLC layer. The RLC layer adds RLC headers to the RLC SDUs after segmentation (if segmented) which are entered into the MAC layer as MAC SDUs. The MAC layer adds the MAC headers to the MAC SDUs and multiplexes one or more MAC SDUs to form a PHY SDU (also referred to as a transport block (TB) or a MAC PDU).

In FIG. 4, the MAC SDUs are multiplexed to form a transport block. The MAC layer may multiplex one or more MAC control elements (MAC CEs) with zero or more MAC SDUs to form a transport block. The MAC CEs may also be referred to as MAC commands or MAC layer control signaling and may be used for in-band control signaling. The MAC CEs may be transmitted by a base station to a UE (e.g., downlink MAC CEs) or by a UE to a base station (e.g., uplink MAC CEs). The MAC CEs may be used for transmission of information useful by a gNB for scheduling (e.g., buffer status report (BSR) or power headroom report (PHR)), activation/deactivation of one or more cells, activation/deactivation of configured radio resources for or one or more processes, activation/deactivation of one or more processes, indication of parameters used in one or more processes, etc.

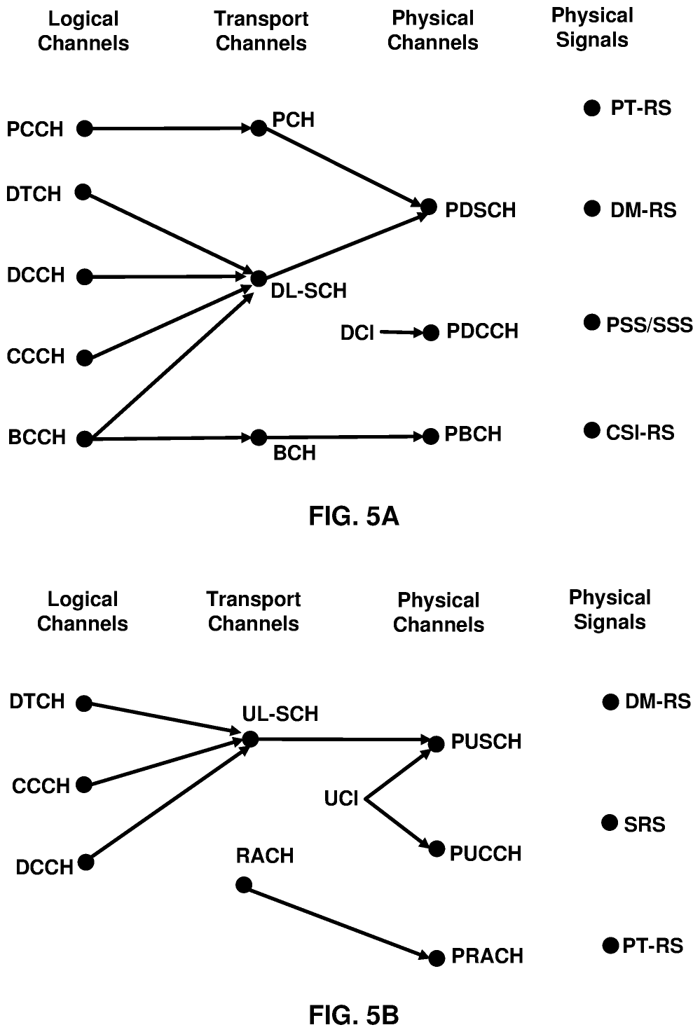

FIG. 5A and FIG. 5B show example mapping between logical channels, transport channels and physical channels for downlink and uplink, respectively in accordance with several of various embodiments of the present disclosure. As discussed before, the MAC layer provides services to higher layer in the form of logical channels. A logical channel may be classified as a control channel, if used for transmission of control and/or configuration information, or a traffic channel if used for transmission of user data. Example logical channels in NR include Broadcast Control Channel (BCCH) used for transmission of broadcast system control information, Paging Control Channel (PCCH) used for carrying paging messages for wireless devices with unknown locations, Common Control Channel (CCCH) used for transmission of control information between UEs and network and for UEs that have no RRC connection with the network, Dedicated Control Channel (DCCH) which is a point-to-point bi-directional channel for transmission of dedicated control information between a UE that has an RRC connection and the network and Dedicated Traffic Channel (DTCH) which is point-to-point channel, dedicated to one UE, for the transfer of user information and may exist in both uplink and downlink.

As discussed before, the PHY layer provides services to the MAC layer and higher layers in the form of transport channels. Example transport channels in NR include Broadcast Channel (BCH) used for transmission of part of the BCCH referred to as master information block (MIB), Downlink Shared Channel (DL-SCH) used for transmission of data (e.g., from DTCH in downlink) and various control information (e.g., from DCCH and CCCH in downlink and part of the BCCH that is not mapped to the BCH), Uplink Shared Channel (UL-SCH) used for transmission of uplink data (e.g., from DTCH in uplink) and control information (e.g., from CCCH and DCCH in uplink) and Paging Channel (PCH) used for transmission of paging information from the PCCH. In addition, Random Access Channel (RACH) is a transport channel used for transmission of random access preambles. The RACH does not carry a transport block. Data on a transport channel (except RACH) may be organized in transport blocks, wherein One or more transport blocks may be transmitted in a transmission time interval (TTI).

The PHY layer may map the transport channels to physical channels. A physical channel may correspond to time-frequency resources that are used for transmission of information from one or more transport channels. In addition to mapping transport channels to physical channels, the physical layer may generate control information (e.g., downlink control information (DCI) or uplink control information (UCI)) that may be carried by the physical channels. Example DCI include scheduling information (e.g., downlink assignments and uplink grants), request for channel state information report, power control command, etc. Example UCI include HARQ feedback indicating correct or incorrect reception of downlink transport blocks, channel state information report, scheduling request, etc. Example physical channels in NR include a Physical Broadcast Channel (PBCH) for carrying information from the BCH, a Physical Downlink Shared Channel (PDSCH) for carrying information form the PCH and the DL-SCH, a Physical Downlink Control Channel (PDCCH) for carrying DCI, a Physical Uplink Shared Channel (PUSCH) for carrying information from the UL-SCH and/or UCI, a Physical Uplink Control Channel (PUCCH) for carrying UCI and Physical Random Access Channel (PRACH) for transmission of RACH (e.g., random access preamble).

The PHY layer may also generate physical signals that are not originated from higher layers. As shown in FIG. 5A, example downlink physical signals include Demodulation Reference Signal (DM-RS), Phase Tracking Reference Signal (PT-RS), Channel State Information Reference Signal (CSI-RS), Primary Synchronization Signal (PSS) and Secondary Synchronization Signal (SSS). As shown in FIG. 5B, example uplink physical signals include DM-RS, PT-RS and sounding reference signal (SRS).

As indicated earlier, some of the protocol layers (PHY, MAC, RLC and PDCP) of the control plane of an NR Uu interface, are common between the user plane protocol stack (as shown in FIG. 2A) and the control plane protocol stack (as shown in FIG. 2B). In addition to PHY, MAC, RLC and PDCP, the control plane protocol stack includes the RRC protocol layer and the NAS protocol layer.

The NAS layer, as shown in FIG. 2B, terminates at the UE 200 and the AMF 220 entity of the 5G-C 130. The NAS layer is used for core network related functions and signaling including registration, authentication, location update and session management. The NAS layer uses services from the AS of the Uu interface to transmit the NAS messages.

The RRC layer, as shown in FIG. 2B, operates between the UE 200 and the gNB 210 (more generally NG-RAN 120) and may provide services and functions such as broadcast of system information (SI) related to AS and NAS as well as paging initiated by the 5G-C 130 or NG-RAN 120. In addition, the RRC layer is responsible for establishment, maintenance and release of an RRC connection between the UE 200 and the NG-RAN 120, carrier aggregation configuration (e.g., addition, modification and release), dual connectivity configuration (e.g., addition, modification and release), security related functions, radio bearer configuration/maintenance and release, mobility management (e.g., maintenance and context transfer), UE cell selection and reselection, inter-RAT mobility, QoS management functions, UE measurement reporting and control, radio link failure (RLF) detection and NAS message transfer. The RRC layer uses services from PHY, MAC, RLC and PDCP layers to transmit RRC messages using signaling radio bearers (SRBs). The SRBs are mapped to CCCH logical channel during connection establishment and to DCCH logical channel after connection establishment.

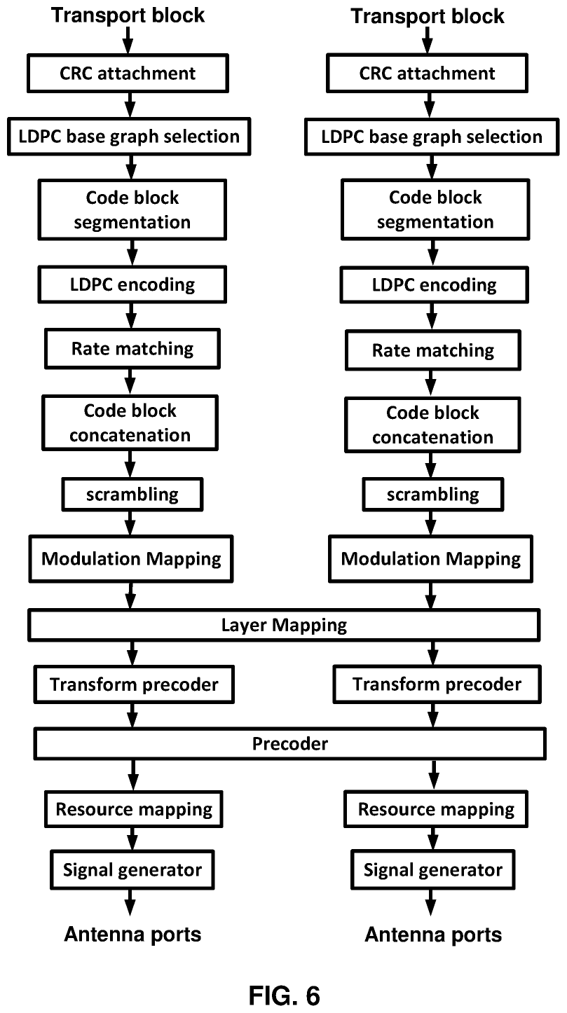

FIG. 6 shows example physical layer processes for signal transmission in accordance with several of various embodiments of the present disclosure. Data and/or control streams from MAC layer may be encoded/decoded to offer transport and control services over the radio transmission link. For example, one or more (e.g., two as shown in FIG. 6) transport blocks may be received from the MAC layer for transmission via a physical channel (e.g., a physical downlink shared channel or a physical uplink shared channel). A cyclic redundancy check (CRC) may be calculated and attached to a transport block in the physical layer. The CRC calculation may be based on one or more cyclic generator polynomials. The CRC may be used by the receiver for error detection. Following the transport block CRC attachment, a low-density parity check (LDPC) base graph selection may be performed. In example embodiments, two LDPC base graphs may be used wherein a first LDPC base graph may be optimized for small transport blocks and a second LDPC base graph may be optimized for comparatively larger transport blocks.

The transport block may be segmented into code blocks and code block CRC may be calculated and attached to a code block. A code block may be LDPC coded and the LDPC coded blocks may be individually rate matched. The code blocks may be concatenated to create one or more codewords. The contents of a codeword may be scrambled and modulated to generate a block of complex-valued modulation symbols. The modulation symbols may be mapped to a plurality of transmission layers (e.g., multiple-input multiple-output (MIMO) layers) and the transmission layers may be subject to transform precoding and/or precoding. The precoded complex-valued symbols may be mapped to radio resources (e.g., resource elements). The signal generator block may create a baseband signal and up-convert the baseband signal to a carrier frequency for transmission via antenna ports. The signal generator block may employ mixers, filters and/or other radio frequency (RF) components prior to transmission via the antennas. The functions and blocks in FIG. 6 are illustrated as examples and other mechanisms may be implemented in various embodiments.

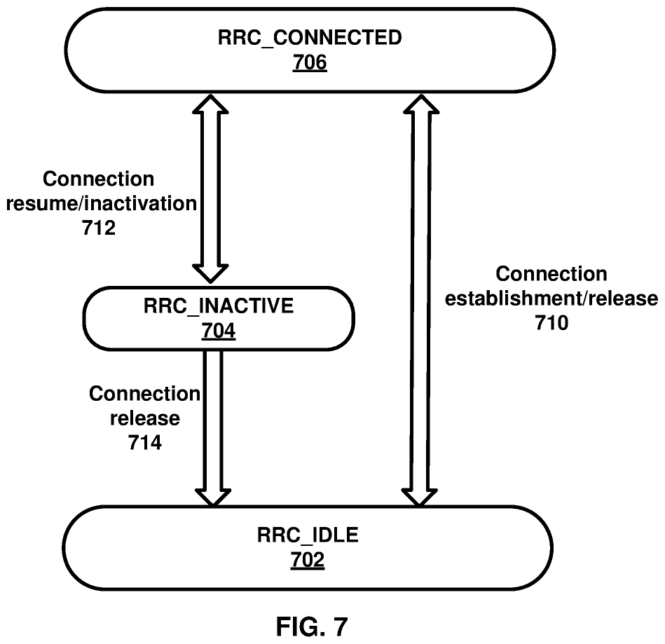

FIG. 7 shows examples of RRC states and RRC state transitions at a UE in accordance with several of various embodiments of the present disclosure. A UE may be in one of three RRC states: RRC_IDLE 702, RRC INACTIVE 704 and RRC_CONNECTED 706. In RRC_IDLE 702 state, no RRC context (e.g., parameters needed for communications between the UE and the network) may be established for the UE in the RAN. In RRC_IDLE 702 state, no data transfer between the UE and the network may take place and uplink synchronization is not maintained. The wireless device may sleep most of the time and may wake up periodically to receive paging messages. The uplink transmission of the UE may be based on a random access process and to enable transition to the RRC_CONNECTED 706 state. The mobility in RRC_IDLE 702 state is through a cell reselection procedure where the UE camps on a cell based on one or more criteria including signal strength that is determined based on the UE measurements.

In RRC_CONNECTED 706 state, the RRC context is established and both the UE and the RAN have necessary parameters to enable communications between the UE and the network. In the RRC_CONNECTED 706 state, the UE is configured with an identity known as a Cell Radio Network Temporary Identifier (C-RNTI) that is used for signaling purposes (e.g., uplink and downlink scheduling, etc.) between the UE and the RAN. The wireless device mobility in the RRC_CONNECTED 706 state is managed by the RAN. The wireless device provides neighboring cells and/or current serving cell measurements to the network and the network may make hand over decisions. Based on the wireless device measurements, the current serving base station may send a handover request message to a neighboring base station and may send a handover command to the wireless device to handover to a cell of the neighboring base station. The transition of the wireless device from the RRC_IDLE 702 state to the RRC_CONNECTED 706 state or from the RRC_CONNECTED 706 state to the RRC_IDLE 702 state may be based on connection establishment and connection release procedures (shown collectively as connection establishment/release 710 in FIG. 7).

To enable a faster transition to the RRC_CONNECTED 706 state (e.g., compared to transition from RRC_IDLE 702 state to RRC_CONNECTED 706 state), an RRC_INACTIVE 704 state is used for an NR UE wherein, the RRC context is kept at the UE and the RAN. The transition from the RRC_INACTIVE 704 state to the RRC_CONNECTED 706 state is handled by RAN without CN signaling. Similar to the RRC_IDLE 702 state, the mobility in RRC_INACTIVE 704 state is based on a cell reselection procedure without involvement from the network. The transition of the wireless device from the RRC_INACTIVE 704 state to the RRC_CONNECTED 706 state or from the RRC_CONNECTED 706 state to the RRC_INACTIVE 704 state may be based on connection resume and connection inactivation procedures (shown collectively as connection resume/inactivation 712 in FIG. 7). The transition of the wireless device from the RRC_INACTIVE 704 state to the RRC_IDLE 702 state may be based on a connection release 714 procedure as shown in FIG. 7.

In NR, Orthogonal Frequency Division Multiplexing (OFDM), also called cyclic prefix OFDM (CP-OFDM), is the baseline transmission scheme in both downlink and uplink of NR and the Discrete Fourier Transform (DFT) spread OFDM (DFT-s-OFDM) is a complementary uplink transmission in addition to the baseline OFDM scheme. OFDM is multi-carrier transmission scheme wherein the transmission bandwidth may be composed of several narrowband sub-carriers. The subcarriers are modulated by the complex valued OFDM modulation symbols resulting in an OFDM signal. The complex valued OFDM modulation symbols are obtained by mapping, by a modulation mapper, the input data (e.g., binary digits) to different points of a modulation constellation diagram. The modulation constellation diagram depends on the modulation scheme. NR may use different types of modulation schemes including Binary Phase Shift Keying (BPSK), π/2-BPSK, Quadrature Phase Shift Keying (QPSK), 16 Quadrature Amplitude Modulation (16QAM), 64QAM and 256QAM. Different and/or higher order modulation schemes (e.g., M-QAM in general) may be used. An OFDM signal with N subcarriers may be generated by processing N subcarriers in parallel for example by using Inverse Fast Fourier Transform (IFFT) processing. The OFDM receiver may use FFT processing to recover the transmitted OFDM modulation symbols. The subcarrier spacing of subcarriers in an OFDM signal is inversely proportional to an OFDM modulation symbol duration. For example, for a 15 KHz subcarrier spacing, duration of an OFDM signal is nearly 66.7 μs. To enhance the robustness of OFDM transmission in time dispersive channels, a cyclic prefix (CP) may be inserted at the beginning of an OFDM symbol. For example, the last part of an OFDM symbol may be copied and inserted at the beginning of an OFDM symbol. The CP insertion enhanced the OFDM transmission scheme by preserving subcarrier orthogonality in time dispersive channels.

In NR, different numerologies may be used for OFDM transmission. A numerology of OFDM transmission may indicate a subcarrier spacing and a CP duration for the OFDM transmission. For example, a subcarrier spacing in NR may generally be a multiple of 15 KHz and expressed as Δf=2^{μ}·15 KHz (μ=0, 1, 2, . . . ). Example subcarrier spacings used in NR include 15 KHz (μ=0), 30 KHz (μ=1), 60 KHz (μ=2), 120 KHz (μ=3) and 240 KHz (μ=4). As discussed before, a duration of OFDM symbol is inversely proportional to the subcarrier spacing and therefor OFDM symbol duration may depend on the numerology (e.g., the μ value).

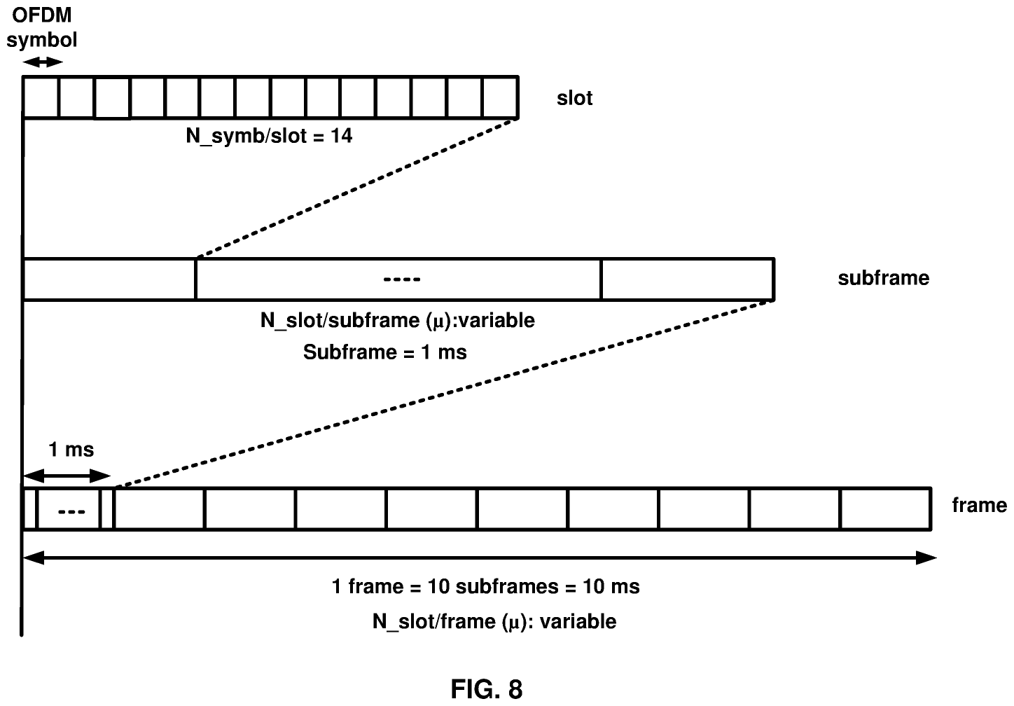

FIG. 8 shows an example time domain transmission structure in NR wherein OFDM symbols are grouped into slots, subframes and frames in accordance with several of various embodiments of the present disclosure. A slot is a group of N_{symb}^{slot} OFDM symbols, wherein the N_{symb}^{slot} may have a constant value (e.g., 14). Since different numerologies results in different OFDM symbol durations, duration of a slot may also depend on the numerology and may be variable. A subframe may have a duration of 1 ms and may be composed of one or more slots, the number of which may depend on the slot duration. The number of slots per subframe is therefore a subfunction of μ and may generally expressed as Nₛₗₒₜ^{subframe,μ} and the number of symbols per subframe may be expressed as N_{symb}^{subframe,μ}=N_{symb}^{slot}Nₛₗₒₜ^{subframe,μ}. A frame may have a duration of 10 ms and may consist of 10 subframes. The number of slots per frame may depend on the numerology and therefore may be variable. The number of slots per frame may generally be expressed as Nₛₗₒₜ^{frame,μ}.

An antenna port may be defined as a logical entity such that channel characteristics over which a symbol on the antenna port is conveyed may be inferred from the channel characteristics over which another symbol on the same antenna port is conveyed. For example, for DM-RS associated with a PDSCH, the channel over which a PDSCH symbol on an antenna port is conveyed may be inferred from the channel over which a DM-RS symbol on the same antenna port is conveyed, for example, if the two symbols are within the same resource as the scheduled PDSCH and/or in the same slot and/or in the same precoding resource block group (PRG). For example, for DM-RS associated with a PDCCH, the channel over which a PDCCH symbol on an antenna port is conveyed may be inferred from the channel over which a DM-RS symbol on the same antenna port is conveyed if, for example, the two symbols are within resources for which the UE may assume the same precoding being used. For example, for DM-RS associated with a PBCH, the channel over which a PBCH symbol on one antenna port is conveyed may be inferred from the channel over which a DM-RS symbol on the same antenna port is conveyed if, for example, the two symbols are within a SS/PBCH block transmitted within the same slot, and with the same block index. The antenna port may be different from a physical antenna. An antenna port may be associated with an antenna port number and different physical channels may correspond to different ranges of antenna port numbers.

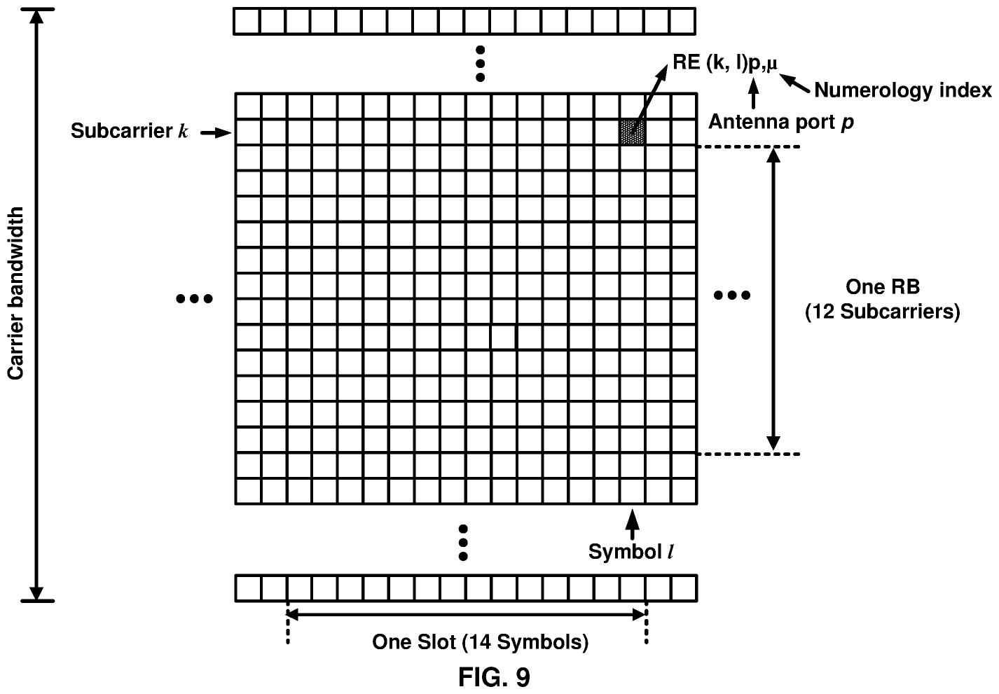

FIG. 9 shows an example of time-frequency resource grid in accordance with several of various embodiments of the present disclosure. The number of subcarriers in a carrier bandwidth may be based on the numerology of OFDM transmissions in the carrier. A resource element, corresponding to one symbol duration and one subcarrier, may be the smallest physical resource in the time-frequency grid. A resource element (RE) for antenna port p and subcarrier spacing configuration μ may be uniquely identified by (k,l)_{p,μ} where k is the index of a subcarrier in the frequency domain and 1 may refer to the symbol position in the time domain relative to some reference point. A resource block may be defined as N_{SC}^{RB}=12 subcarriers. Since subcarrier spacing depends on the numerology of OFDM transmission, the frequency domain span of a resource block may be variable and may depend on the numerology. For example, for a subcarrier spacing of 15 KHz (e.g., μ=0), a resource block may be 180 KHz and for a subcarrier spacing of 30 KHz (e.g., μ=1), a resource block may be 360 KHz.

With large carrier bandwidths defined in NR and due to limited capabilities for some UEs (e.g., due to hardware limitations), a UE may not support an entire carrier bandwidth. Receiving on the full carrier bandwidth may imply high energy consumption. For example, transmitting downlink control channels on the full downlink carrier bandwidth may result in high power consumption for wide carrier bandwidths. NR may use a bandwidth adaptation procedure to dynamically adapt the transmit and receive bandwidths. The transmit and receive bandwidth of a UE on a cell may be smaller than the bandwidth of the cell and may be adjusted. For example, the width of the transmit and/or receive bandwidth may change (e.g., shrink during period of low activity to save power); the location of the transmit and/or receive bandwidth may move in the frequency domain (e.g., to increase scheduling flexibility); and the subcarrier spacing of the transmit or receive bandwidth may change (e.g., to allow different services). A subset of the cell bandwidth may be referred to as a Bandwidth Part (BWP) and bandwidth adaptation may be achieved by configuring the UE with one or more BWPs. The base station may configure a UE with a set of downlink BWPs and a set of uplink BWPs. A BWP may be characterized by a numerology (e.g., subcarrier spacing and cyclic prefix) and a set of consecutive resource blocks in the numerology of the BWP. One or more first BWPs of the one or more BWPs of the cell may be active at a time. An active BWP may be an active downlink BWP or an active uplink BWP.

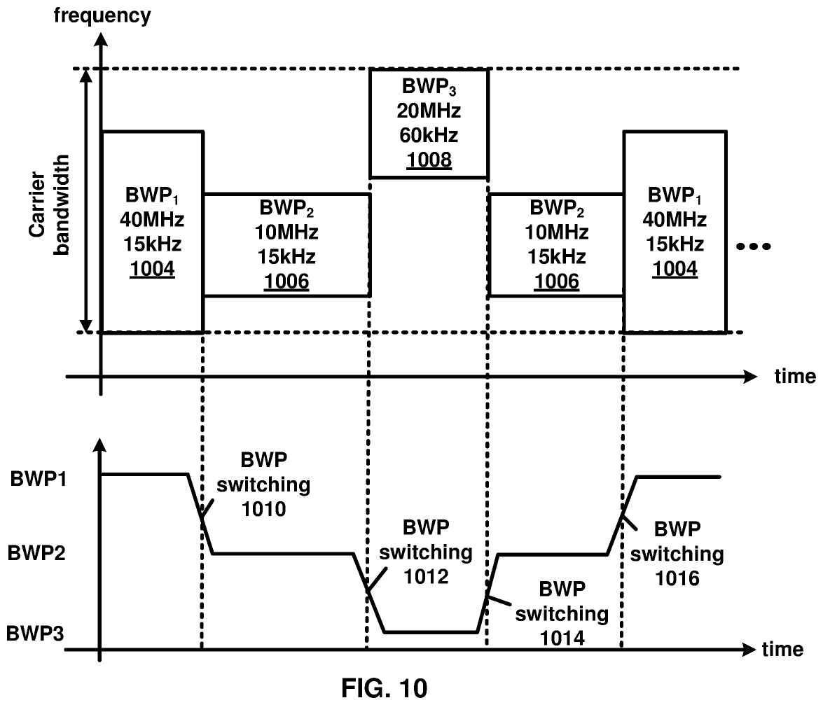

FIG. 10 shows an example of bandwidth part adaptation and switching. In this example, three BWPs (BWP₁ 1004, BWP₂ 1006 and BWP₃ 1008) are configured for a UE on a carrier bandwidth. The BWP₁ is configured with a bandwidth of 40 MHz and a numerology with subcarrier spacing of 15 KHz, the BWP₂ is configured with a bandwidth of 10 MHz and a numerology with subcarrier spacing of 15 KHz and the BWP₃ is configured with a bandwidth of 20 MHz and a subcarrier spacing of 60 KHz. The wireless device may switch from a first BWP (e.g., BWP₁) to a second BWP (e.g., BWP₂). An active BWP of the cell may change from the first BWP to the second BWP in response to the BWP switching.

The BWP switching (e.g., BWP switching 1010, BWP switching 1012, BWP switching 1014, or BWP switching 1016 in FIG. 10) may be based on a command from the base station. The command may be a DCI comprising scheduling information for the UE in the second BWP. In case of uplink BWP switching, the first BWP and the second BWP may be uplink BWPs and the scheduling information may be an uplink grant for uplink transmission via the second BWP. In case of downlink BWP switching, the first BWP and the second BWP may be downlink BWPs and the scheduling information may be a downlink assignment for downlink reception via the second BWP.

The BWP switching (e.g., BWP switching 1010, BWP switching 1012, BWP switching 1014, or BWP switching 1016 in FIG. 10) may be based on an expiry of a timer. The base station may configure a wireless device with a BWP inactivity timer and the wireless device may switch to a default BWP (e.g., default downlink BWP) based on the expiry of the BWP inactivity timer. The expiry of the BWP inactivity timer may be an indication of low activity on the current active downlink BWP. The base station may configure the wireless device with the default downlink BWP. If the base station does not configure the wireless device with the default BWP, the default BWP may be an initial downlink BWP. The initial active BWP may be the BWP that the wireless device receives scheduling information for remaining system information upon transition to an RRC_CONNECTED state.

A wireless device may monitor a downlink control channel of a downlink BWP. For example, the UE may monitor a set of PDCCH candidates in configured monitoring occasions in one or more configured COntrol REsource SETs (CORESETs) according to the corresponding search space configurations. A search space configuration may define how/where to search for PDCCH candidates. For example, the search space configuration parameters may comprise a monitoring periodicity and offset parameter indicating the slots for monitoring the PDCCH candidates. The search space configuration parameters may further comprise a parameter indicating a first symbol with a slot within the slots determined for monitoring PDCCH candidates. A search space may be associated with one or more CORESETs and the search space configuration may indicate one or more identifiers of the one or more CORESETs. The search space configuration parameters may further indicate that whether the search space is a common search space or a UE-specific search space. A common search space may be monitored by a plurality of wireless devices and a UE-specific search space may be dedicated to a specific UE.

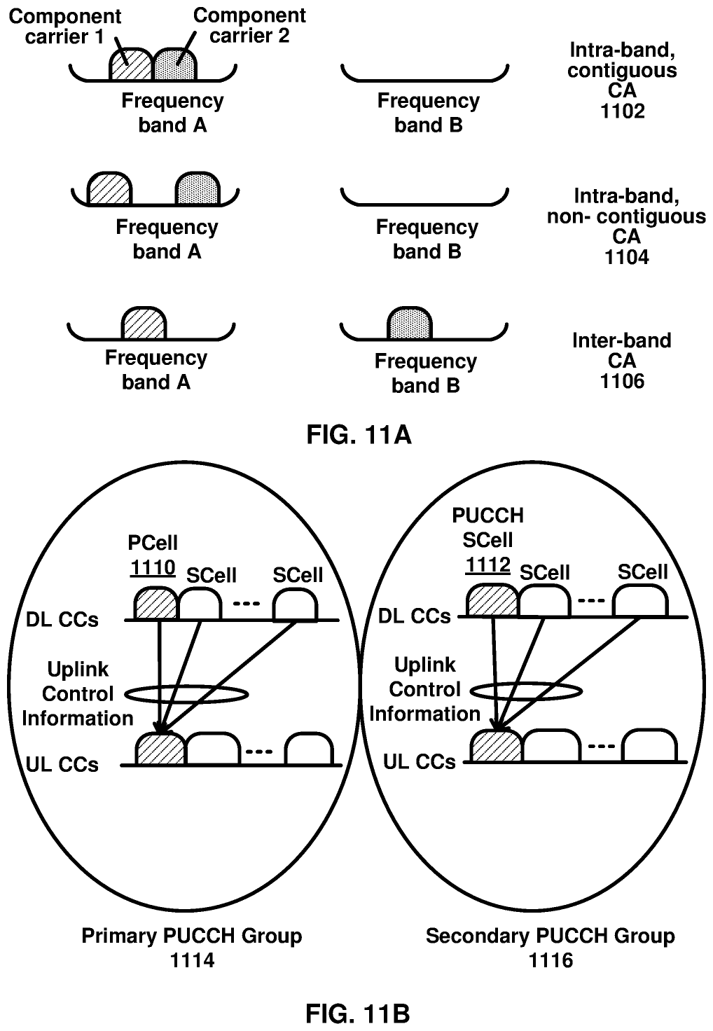

FIG. 11A shows example arrangements of carriers in carrier aggregation in accordance with several of various embodiments of the present disclosure. With carrier aggregation, multiple NR component carriers (CCs) may be aggregated. Downlink transmissions to a wireless device may take place simultaneously on the aggregated downlink CCs resulting in higher downlink data rates. Uplink transmissions from a wireless device may take place simultaneously on the aggregated uplink CCs resulting in higher uplink data rates. The component carriers in carrier aggregation may be on the same frequency band (e.g., intra-band carrier aggregation) or on different frequency bands (e.g., inter-band carrier aggregation). The component carriers may also be contiguous or non-contiguous. This results in three possible carrier aggregation scenarios, intra-band contiguous CA 1102, intra-band non-contiguous CA 1104 and inter-band CA 1106 as shown in FIG. 11A. Depending on the UE capability for carrier aggregation, a UE may transmit and/or receive on multiple carriers or for a UE that is not capable of carrier aggregation, the UE may transmit and/or receive on one component carrier at a time. In this disclosure, the carrier aggregation is described using the term cell and a carrier aggregation capable UE may transmit and/or receive via multiple cells.

In carrier aggregation, a UE may be configured with multiple cells. A cell of the multiple cells configured for the UE may be referred to as a Primary Cell (PCell). The PCell may be the first cell that the UE is initially connected to. One or more other cells configured for the UE may be referred to as Secondary Cells (SCells). The base station may configure a UE with multiple SCells. The configured SCells may be deactivated upon configuration and the base station may dynamically activate or deactivate one or more of the configured SCells based on traffic and/or channel conditions. The base station may activate or deactivate configured SCells using a SCell Activation/Deactivation MAC CE. The SCell Activation/Deactivation MAC CE may comprise a bitmap, wherein each bit in the bitmap may correspond to a SCell and the value of the bit indicates an activation status or deactivation status of the SCell.

An SCell may also be deactivated in response to expiry of a SCell deactivation timer of the SCell. The expiry of an SCell deactivation timer of an SCell may be an indication of low activity (e.g., low transmission or reception activity) on the SCell. The base station may configure the SCell with an SCell deactivation timer. The base station may not configure an SCell deactivation timer for an SCell that is configured with PUCCH (also referred to as a PUCCH SCell). The configuration of the SCell deactivation timer may be per configured SCell and different SCells may be configured with different SCell deactivation timer values. The SCell deactivation timer may be restarted based on one or more criteria including reception of downlink control information on the SCell indicating uplink grant or downlink assignment for the SCell or reception of downlink control information on a scheduling cell indicating uplink grant or downlink assignment for the SCell or transmission of a MAC PDU based on a configured uplink grant or reception of a configured downlink assignment.

A PCell for a UE may be an SCell for another UE and a SCell for a UE may be PCell for another UE. The configuration of PCell may be UE-specific. One or more SCells of the multiple SCells configured for a UE may be configured as downlink-only SCells, e.g., may only be used for downlink reception and may not be used for uplink transmission. In case of self-scheduling, the base station may transmit signaling for uplink grants and/or downlink assignments on the same cell that the corresponding uplink or downlink transmission takes place. In case of cross-carrier scheduling, the base station may transmit signaling for uplink grants and/or downlink assignments on a cell different from the cell that the corresponding uplink or downlink transmission takes place.

FIG. 11B shows examples of uplink control channel groups in accordance with several of various embodiments of the present disclosure. A base station may configure a UE with multiple PUCCH groups wherein a PUCCH group comprises one or more cells. For example, as shown in FIG. 11B, the base station may configure a UE with a primary PUCCH group 1114 and a secondary PUCCH group 1116. The primary PUCCH group may comprise the PCell 1110 and one or more first SCells. First UCI corresponding to the PCell and the one or more first SCells of the primary PUCCH group may be transmitted by the PUCCH of the PCell. The first UCI may be, for example, HARQ feedback for downlink transmissions via downlink CCs of the PCell and the one or more first SCells. The secondary PUCCH group may comprise a PUCCH SCell and one or more second SCells. Second UCI corresponding to the PUCCH SCell and the one or more second SCells of the secondary PUCCH group may be transmitted by the PUCCH of the PUCCH SCell. The second UCI may be, for example, HARQ feedback for downlink transmissions via downlink CCs of the PUCCH SCell and the one or more second SCells.

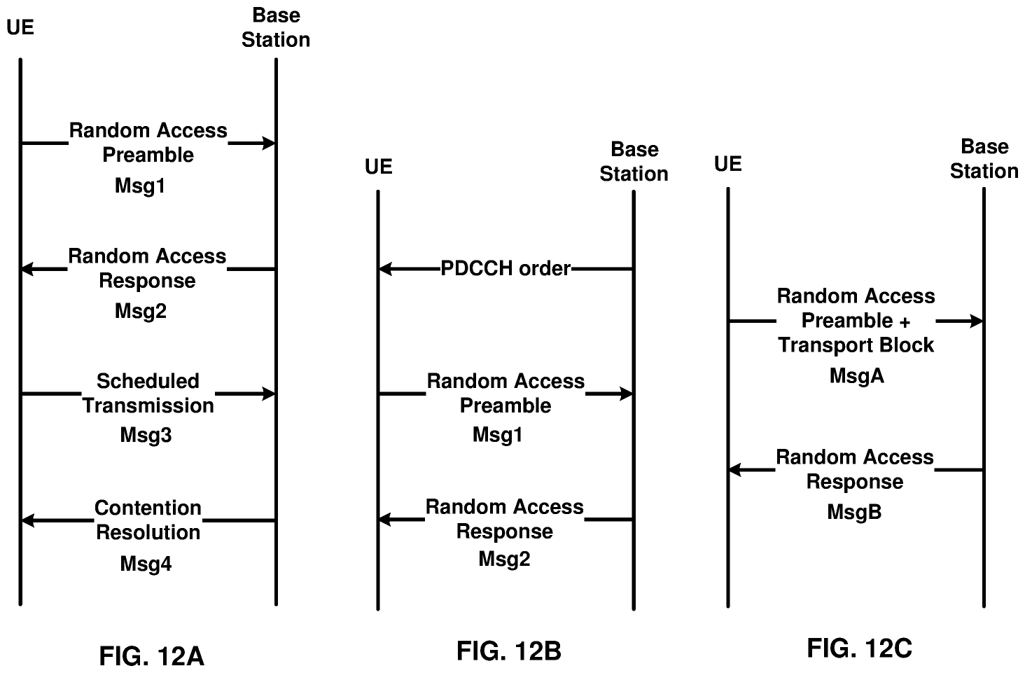

FIG. 12A, FIG. 12B and FIG. 12C show example random access processes in accordance with several of various embodiments of the present disclosure. FIG. 12A shows an example of four step contention-based random access (CBRA) procedure. The four-step CBRA procedure includes exchanging four messages between a UE and a base station. Msg1 may be for transmission (or retransmission) of a random access preamble by the wireless device to the base station. Msg2 may be the random access response (RAR) by the base station to the wireless device. Msg3 is the scheduled transmission based on an uplink grant indicated in Msg2 and Msg4 may be for contention resolution.

The base station may transmit one or more RRC messages comprising configuration parameters of the random access parameters. The random access parameters may indicate radio resources (e.g., time-frequency resources) for transmission of the random access preamble (e.g., Msg1), configuration index, one or more parameters for determining the power of the random access preamble (e.g., a power ramping parameter, a preamble received target power, etc.), a parameter indicating maximum number of preamble transmission, RAR window for monitoring RAR, cell-specific random access parameters and UE specific random access parameters. The UE-specific random access parameters may indicate one or more PRACH occasions for random access preamble (e.g., Msg1) transmissions. The random access parameters may indicate association between the PRACH occasions and one or more reference signals (e.g., SSB or CSI-RS). The random access parameters may further indicate association between the random access preambles and one or more reference signals (e.g., SBB or CSI-RS). The UE may use one or more reference signals (e.g., SSB(s) or CSI-RS(s)) and may determine a random access preamble to use for Msg1 transmission based on the association between the random access preambles and the one or more reference signals. The UE may use one or more reference signals (e.g., SSB(s) or CSI-RS(s)) and may determine the PRACH occasion to use for Msg1 transmission based on the association between the PRACH occasions and the reference signals. The UE may perform a retransmission of the random access preamble if no response is received with the RAR window following the transmission of the preamble. UE may use a higher transmission power for retransmission of the preamble. UE may determine the higher transmission power of the preamble based on the power ramping parameter.

Msg2 is for transmission of RAR by the base station. Msg2 may comprise a plurality of RARs corresponding to a plurality of random access preambles transmitted by a plurality of UEs. Msg2 may be associated with a random access temporary radio identifier (RA-RNTI) and may be received in a common search space of the UE. The RA-RNTI may be based on the PRACH occasion (e.g., time and frequency resources of a PRACH) in which a random access preamble is transmitted. RAR may comprise a timing advance command for uplink timing adjustment at the UE, an uplink grant for transmission of Msg3 and a temporary C-RNTI. In response to the successful reception of Msg2, the UE may transmit the Msg3. Msg3 and Msg4 may enable contention resolution in case of CBRA. In a CBRA, a plurality of UEs may transmit the same random access preamble and may consider the same RAR as being corresponding to them. UE may include a device identifier in Msg3 (e.g., a C-RNTI, temporary C-RNTI or other UE identity). Base station may transmit the Msg4 with a PDSCH and UE may assume that the contention resolution is successful in response to the PDSCH used for transmission of Msg4 being associated with the UE identifier included in Msg3.

FIG. 12B shows an example of a contention-free random access (CFRA) process. Msg 1 (random access preamble) and Msg 2 (random access response) in FIG. 12B for CFRA may be analogous to Msg 1 and Msg 2 in FIG. 12A for CBRA. In an example, the CFRA procedure may be initiated in response to a PDCCH order from a base station. The PDCCH order for initiating the CFRA procedure by the wireless device may be based on a DCI having a first format (e.g., format 1_0). The DCI for the PDCCH order may comprise a random access preamble index, an UL/SUL indicator indicating an uplink carrier of a cell (e.g., normal uplink carrier or supplementary uplink carrier) for transmission of the random access preamble, a SS/PBCH index indicating the SS/PBCH that may be used to determine a RACH occasion for PRACH transmission, a PRACH mask index indicating the RACH occasion associated with the SS/PBCH indicated by the SS/PBCH index for PRACH transmission, etc. In an example, the CFRA process may be started in response to a beam failure recovery process. The wireless device may start the CFRA for the beam failure recovery without a command (e.g., PDCCH order) from the base station and by using the wireless device dedicated resources.

FIG. 12C shows an example of a two-step random access process comprising two messages exchanged between a wireless device and a base station. Msg A may be transmitted by the wireless device to the base station and may comprise one or more transmissions of a preamble and/or one or more transmissions of a transport block. The transport block in Msg A and Msg 3 in FIG. 12A may have similar and/or equivalent contents. The transport block of Msg A may comprise data and control information (e.g., SR, HARQ feedback, etc.). In response to the transmission of Msg A, the wireless device may receive Msg B from the base station. Msg B in FIG. 12C and Msg 2 (e.g., RAR) illustrated in FIGS. 12A and 12B may have similar and/or equivalent content.

The base station may periodically transmit synchronization signals (SSs), e.g., primary SS (PSS) and secondary SS (SSS) along with PBCH on each NR cell. The PSS/SSS together with PBCH is jointly referred to as a SS/PBCH block. The SS/PBCH block enables a wireless device to find a cell when entering to the mobile communications network or find new cells when moving within the network. The SS/PBCH block spans four OFDM symbols in time domain. The PSS is transmitted in the first symbol and occupies 127 subcarriers in frequency domain. The SSS is transmitted in the third OFDM symbol and occupies the same 127 subcarriers as the PSS. There are eight and nine empty subcarriers on each side of the SSS. The PBCH is transmitted on the second OFDM symbol occupying 240 subcarriers, the third OFDM symbol occupying 48 subcarriers on each side of the SSS, and on the fourth OFDM symbol occupying 240 subcarriers. Some of the PBCH resources indicated above may be used for transmission of the demodulation reference signal (DMRS) for coherent demodulation of the PBCH. The SS/PBCH block is transmitted periodically with a period ranging from 5 ms to 160 ms. For initial cell search or for cell search during inactive/idle state, a wireless device may assume that that the SS/PBCH block is repeated at least every 20 ms.

In NR, transmissions using of antenna arrays, with many antenna elements, and beamforming plays an important role specially in higher frequency bands. Beamforming enables higher capacity by increasing the signal strength (e.g., by focusing the signal energy in a specific direction) and by lowering the amount interference received at the wireless devices. The beamforming techniques may generally be divided to analog beamforming and digital beamforming techniques. With digital beamforming, signal processing for beamforming is carried out in the digital domain before digital-to-analog conversion and detailed control of both amplitude and phase of different antenna elements may be possible. With analog beamforming, the signal processing for beamforming is carried out in the analog domain and after the digital to analog conversion. The beamformed transmissions may be in one direction at a time. For example, the wireless devices that are in different directions relative to the base station may receive their downlink transmissions at different times. For analog receiver-side beamforming, the receiver may focus its receiver beam in one direction at a time.

In NR, the base station may use beam sweeping for transmission of SS/PBCH blocks. The SS/PBCH blocks may be transmitted in different beams using time multiplexing. The set of SS/PBCH blocks that are transmitted in one beam sweep may be referred to as a SS/PBCH block set. The period of PBCH/SSB block transmission may be a time duration between a SS/PBCH block transmission in a beam and the next SS/PBCH block transmission in the same beam. The period of SS/PBCH block is, therefore, also the period of the SS/PBCH block set.

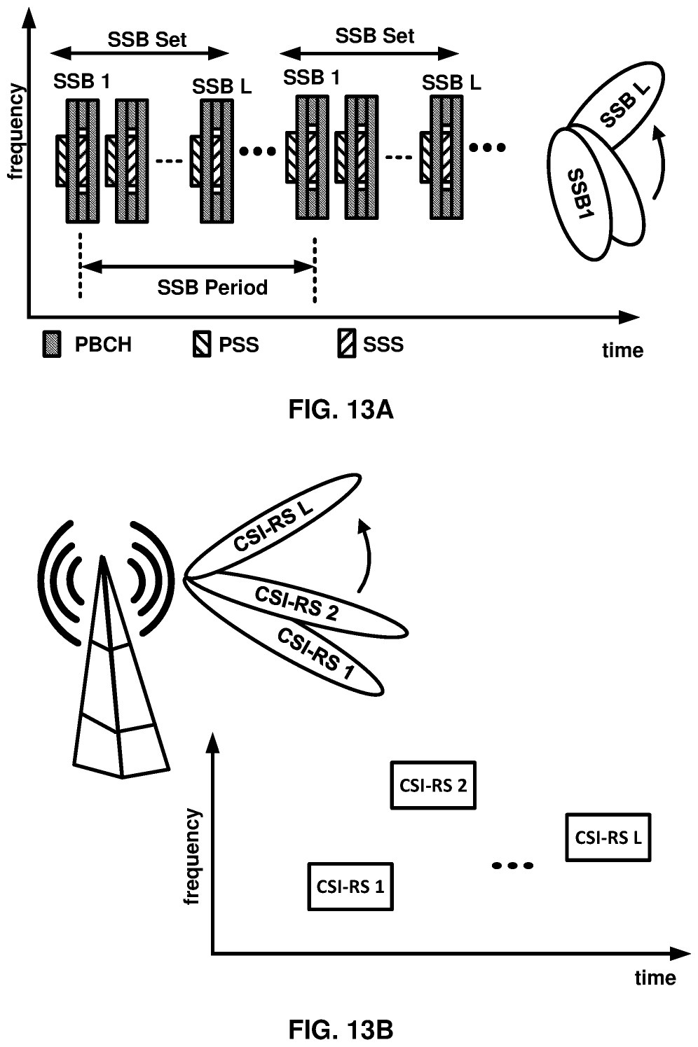

FIG. 13A shows example time and frequency structure of SS/PBCH blocks and their associations with beams in accordance with several of various embodiments of the present disclosure. In this example, a SS/PBCH block (also referred to as SSB) set comprise L SSBs wherein an SSB in the SSB set is associated with (e.g., transmitted in) one of L beams of a cell. The transmission of SBBs of an SSB set may be confined within a 5 ms interval, either in a first half-frame or a second half-frame of a 10 ms frame. The number of SSBs in an SSB set may depend on the frequency band of operation. For example, the number of SSBs in a SSB set may be up to four SSBs in frequency bands below 3 GHz enabling beam sweeping of up to four beams, up to eight SSBs in frequency bands between 3 GHz and 6 GHz enabling beam sweeping of up to eight beams, and up to sixty four SSBs in higher frequency bands enabling beam sweeping of up to sixty four beams. The SSs of an SSB may depend on a physical cell identity (PCI) of the cell and may be independent of which beam of the cell is used for transmission of the SSB. The PBCH of an SSB may indicate a time index parameter and the wireless device may determine the relative position of the SSB within the SSB set using the time index parameter. The wireless device may use the relative position of the SSB within an SSB set for determining the frame timing and/or determining RACH occasions for a random access process.

A wireless device entering the mobile communications network may first search for the PSS. After detecting the PSS, the wireless device may determine the synchronization up to the periodicity of the PSS. By detecting the PSS, the wireless device may determine the transmission timing of the SSS. The wireless device may determine the PCI of the cell after detecting the SSS. The PBCH of a SS/PBCH block is a downlink physical channel that carries the MIB. The MIB may be used by the wireless device to obtain remaining system information (RMSI) that is broadcast by the network. The RMSI may include System Information Block 1 (SIB1) that contains information required for the wireless device to access the cell.

As discussed earlier, the wireless device may determine a time index parameter from the SSB. The PBCH comprises a half-frame parameter indicating whether the SSB is in the first 5 ms half or the second 5 ms half of a 10 ms frame. The wireless device may determine the frame boundary using the time index parameter and the half-frame parameter. In addition, the PBCH may comprise a parameter indicating the system frame number (SFN) of the cell.

The base station may transmit CSI-RS and a UE may measure the CSI-RS to obtain channel state information (CSI). The base station may configure the CSI-RS in a UE-specific manner. In some scenarios, same set of CSI-RS resources may be configured for multiple UEs and one or more resource elements of a CSI-RS resource may be shared among multiple UEs. A CSI-RS resource may be configured such that it does not collide with a CORESET configured for the wireless device and/or with a DMRS of a PDSCH scheduled for the wireless device and/or transmitted SSBs. The UE may measure one or more CSI-RSs configured for the UE and may generate a CSI report based on the CSI-RS measurements and may transmit the CSI report to the base station for scheduling, link adaptation and/or other purposes.

NR supports flexible CSI-RS configurations. A CSI-RS resource may be configured with single or multiple antenna ports and with configurable density. Based on the number of configured antenna ports, a CSI-RS resource may span different number of OFDM symbols (e.g., 1, 2, and 4 symbols). The CSI-RS may be configured for a downlink BWP and may use the numerology of the downlink BWP. The CSI-RS may be configured to cover the full bandwidth of the downlink BWP or a portion of the downlink BWP. In some case, the CSI-RS may be repeated in every resource block of the CSI-RS bandwidth, referred to as CSI-RS with density equal to one. In some cases, the CSI-RS may be configured to be repeated in every other resource block of the CSI-RS bandwidth. CSI-RS may be non-zero power (NZP) CSI-RS or zero-power (ZP) CSI-RS.

The base station may configure a wireless device with one or more sets of NZP CSI-RS resources. The base station may configure the wireless device with a NZP CSI-RS resource set using an RRC information element (IE) NZP-CSI-RS-ResourceSet indicating a NZP CSI-RS resource set identifier (ID) and parameters specific to the NZP CSI-RS resource set. An NZP CSI-RS resource set may comprise one or more CSI-RS resources. An NZP CSI-RS resource set may be configured as part of the CSI measurement configuration.

The CSI-RS may be configured for periodic, semi-persistent or aperiodic transmission. In case of the periodic and semi-persistent CSI-RS configurations, the wireless device may be configured with a CSI resource periodicity and offset parameter that indicate a periodicity and corresponding offset in terms of number of slots. The wireless device may determine the slots that the CSI-RSs are transmitted. For semi-persistent CSI-RS, the CSI-RS resources for CSI-RS transmissions may be activated and deactivated by using a semi-persistent (SP) CSI-CSI Resource Set Activation/Deactivation MAC CE. In response to receiving a MAC CE indicating activation of semi-persistent CSI-RS resources, the wireless device may assume that the CSI-RS transmissions will continue until the CSI-RS resources for CSI-RS transmissions are activated.

As discussed before, CSI-RS may be configured for a wireless device as NZP CSI-RS or ZP CSI-RS. The configuration of the ZP CSI-RS may be similar to the NZP CSI-RS with the difference that the wireless device may not carry out measurements for the ZP CSI-RS. By configuring ZP CSI-RS, the wireless device may assume that a scheduled PDSCH that includes resource elements from the ZP CSI-RS is rate matched around those ZP CSI-RS resources. For example, a ZP CSI-RS resource configured for a wireless device may be an NZP CSI-RS resource for another wireless device. For example, by configuring ZP CSI-RS resources for the wireless device, the base station may indicate to the wireless device that the PDSCH scheduled for the wireless device is rate matched around the ZP CSI-RS resources.

A base station may configure a wireless device with channel state information interference measurement (CSI-IM) resources. Similar to the CSI-RS configuration, configuration of locations and density of CSI-IM resources may be flexible. The CSI-IM resources may be periodic (configured with a periodicity), semi-persistent (configured with a periodicity and activated and deactivated by MAC CE) or aperiodic (triggered by a DCI).

Tracking reference signals (TRSs) may be configured for a wireless device as a set of sparse reference signals to assist the wireless in time and frequency tracking and compensating time and frequency variations in its local oscillator. The wireless device may further use the TRSs for estimating channel characteristics such as delay spread or doppler frequency. The base station may use a CSI-RS configuration for configuring TRS for the wireless device. The TRS may be configured as a resource set comprising multiple periodic NZP CSI-RS resources.

A base station may configure a UE and the UE may transmit sounding reference signals (SRSs) to enable uplink channel sounding/estimation at the base station. The SRS may support up to four antenna ports and may be designed with low cubic metric enabling efficient operation of the wireless device amplifier. The SRS may span one or more (e.g., one, two or four) consecutive OFDM symbols in time domain and may be located within the last n (e.g., six) symbols of a slot. In the frequency domain, the SRS may have a structure that is referred to as a comb structure and may be transmitted on every Nth subcarrier. Different SRS transmissions from different wireless devices may have different comb structures and may be multiplexed in frequency domain.

A base station may configure a wireless device with one or more SRS resource sets and an SRS resource set may comprise one or more SRS resources. The SRS resources in an SRS resources set may be configured for periodic, semi-persistent or aperiodic transmission. The periodic SRS and the semi-persistent SRS resources may be configured with periodicity and offset parameters. The Semi-persistent SRS resources of a configured semi-persistent SRS resource set may be activated or deactivated by a semi-persistent (SP) SRS Activation/Deactivation MAC CE. The set of SRS resources included in an aperiodic SRS resource set may be activated by a DCI. A value of a field (e.g., an SRS request field) in the DCI may indicate activation of resources in an aperiodic SRS resource set from a plurality of SRS resource sets configured for the wireless device.

An antenna port may be associated with one or more reference signals. The receiver may assume that the one or more reference signals, associated with the antenna port, may be used for estimating channel corresponding to the antenna port. The reference signals may be used to derive channel state information related to the antenna port. Two antenna ports may be referred to as quasi co-located if characteristics (e.g., large-scale properties) of the channel over which a symbol is conveyed on one antenna port may be inferred from the channel over which a symbol is conveyed from another antenna port. For example, a UE may assume that radio channels corresponding to two different antenna ports have the same large-scale properties if the antenna ports are specified as quasi co-located. In some cases, the UE may assume that two antenna ports are quasi co-located based on signaling received from the base station. Spatial quasi-colocation (QCL) between two signals may be, for example, due to the two signals being transmitted from the same location and in the same beam. If a receive beam is good for a signal in a group of signals that are spatially quasi co-located, it may be assumed also be good for the other signals in the group of signals.

The CSI-RS in the downlink and the SRS in uplink may serve as quasi-location (QCL) reference for other physical downlink channels and physical uplink channels, respectively. For example, a downlink physical channel (e.g., PDSCH or PDCCH) may be spatially quasi co-located with a downlink reference signal (e.g., CSI-RS or SSB). The wireless device may determine a receive beam based on measurement on the downlink reference signal and may assume that the determined received beam is also good for reception of the physical channels (e.g., PDSCH or PDCCH) that are spatially quasi co-located with the downlink reference signal. Similarly, an uplink physical channel (e.g., PUSCH or PUCCH) may be spatially quasi co-located with an uplink reference signal (e.g., SRS). The base station may determine a receive beam based on measurement on the uplink reference signal and may assume that the determined received beam is also good for reception of the physical channels (e.g., PUSCH or PUCCH) that are spatially quasi co-located with the uplink reference signal.

The Demodulation Reference Signals (DM-RSs) enables channel estimation for coherent demodulation of downlink physical channels (e.g., PDSCH, PDCCH and PBH) and uplink physical channels (e.g., PUSCH and PUCCH). The DM-RS may be located early in the transmission (e.g., front-loaded DM-RS) and may enable the receiver to obtain the channel estimate early and reduce the latency. The time-domain structure of the DM-RS (e.g., symbols wherein the DM-RS are located in a slot) may be based on different mapping types.

The Phase Tracking Reference Signals (PT-RSs) enables tracking and compensation of phase variations across the transmission duration. The phase variations may be, for example, due to oscillator phase noise. The oscillator phase noise may become more sever in higher frequencies (e.g., mmWave frequency bands). The base station may configure the PT-RS for uplink and/or downlink. The PT-RS configuration parameters may indicate frequency and time density of PT-RS, maximum number of ports (e.g., uplink ports), resource element offset, configuration of uplink PT-RS without transform precoder (e.g., CP-OFDM) or with transform precoder (e.g., DFT-s-OFDM), etc. The subcarrier number and/or resource blocks used for PT-RS transmission may be based on the C-RNTI of the wireless device to reduce risk of collisions between PT-RSs of wireless devices scheduled on overlapping frequency domain resources.

FIG. 13B shows example time and frequency structure of CSI-RSs and their association with beams in accordance with several of various embodiments of the present disclosure. A beam of the L beams shown in FIG. 13B may be associated with a corresponding CSI-RS resource. The base station may transmit the CSI-RSs using the configured CSI-RS resources and a UE may measure the CSI-RSs (e.g., received signal received power (RSRP) of the CSI-RSs) and report the CSI-RS measurements to the base station based on a reporting configuration. For example, the base station may determine one or more transmission configuration indication (TCI) states and may indicate the one or more TCI states to the UE (e.g., using RRC signaling, a MAC CE and/or a DCI). Based on the one or more TCI states indicated to the UE, the UE may determine a downlink receive beam and receive downlink transmissions using the receive beam. In case of a beam correspondence, the UE may determine a spatial domain filter of a transmit beam based on spatial domain filter of a corresponding receive beam. Otherwise, the UE may perform an uplink beam selection procedure to determine the spatial domain filter of the transmit beam. The UE may transmit one or more SRSs using the SRS resources configured for the UE and the base station may measure the SRSs and determine/select the transmit beam for the UE based the SRS measurements. The base station may indicate the selected beam to the UE. The CSI-RS resources shown in FIG. 13B may be for one UE. The base station may configure different CSI-RS resources associated with a given beam for different UEs by using frequency division multiplexing.

A base station and a wireless device may perform beam management procedures to establish beam pairs (e.g., transmit and receive beams) that jointly provide good connectivity. For example, in the downlink direction, the UE may perform measurements for a beam pair and estimate channel quality for a transmit beam by the base station (or a transmission reception point (TRP) more generally) and the receive beam by the UE. The UE may transmit a report indicating beam pair quality parameters. The report may comprise one or more parameters indicating one or more beams (e.g., a beam index, an identifier of reference signal associated with a beam, etc.), one or more measurement parameters (e.g., RSRP), a precoding matrix indicator (PMI), a channel quality indicator (CQI), and/or a rank indicator (RI).

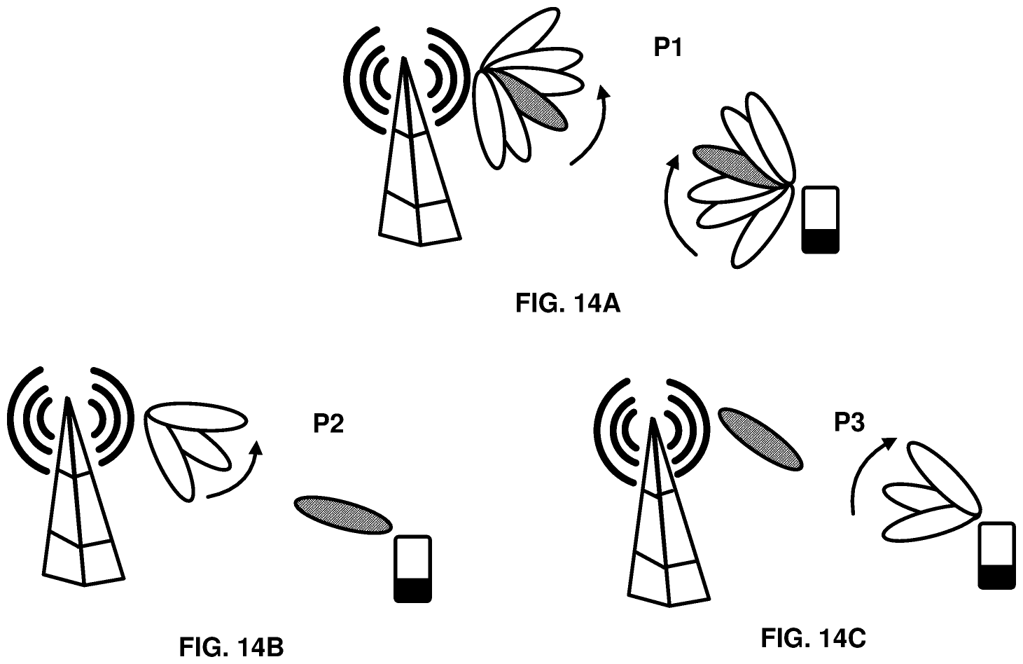

FIG. 14A, FIG. 14B and FIG. 14C show example beam management processes (referred to as P1, P2 and P3, respectively) in accordance with several of various embodiments of the present disclosure. The P1 process shown in FIG. 14A may enable, based on UE measurements, selection of a base station (or TRP more generally) transmit beam and/or a wireless device receive beam. The TRP may perform a beam sweeping procedure where the TRP may sequentially transmit reference signals (e.g., SSB and/or CSI-RS) on a set of beams and the UE may select a beam from the set of beams and may report the selected beam to the TRP. The P2 procedure as shown in FIG. 14B may be a beam refinement procedure. The selection of the TRP transmit beam and the UE receive beam may be regularly reevaluated due to movements and/or rotations of the UE or movement of other objects. In an example, the base station may perform the beam sweeping procedure over a smaller set of beams and the UE may select the best beam over the smaller set. In an example, the beam shape may be narrower compared to beam selected based on the P1 procedure. Using the P3 procedure as shown in FIG. 14C, the TRP may fix its transmit beam and the UE may refine its receive beam.

A wireless device may receive one or more messages from a base station. The one or more messages may comprise one or more RRC messages. The one or more messages may comprise configuration parameters of a plurality of cells for the wireless device. The plurality of cells may comprise a primary cell and one or more secondary cells. For example, the plurality of cells may be provided by a base station and the wireless device may communicate with the base station using the plurality of cells. For example, the plurality of cells may be provided by multiple base station (e.g., in case of dual and/or multi-connectivity). The wireless device may communicate with a first base station, of the multiple base stations, using one or more first cells of the plurality of cells. The wireless device may communicate with a second base station of the multiple base stations using one or more second cells of the plurality of cells.

The one or more messages may comprise configuration parameters used for processes in physical, MAC, RLC, PCDP, SDAP, and/or RRC layers of the wireless device. For example, the configuration parameters may include values of timers used in physical, MAC, RLC, PCDP, SDAP, and/or RRC layers. For example, the configuration parameters may include parameters for configurating different channels (e.g., physical layer channel, logical channels, RLC channels, etc.) and/or signals (e.g., CSI-RS, SRS, etc.).

Upon starting a timer, the timer may start running until the timer is stopped or until the timer expires. A timer may be restarted if it is running. A timer may be started if it is not running (e.g., after the timer is stopped or after the timer expires). A timer may be configured with or may be associated with a value (e.g., an initial value). The timer may be started or restarted with the value of the timer. The value of the timer may indicate a time duration that the timer may be running upon being started or restarted and until the timer expires. The duration of a timer may not be updated until the timer is stopped or expires (e.g., due to BWP switching). This specification may disclose a process that includes one or more timers. The one or more timers may be implemented in multiple ways. For example, a timer may be used by the wireless device and/or base station to determine a time window [t1, t2], wherein the timer is started at time t1 and expires at time t2 and the wireless device and/or the base station may be interested in and/or monitor the time window [t1, t2], for example to receive a specific signaling. Other examples of implementation of a timer may be provided.

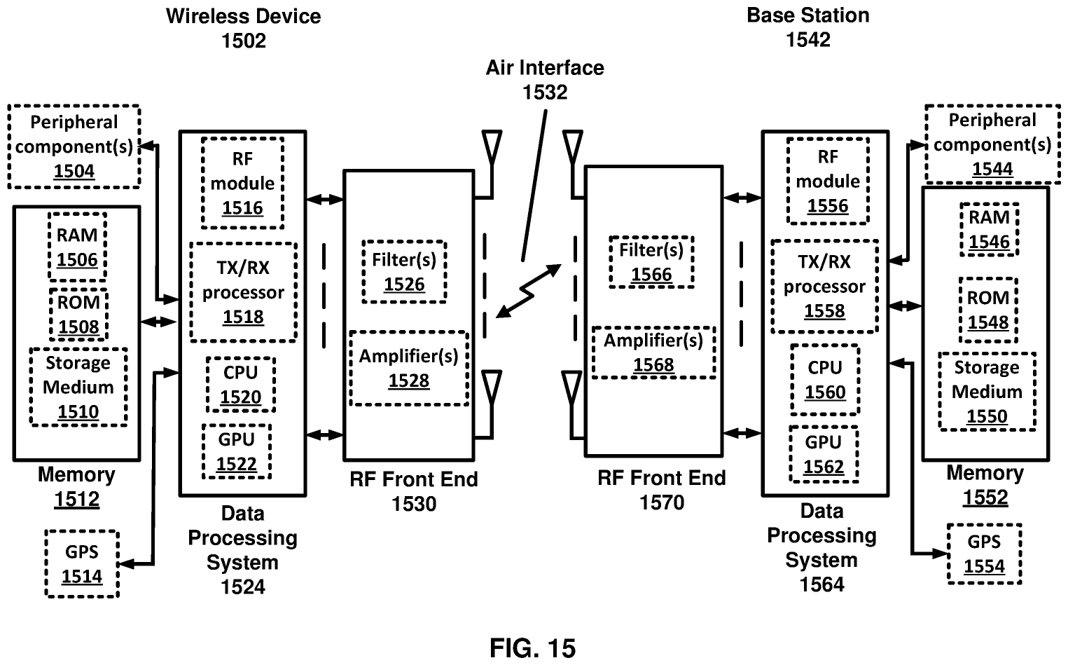

FIG. 15 shows example components of a wireless device and a base station that are in communication via an air interface in accordance with several of various embodiments of the present disclosure. The wireless device 1502 may communicate with the base station 1542 over the air interface 1532. The wireless device 1502 may include a plurality of antennas. The base station 1542 may include a plurality of antennas. The plurality of antennas at the wireless device 1502 and/or the base station 1542 enables different types of multiple antenna techniques such as beamforming, single-user and/or multi-user MIMO, etc.

The wireless device 1502 and the base station 1542 may have one or more of a plurality of modules/blocks, for example RF front end (e.g., RF front end 1530 at the wireless device 1502 and RF front end 1570 at the base station 1542), Data Processing System (e.g., Data Processing System 1524 at the wireless device 1502 and Data Processing System 1564 at the base station 1542), Memory (e.g., Memory 1512 at the wireless device 1502 and Memory 1542 at the base station 1542). Additionally, the wireless device 1502 and the base station 1542 may have other modules/blocks such as GPS (e.g., GPS 1514 at the wireless device 1502 and GPS 1554 at the base station 1542).

An RF front end module/block may include circuitry between antennas and a Data Processing System for proper conversion of signals between these two modules/blocks. An RF front end may include one or more filters (e.g., Filter(s) 1526 at RF front end 1530 or Filter(s) 1566 at the RF front end 1570), one or more amplifiers (e.g., Amplifier(s) 1528 at the RF front end 1530 and Amplifier(s) 1568 at the RF front end 1570). The Amplifier(s) may comprise power amplifier(s) for transmission and low-noise amplifier(s) (LNA(s)) for reception.

The Data Processing System 1524 and the Data Processing System 1564 may process the data to be transmitted or the received signals by implementing functions at different layers of the protocol stack such as PHY, MAC, RLC, etc. Example PHY layer functions that may be implemented by the Data Processing System 1524 and/or 1564 may include forward error correction, interleaving, rate matching, modulation, precoding, resource mapping, MIMO processing, etc. Similarly, one or more functions of the MAC layer, RLC layer and/or other layers may be implemented by the Data Processing System 1524 and/or the Data Processing System 1564. One or more processes described in the present disclosure may be implemented by the Data Processing System 1524 and/or the Data Processing System 1564. A Data Processing System may include an RF module (RF module 1516 at the Data Processing System 1524 and RF module 1556 at the Data Processing System 1564) and/or a TX/RX processor (e.g., TX/RX processor 1518 at the Data Processing System 1524 and TX/RX processor 1558 at the Data Processing System 1566) and/or a central processing unit (CPU) (e.g., CPU 1520 at the Data Processing System 1524 and CPU 1560 at the Data Processing System 1564) and/or a graphical processing unit (GPU) (e.g., GPU 1522 at the Data Processing System 1524 and GPU 1562 at the Data Processing System 1564).

The Memory 1512 may have interfaces with the Data Processing System 1524 and the Memory 1552 may have interfaces with Data Processing System 1564, respectively. The Memory 1512 or the Memory 1552 may include non-transitory computer readable mediums (e.g., Storage Medium 1510 at the Memory 1512 and Storage Medium 1550 at the Memory 1552) that may store software code or instructions that may be executed by the Data Processing System 1524 and Data Processing System 1564, respectively, to implement the processes described in the present disclosure. The Memory 1512 or the Memory 1552 may include random-access memory (RAM) (e.g., RAM 1506 at the Memory 1512 or RAM 1546 at the Memory 1552) or read-only memory (ROM) (e.g., ROM 1508 at the Memory 1512 or ROM 1548 at the Memory 1552) to store data and/or software codes.

The Data Processing System 1524 and/or the Data Processing System 1564 may be connected to other components such as a GPS module 1514 and a GPS module 1554, respectively, wherein the GPS module 1514 and a GPS module 1554 may enable delivery of location information of the wireless device 1502 to the Data Processing System 1524 and location information of the base station 1542 to the Data Processing System 1564. One or more other peripheral components (e.g., Peripheral Component(s) 1504 or Peripheral Component(s) 1544) may be configured and connected to the data Processing System 1524 and data Processing System 1564, respectively.

In example embodiments, a wireless device may be configured with parameters and/or configuration arrangements. For example, the configuration of the wireless device with parameters and/or configuration arrangements may be based on one or more control messages that may be used to configure the wireless device to implement processes and/or actions. The wireless device may be configured with the parameters and/or the configuration arrangements regardless of the wireless device being in operation or not in operation. For example, software, firmware, memory, hardware and/or a combination thereof and/or alike may be configured in a wireless device regardless of the wireless device being in operation or not operation. The configured parameters and/or settings may influence the actions and/or processes performed by the wireless device when in operation.

In example embodiments, a wireless device may receive one or more message comprising configuration parameters. For example, the one or more messages may comprise radio resource control (RRC) messages. A parameter of the configuration parameters may be in at least one of the one or more messages. The one or more messages may comprise information element (IEs). An information element may be a structural element that includes single or multiple fields. The fields in an IE may be individual contents of the IE. The terms configuration parameter, IE and field may be used equally in this disclosure. The IEs may be implemented using a nested structure, wherein an IE may include one or more other IEs and an IE of the one or more other IEs may include one or more additional IEs. With this structure, a parent IE contains all the offspring IEs as well. For example, a first IE containing a second IE, the second IE containing a third IE, and the third IE containing a fourth IE may imply that the first IE contains the third IE and the fourth IE.

In an example, RRC may configure a wireless device with a timeAlignmentTimer configuration parameters per timing advance group (TAG). The timeAlignmentTimer (per TAG) may control how long the MAC entity may consider the Serving Cells belonging to the associated TAG to be uplink time aligned.

In an example, when a Timing Advance Command MAC CE is received, and if an NTA has been maintained with the indicated TAG, the MAC entity may apply the Timing Advance Command for the indicated TAG; and may start or restart the timeAlignmentTimer associated with the indicated TAG.

In an example, when a Timing Advance Command is received in a Random Access Response message for a Serving Cell belonging to a TAG or in a MSGB for an SpCell: if the Random Access Preamble was not selected by the MAC entity among the contention-based Random Access Preamble: the MAC entity may apply the Timing Advance Command for this TAG; and may start or restart the timeAlignmentTimer associated with this TAG.

In an example, when a Timing Advance Command is received in a Random Access Response message for a Serving Cell belonging to a TAG or in a MSGB for an SpCell: if the timeAlignmentTimer associated with this TAG is not running: the MAC entity may apply the Timing Advance Command for this TAG; may start the timeAlignmentTimer associated with this TAG; and when the Contention Resolution is considered not successful or when the Contention Resolution is considered successful for SI request, after transmitting HARQ feedback for MAC PDU including UE Contention Resolution Identity MAC CE: the MAC entity may stop timeAlignmentTimer associated with this TAG.

In an example, when a Timing Advance Command is received in a Random Access Response message for a Serving Cell belonging to a TAG or in a MSGB for an SpCell: if the timeAlignmentTimer associated with this TAG is running, the MAC entity may ignore the received Timing Advance Command.

In an example, when an Absolute Timing Advance Command is received in response to a MSGA transmission including C-RNTI MAC CE: the MAC entity may apply the Timing Advance Command for PTAG; and may start or restart the timeAlignmentTimer associated with PTAG.

In an example, when a timeAlignmentTimer expires: if the timeAlignmentTimer is associated with the PTAG, the MAC entity may flush all HARQ buffers for all Serving Cells; may notify RRC to release PUCCH for all Serving Cells, if configured; may notify RRC to release SRS for all Serving Cells, if configured; may clear any configured downlink assignments and configured uplink grants; may clear any PUSCH resource for semi-persistent CSI reporting; may consider all running timeAlignmentTimers as expired; and may maintain NTA of all TAGs.

In an example, when a timeAlignmentTimer expires: if the timeAlignmentTimer is associated with an STAG, then for all Serving Cells belonging to this TAG: the MAC entity may flush all HARQ buffers; may notify RRC to release PUCCH, if configured; may notify RRC to release SRS, if configured; may clear any configured downlink assignments and configured uplink grants; may clear any PUSCH resource for semi-persistent CSI reporting; and may maintain NTA of this TAG.

In an example, when the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity may consider the timeAlignmentTimer associated with the SCell as expired.

In an example, the MAC entity may not perform any uplink transmission on a Serving Cell except the Random Access Preamble and MSGA transmission when the timeAlignmentTimer associated with the TAG to which this Serving Cell belongs is not running. In an example, when the timeAlignmentTimer associated with the PTAG is not running, the MAC entity may not perform any uplink transmission on any Serving Cell except the Random Access Preamble and MSGA transmission on the SpCell.

In an example, the IE MAC-CellGroupConfig may be used to configure MAC parameters for a cell group, including DRX. In an example, a field/IE tag-Config may be used to configure parameters for a time-alignment group. The field may not be present if a DAPS bearer is configured.

In an example, the IE TAG-Config may be used to configure parameters for a time-alignment group. A field tag-Id may indicate the TAG of the SpCell or an SCell. The tag-Id may uniquely identify the TAG within the scope of a Cell Group (e.g., MCG or SCG). A field timeAlignmentTimer may indicate a value in ms of the timeAlignmentTimer for TAG with ID tag-Id.

In an example, uplink grant may be received dynamically on the PDCCH, in a Random Access Response, configured semi-persistently by RRC or determined to be associated with the PUSCH resource of MSGA. The MAC entity may have an uplink grant to transmit on the UL-SCH. To perform the requested transmissions, the MAC layer may receive HARQ information from lower layers. An uplink grant addressed to CS-RNTI with NDI=0 may be considered as a configured uplink grant. An uplink grant addressed to CS-RNTI with NDI=1 may be considered as a dynamic uplink grant.

In an example, the MAC entity may have a C-RNTI, a Temporary C-RNTI, or CS-RNTI. The MAC entity may receive an uplink grant based on monitoring a PDCCH occasion for a Serving Cell belonging to a TAG that has a running timeAlignmentTimer.

In an example, an uplink grant for a Serving Cell may have been received on the PDCCH for the MAC entity's C-RNTI or Temporary C-RNTI; or an uplink grant may have been received in a Random Access Response. If the uplink grant is for MAC entity's C-RNTI and if the previous uplink grant delivered to the HARQ entity for the same HARQ process was either an uplink grant received for the MAC entity's CS-RNTI or a configured uplink grant, the wireless device may consider the NDI to have been toggled for the corresponding HARQ process regardless of the value of the NDI. If the uplink grant is for MAC entity's C-RNTI, and the identified HARQ process is configured for a configured uplink grant: the wireless device may start or restart the configuredGrantTimer for the corresponding HARQ process, if configured; and the wireless device may stop the cg-RetransmissionTimer for the corresponding HARQ process, if running. The wireless device may deliver the uplink grant and the associated HARQ information to the HARQ entity.

In an example, an uplink grant for a PDCCH occasion may have been received for a Serving Cell on the PDCCH for the MAC entity's CS-RNTI. The NDI in the received HARQ information may be 1. The wireless device may consider the NDI for the corresponding HARQ process not to have been toggled; may start or restart the configuredGrantTimer for the corresponding HARQ process, if configured; may stop the cg-RetransmissionTimer for the corresponding HARQ process, if running; and may deliver the uplink grant and the associated HARQ information to the HARQ entity.

In an example, an uplink grant for a PDCCH occasion may have been received for a Serving Cell on the PDCCH for the MAC entity's CS-RNTI. The NDI in the received HARQ information may be 0. If PDCCH contents indicate configured grant Type 2 deactivation: the wireless device may trigger configured uplink grant confirmation. If PDCCH contents indicate configured grant Type 2 activation: the wireless device may trigger configured uplink grant confirmation; the wireless device may trigger configured uplink grant confirmation; may store the uplink grant for the Serving Cell and the associated HARQ information as configured uplink grant; the wireless device may initialize or re-initialize the configured uplink grant for the Serving Cell to start in the associated PUSCH duration and to recur according to rules; the wireless device may stop the configuredGrantTimer for the corresponding HARQ process, if running; the wireless device may stop the cg-RetransmissionTimer for the corresponding HARQ process, if running.

In an example, when the UE is scheduled to transmit a transport block and no CSI report, or the UE is scheduled to transmit a transport block and a CSI report(s) on PUSCH by a DCI, the ‘Time domain resource assignment’ field value m of the DCI may provide a row index m+1 to an allocated table. The indexed row may define the slot offset K2, the start and length indicator SLIV, or directly the start symbol S and the allocation length L, the PUSCH mapping type, and the number of repetitions (if numberOfRepetitions is present in the resource allocation table) to be applied in the PUSCH transmission.

In an example, when the UE is scheduled to transmit a PUSCH with no transport block and with a CSI report(s) by a ‘CSI request’ field on a DCI, the ‘Time domain resource assignment’ field value m of the DCI may provide a row index m+1 to the allocated table. The indexed row may define the start and length indicator SLIV, or directly the start symbol S and the allocation length L, and the PUSCH mapping type to be applied in the PUSCH transmission and the K2 value may be determined as

$${K}_{2} = {max}_{j} {Y}_{j} ( m + 1 ) ,$$

where Yⱼ, j=0, . . . N_{Rep}−1 are the corresponding list entries of a higher layer parameter in CSI-ReportConfig for the N_{Rep} triggered CSI Reporting Settings and Yⱼ(m+1) is the (m+1)th entry of Yⱼ. The higher layer parameter may be reportSlotOffsetListDCI-0-2, if PUSCH is scheduled by DCI format 0_2 and reportSlotOffsetListDCI-0-2 is configured; the higher layer parameter may be reportSlotOffsetListDCI-0-1, if PUSCH is scheduled by DCI format 0_1 and reportSlotOffsetListDCI-0-1 is configured; otherwise the higher layer parameter may be reportSlotOffsetList.

In an example, the slot Ks where the UE may transmit the PUSCH may be determined by

$$K 2 as Ks = ⌊ n \cdot \frac{{2}^{{μ}_{PUSCH}}}{{2}^{{μ}_{PDCCH}}} ⌋ + {K}_{2} + ⌊ ( \frac{{N}_{slot , offset , PDCCH}^{CA}}{{2}^{{μ}_{offset , PDCCH}}} - \frac{{N}_{slot , offset , PUSCH}^{CA}}{{2}^{{μ}_{offset , PDCCH}}} \cdot {2}^{{μ}_{PUSCH}} ⌋ ,$$

if UE is configured with ca-SlotOffset for at least one of the scheduled and scheduling cell,

$$Ks = ⌊ n \cdot \frac{{2}^{{μ}_{PUSCH}}}{{2}^{{μ}_{PDCCH}}} ⌋ + {K}_{2} ,$$

otherwise, and where n may be the slot with the scheduling DCI, K2 may be based on the numerology of PUSCH, and μ_{PUSCH} and μ_{PDCCH} may be the subcarrier spacing configurations for PUSCH and PDCCH, respectively.

In an example, N_{slot,offset,PDCCH}^{CA} and μ_{offset,PDCCH} may be the N_{slot,offset}^{CA} and the μ_{offset}, respectively, which may be determined by higher-layer configured ca-SlotOffset for the cell receiving the PDCCH, N_{slot,offset,PUSCH}^{CA} and μ_{offset,PUSCH} may be the N_{slot,offset}^{CA} and the μ_{offset}, respectively, which may be determined by higher-layer configured ca-SlotOffset for the cell transmitting the PUSCH.

In an example, for PUSCH scheduled by DCI format 0_1, if pusch-RepTypeIndicatorDCI-0-1 is set to ‘pusch-RepTypeB’, the UE may apply PUSCH repetition Type B procedure when determining the time domain resource allocation. For PUSCH scheduled by DCI format 0_2, if pusch-RepTypeIndicatorDCI-0-2 is set to ‘pusch-RepTypeB’, the UE may apply PUSCH repetition Type B procedure when determining the time domain resource allocation. Otherwise, the UE may apply PUSCH repetition Type A procedure when determining the time domain resource allocation for PUSCH scheduled by PDCCH.

In an example, for PUSCH repetition Type A, the starting symbol S relative to the start of the slot, and the number of consecutive symbols L counting from the symbol S allocated for the PUSCH may be determined from the start and length indicator SLIV of the indexed row: if (L−1)≤7 then SLIV=14·(L−1)+S, otherwise SLIV=14·(14−L+1)+(14−1−S), where 0<L≤14−S.

In an example, for PUSCH repetition Type B, the starting symbol S relative to the start of the slot, and the number of consecutive symbols L counting from the symbol S allocated for the PUSCH may be provided by startSymbol and length of the indexed row of the resource allocation table, respectively.

In an example, for PUSCH repetition Type A, the PUSCH mapping type may be set to Type A or Type B as given by the indexed row.

In an example, for PUSCH repetition Type B, the PUSCH mapping type may be set to Type B.

In an example, for PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K may be determined. If numberOfRepetitions is present in the resource allocation table, the number of repetitions K may be equal to numberOfRepetitions; if the UE is configured with pusch-AggregationFactor, the number of repetitions K may be equal to pusch-AggregationFactor; otherwise K=1.

In an example, if a UE is configured with higher layer parameter pusch-TimeDomainAllocationListForMultiPUSCH, the UE may not expect to be configured with pusch-AggregationFactor.

In an example, for PUSCH repetition Type A, in case K>1, the same symbol allocation may be applied across the K consecutive slots and the PUSCH may be limited to a single transmission layer. The UE may repeat the TB across the K consecutive slots applying the same symbol allocation in each slot. The redundancy version to be applied on the nth transmission occasion of the TB, where n=0, 1, . . . K−1, may be determined according to a table.

In an example, when transmitting MsgA PUSCH on a non-initial UL BWP, if the UE is configured with startSymbolAndLengthMsgA-PO, the UE may determine the S and L from startSymbolAndLengthMsgA-PO.

In an example, when transmitting MsgA PUSCH, if the UE is not configured with startSymbolAndLengthMsgA-PO, and if the TDRA list PUSCH-TimeDomainResourceAllocationList is provided in PUSCH-ConfigCommon, the UE may use msgA-PUSCH-TimeDomainAllocation to indicate which values are used in the list. If PUSCH-TimeDomainResourceAllocationList is not provided in PUSCH-ConfigCommon, the UE may use parameters S and L from a corresponding table where msgA-PUSCH-TimeDomainAllocation may indicate which values may be used in the list.

In an example, for PUSCH repetition Type A, a PUSCH transmission in a slot of a multi-slot PUSCH transmission may be omitted according to conditions.

In an example, for PUSCH repetition Type B, except for PUSCH transmitting CSI report(s) with no transport block, the number of nominal repetitions may be given by numberOfRepetitions. For the n-th nominal repetition, n=0, . . . , numberOfRepetitions−1, the slot where the nominal repetition starts or ends may be determined. The slot where the nominal repetition starts may be given by

$${K}_{S} + ⌊ \frac{S + n \cdot L}{{N}_{symb}^{slot}} ⌋ ,$$

and the starting symbol relative to the start of the slot may be given by mod(S+n·L, N_{symb}^{slot}). The slot where the nominal repetition ends may be given by

$${K}_{S} + ⌊ \frac{S + ( n + 1 ) \cdot L - 1}{{N}_{symb}^{slot}} ⌋ ,$$

and the ending symbol relative to the start of the slot may be given by mod(S+(n+1)·L−1, N_{symb}^{slot}). The Kₛ may be the slot where the PUSCH transmission starts, and N_{symb}^{slot} may be the number of symbols per slot.

In an example, for PUSCH repetition Type B, the UE may determine invalid symbol(s) for PUSCH repetition Type B transmission.

In an example, a symbol that is indicated as downlink by tdd-UL-DL-ConfigurationCommon or tdd-UL-DL-ConfigurationDedicated may be considered as an invalid symbol for PUSCH repetition Type B transmission.

In an example, for operation in unpaired spectrum, symbols indicated by ssb-PositionsInBurst in SIB1 or ssb-PositionsInBurst in ServingCellConfigCommon for reception of SS/PBCH blocks may be considered as invalid symbols for PUSCH repetition Type B transmission.

In an example, for operation in unpaired spectrum, symbol(s) indicated by pdcch-ConfigSIB1 in MIB for a CORESET for Type0-PDCCH CSS set may be considered as invalid symbol(s) for PUSCH repetition Type B transmission.

In an example, for operation in unpaired spectrum, if numberOfInvalidSymbolsForDL-UL-Switching is configured, numberOfInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated are considered as invalid symbol(s) for PUSCH repetition Type B transmission. The symbol(s) given by numberOfInvalidSymbolsForDL-UL-Switching are defined using the reference SCS configuration referenceSubcarrierSpacing provided in tdd-UL-DL-ConfigurationCommon.

In an example, the UE may be configured with the higher layer parameter invalidSymbolPattern, which may provide a symbol level bitmap spanning one or two slots (higher layer parameter symbols given by invalidSymbolPattern). A bit value equal to 1 in the symbol level bitmap symbols may indicate that the corresponding symbol is an invalid symbol for PUSCH repetition Type B transmission. The UE may be additionally configured with a time-domain pattern (higher layer parameter periodicityAndPattern given by invalidSymbolPattern), where each bit of periodicityAndPattern may correspond to a unit equal to a duration of the symbol level bitmap symbols, and a bit value equal to 1 may indicate that the symbol level bitmap symbols is present in the unit. The periodicityAndPattern may be {1, 2, 4, 5, 8, 10, 20 or 40} units long, but maximum of 40 msec. The first symbol of periodicityAndPattern every 40 msec/P periods may be a first symbol in frame nf mod 4=0, where P may be the duration of periodicityAndPattern in units of msec. When periodicityAndPattern is not configured, for a symbol level bitmap spanning two slots, the bits of the first and second slots may correspond respectively to even and odd slots of a radio frame, and for a symbol level bitmap spanning one slot, the bits of the slot correspond to every slot of a radio frame. If invalidSymbolPattern is configured, when the UE applies the invalid symbol pattern may be determined.

In an example, for PUSCH repetition Type B, after determining the invalid symbol(s) for PUSCH repetition type B transmission for each of the K nominal repetitions, the remaining symbols may be considered as potentially valid symbols for PUSCH repetition Type B transmission. If the number of potentially valid symbols for PUSCH repetition type B transmission is greater than zero for a nominal repetition, the nominal repetition may consist of one or more actual repetitions, where each actual repetition may consist of a consecutive set of all potentially valid symbols that may be used for PUSCH repetition Type B transmission within a slot. An actual repetition with a single symbol may be omitted except for the case of L=1. An actual repetition may be omitted according to the conditions. The UE may repeat the TB across actual repetitions. The redundancy version to be applied on the nth actual repetition (with the counting including the actual repetitions that are omitted) may be determined.

In an example, for PUSCH repetition Type B, when a UE receives a DCI that schedules aperiodic CSI report(s) or activates semi-persistent CSI report(s) on PUSCH with no transport block by a ‘CSI request’ field on a DCI, the number of nominal repetitions may be assumed to be 1, regardless of the value of numberOfRepetitions. When the UE is scheduled to transmit a PUSCH repetition Type B with no transport block and with aperiodic or semi-persistent CSI report(s) by a ‘CSI request’ field on a DCI, the first nominal repetition may be expected to be the same as the first actual repetition. For PUSCH repetition Type B carrying semi-persistent CSI report(s) without a corresponding PDCCH after being activated on PUSCH by a ‘CSI request’ field on a DCI, if the first nominal repetition is not the same as the first actual repetition, the first nominal repetition may be omitted; otherwise, the first nominal repetition may be omitted according to conditions.

In an example, for PUSCH repetition Type B, when a UE is scheduled to transmit a transport block and aperiodic CSI report(s) on PUSCH by a ‘CSI request’ field on a DCI, the CSI report(s) may be multiplexed on the first actual repetition. The UE may not expect that the first actual repetition have a single symbol duration.

In an example, if pusch-TimeDomainAllocationListForMultiPUSCH in pusch-Config contains row indicating resource allocation for two to eight contiguous PUSCHs, K2 may indicate the slot where UE may transmit the first PUSCH of the multiple PUSCHs. Each PUSCH may have a separate SLIV and mapping type. The number of scheduled PUSCHs may be signaled by the number of indicated valid SLIVs in the row of the pusch-TimeDomainAllocationListForMultiPUSCH signalled in DCI format 0_1.

In an example, when the UE is configured with minimumSchedulingOffsetK2 in an active UL BWP it may apply a minimum scheduling offset restriction indicated by the ‘Minimum applicable scheduling offset indicator’ field in DCI format 0_1 or DCI format 1_1 if the same field is available. When the UE configured with minimumSchedulingOffsetK2 in an active UL BWP and it has not received ‘Minimum applicable scheduling offset indicator’ field in DCI format 0_1 or 1_1, the UE may apply a minimum scheduling offset restriction indicated based on ‘Minimum applicable scheduling offset indicator’ value ‘0’. When the minimum scheduling offset restriction is applied the UE may not be expected to be scheduled with a DCI in slot n to transmit a PUSCH scheduled with C-RNTI, CS-RNTI, MCS-C-RNTI or SP-CSI-RNTI with K2 smaller than

$$⌈ {K}_{2 min} \cdot \frac{{2}^{{μ}^{′}}}{{2}^{μ}} ⌉ ,$$

where K2 min and μ are the applied minimum scheduling offset restriction and the numerology of the active UL BWP of the scheduled cell when receiving the DCI in slot n, respectively, and μ′ is the numerology of the new active UL BWP in case of active UL BWP change in the scheduled cell and may be equal to μ, otherwise. The minimum scheduling offset restriction may not be applied when PUSCH transmission is scheduled by RAR UL grant or fallbackRAR UL grant for RACH procedure, or when PUSCH is scheduled with TC-RNTI.

In an example, the higher layer parameter repK-RV may define the redundancy version pattern to be applied to the repetitions. If cg-RetransmissionTimer is provided, the redundancy version for uplink transmission with a configured grant may be determined by the UE. If the parameter repK-RV is not provided in the configuredGrantConfig and cg-RetransmissionTimer is not provided, the redundancy version for uplink transmissions with a configured grant may be set to 0. If the parameter repK-RV is provided in the configuredGrantConfig and cg-RetransmissionTimer is not provided, for the nth transmission occasion among K repetitions, n=1, 2, . . . , K, it may be associated with (mod(n−1,4)+1)th value in the configured RV sequence. If a configured grant configuration is configured with startingFromRV0 set to ‘off’, the initial transmission of a transport block may start at the first transmission occasion of the K repetitions. Otherwise, the initial transmission of a transport block may start at the first transmission occasion of the K repetitions if the configured RV sequence is {0, 2, 3, 1}; at any of the transmission occasions of the K repetitions that are associated with RV=0 if the configured RV sequence is {0, 3, 0, 3}; and at any of the transmission occasions of the K repetitions if the configured RV sequence is {0, 0, 0, 0}, except the last transmission occasion when K≥8.

In an example, for any RV sequence, the repetitions may be terminated after transmitting K repetitions, or at the last transmission occasion among the K repetitions within the period P, or from the starting symbol of the repetition that overlaps with a PUSCH with the same HARQ process scheduled by DCI format 0_0, 0_1 or 0_2, whichever is reached first. In an example, the UE may terminate the repetition of a transport block in a PUSCH transmission if the UE receives a DCI format 0_1 with DFI flag provided and set to ‘1’, and if in this DCI the UE detects ACK for the HARQ process corresponding to that transport block.

In an example, the UE may not be expected to be configured with the time duration for the transmission of K repetitions larger than the time duration derived by the periodicity P. If the UE determines that, for a transmission occasion, the number of symbols available for the PUSCH transmission in a slot is smaller than transmission duration L, the UE may not transmit the PUSCH in the transmission occasion.

In an example, for Type 1 and Type 2 PUSCH transmissions with a configured grant, when K>1, the UE may repeat the TB across the K consecutive slots applying the same symbol allocation in each slot, except if the UE is provided with higher layer parameters cg-nrofSlots and cg-nrofPUSCH-InSlot, in which case the UE may repeat the TB in the repK earliest consecutive transmission occasion candidates within the same configuration. A Type 1 or Type 2 PUSCH transmission with a configured grant in a slot may be omitted according to conditions.

In an example, for PUSCH transmissions with a Type 1 or Type 2 configured grant, the nominal repetitions and the actual repetitions may be determined according to the procedures for PUSCH repetition Type B. The higher layer configured parameters repK-RV may define the redundancy version pattern to be applied to the repetitions. If the parameter repK-RV is not provided in the configuredGrantConfig, the redundancy version for each actual repetition with a configured grant may be set to 0. Otherwise, for the nth transmission occasion among the actual repetitions (including the actual repetitions that are omitted) of the K nominal repetitions, it may be associated with (mod(n−1,4)+1)th value in the configured RV sequence. If a configured grant configuration is configured with startingFromRV0 set to ‘off’, the initial transmission of a transport block may start at the first transmission occasion of the actual repetitions. Otherwise, the initial transmission of a transport block may start at the first transmission occasion of the actual repetitions if the configured RV sequence is {0, 2, 3, 1}; at any of the transmission occasions of the actual repetitions that are associated with RV=0 if the configured RV sequence is {0, 3, 0, 3}; and any of the transmission occasions of the actual repetitions if the configured RV sequence is {0, 0, 0, 0}, except the actual repetitions within the last nominal repetition when K≥8.

In an example, for any RV sequence, the repetitions may be terminated after transmitting K nominal repetitions, or at the last transmission occasion among the K nominal repetitions within the period P, or from the starting symbol of a repetition that overlaps with a PUSCH with the same HARQ process scheduled by DCI format 0_0, 0_1 or 0_2, whichever is reached first. The UE may not be expected to be configured with the time duration for the transmission of K nominal repetitions larger than the time duration derived by the periodicity P.

In an example, an IE PUSCH-Config may be used to configure the UE specific PUSCH parameters applicable to a particular BWP. A field/parameter pusch-TimeDomainAllocationList may indicate a list of time domain allocations for timing of UL assignment to UL data. The field pusch-TimeDomainAllocationList may apply to DCI formats 0_0 or DCI format 0_1 when the field pusch-TimeDomainAllocationListDCI-0-1 is not configured. The network may not configure the pusch-TimeDomainAllocationList (without suffix) simultaneously with the pusch-TimeDomainAllocationListDCI-0-2-r16 or pusch-TimeDomainAllocationListDCI-0-1-r16 or pusch-TimeDomainAllocationListForMultiPUSCH-r16. A field/parameter pusch-TimeDomainAllocationListDCI-0-1 may indicate configuration of the time domain resource allocation (TDRA) table for DCI format 0_1. A field/parameter pusch-TimeDomainAllocationListDCI-0-2 may indicate configuration of the time domain resource allocation (TDRA) table for DCI format 0_2. A field/parameter pusch-TimeDomainAllocationListForMultiPUSCH may indicate configuration of the time domain resource allocation (TDRA) table for multiple PUSCH. The network may configure at most 16 rows in this TDRA table in PUSCH-TimeDomainResourceAllocationList-r16 configured by this field. This field may not be configured simultaneously with pusch-AggregationFactor.

In an example, an IE PUSCH-ConfigCommon may be used to configure the cell specific PUSCH parameters. A field/parameter pusch-TimeDomainAllocationList may indicate a list of time domain allocations for timing of UL assignment to UL data.

In an example, an IE PUSCH-TimeDomainResourceAllocation may be used to configure a time domain relation between PDCCH and PUSCH. PUSCH-TimeDomainResourceAllocationList may contain one or more of such PUSCH-TimeDomainResourceAllocations. The network may indicate in the UL grant which of the configured time domain allocations the UE may apply for that UL grant. The UE may determine the bit width of the DCI field based on the number of entries in the PUSCH-TimeDomainResourceAllocationList. Value 0 in the DCI field may refer to the first element in this list, value 1 in the DCI field refers to the second element in this list, and so on. A field/parameter k2 may corresponds to L1 parameter ‘K2’. When the field is absent the UE may apply the value 1 when PUSCH SCS is 15/30 kHz; the value 2 when PUSCH SCS is 60 kHz, and the value 3 when PUSCH SCS is 120 KHz. A field/parameter length may indicate the length allocated for PUSCH for DCI format 0_1/0_2. A field/parameter mappingType may indicate a mapping type (e.g., type A, type B, etc.) A field/parameter numberOfRepetitions may indicate a number of repetitions for DCI format 0_1/0_2. A field/parameter puschAllocationList may indicate one or multiple PUSCH continuous in time domain which share a common k2. This list may have one element in pusch-TimeDomainAllocationListDCI-0-1-r16 and in pusch-TimeDomainAllocationListDCI-0-2-r16. A field/parameter startSymbol may indicate the index of start symbol for PUSCH for DCI format 0_1/0_2. A field/parameter startSymbolAndLength may indicate an index giving valid combinations of start symbol and length (jointly encoded) as start and length indicator (SLIV). The network may configure the field so that the allocation does not cross the slot boundary.

In an example, a Logical Channel Prioritization (LCP) procedure may be applied when a new transmission is performed.

In an example, RRC may control the scheduling of uplink data by signaling for each logical channel per MAC entity: priority where an increasing priority value may indicate a lower priority level; prioritisedBitRate which may set the Prioritized Bit Rate (PBR); and bucketSizeDuration which may set the Bucket Size Duration (BSD).

In an example, RRC may additionally control the LCP procedure by configuring one or more of following mapping restrictions for each logical channel: allowedSCS-List which may set the allowed Subcarrier Spacing(s) for transmission; maxPUSCH-Duration which may set the maximum PUSCH duration allowed for transmission; configuredGrantType1Allowed which may set whether a configured grant Type 1 can be used for transmission; allowedServingCells which may set the allowed cell(s) for transmission; allowedCG-List which may set the allowed configured grant(s) for transmission; and allowedPHY-PriorityIndex which may set the allowed PHY priority index(es) of a dynamic grant for transmission.

In an example, the following UE variable Bj may be used for the Logical channel prioritization procedure. Bj may be maintained for each logical channel j.

In an example, The MAC entity may initialize Bj of the logical channel to zero when the logical channel is established.

In an example, for a logical channel j, the MAC entity may increment Bj by the product PBR×T before an instance of the LCP procedure, where T may be the time elapsed since Bj was last incremented. If the value of Bj is greater than the bucket size (i.e., PBR×BSD), the MAC entity may set Bj to the bucket size.

In an example, the MAC entity may select the logical channels for each UL grant that satisfy the following conditions when a new transmission is performed. The set of allowed Subcarrier Spacing index values in allowedSCS-List, if configured, may include the Subcarrier Spacing index associated to the UL grant; and maxPUSCH-Duration, if configured, may be larger than or equal to the PUSCH transmission duration associated to the UL grant; and configuredGrantTypelAllowed, if configured, may be set to true in case the UL grant is a Configured Grant Type 1; and allowedServingCells, if configured, may include the Cell information associated to the UL grant; allowedCG-List, if configured, may include the configured grant index associated to the UL grant; and allowedPHY-PriorityIndex, if configured, may include the priority index associated to the dynamic UL grant.

In an example, the Subcarrier Spacing index, PUSCH transmission duration, Cell information, and priority index may be included in Uplink transmission information received from lower layers for the corresponding scheduled uplink transmission.

In an example, the MAC entity may multiplex MAC CEs and MAC SDUs in a MAC PDU.

In an example, content of a MAC PDU may not change after being built for transmission on a dynamic uplink grant, regardless of LBT outcome.

In an example, if a UE would multiplex UCI in a PUCCH transmission that overlaps with a PUSCH transmission, and the PUSCH and PUCCH transmissions fulfill one or more conditions for UCI multiplexing, the UE may multiplex HARQ-ACK information, if any, from the UCI in the PUSCH transmission and may not transmit the PUCCH if the UE multiplexes aperiodic or semi-persistent CSI reports in the PUSCH; and the UE may multiplex HARQ-ACK information and CSI reports, if any, from the UCI in the PUSCH transmission and may not transmit the PUCCH if the UE does not multiplex aperiodic or semi-persistent CSI reports in the PUSCH.

In an example, a UE may not expect to multiplex in a PUSCH transmission in one slot with SCS configuration μ₁ UCI of same type that the UE would transmit in PUCCHs in different slots with SCS configuration μ₂ if μ₁<μ₂.

In an example, a UE may not expect to multiplex in a PUSCH transmission or in a PUCCH transmission HARQ-ACK information that the UE would transmit in different PUCCHs.

In an example, a UE may not expect a PUCCH resource that results from multiplexing overlapped PUCCH resources, if applicable, to overlap with more than one PUSCHs if each of the more than one PUSCHs includes aperiodic CSI reports.

In an example, a UE may not expect to detect a DCI format scheduling a PDSCH reception or a SPS PDSCH release, a DCI format 1_1 indicating SCell dormancy, or a DCI format including a One-shot HARQ-ACK request field with value 1, and indicating a resource for a PUCCH transmission with corresponding HARQ-ACK information in a slot if the UE previously detects a DCI format scheduling a PUSCH transmission in the slot and if the UE multiplexes HARQ-ACK information in the PUSCH transmission.

In an example, if a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs are fulfilled, the UE may multiplex only the HARQ-ACK information in the PUSCH and may not transmit the PUCCH.

In an example, if a UE transmits multiple PUSCHs in a slot on respective serving cells that include first PUSCHs that are scheduled by DCI formats and second PUSCHs configured by respective ConfiguredGrantConfig or semiPersistentOnPUSCH, and the UE may multiplex UCI in one of the multiple PUSCHs, and the multiple PUSCHs fulfil the conditions for UCI multiplexing, the UE may multiplex the UCI in a PUSCH from the first PUSCHs.

In an example, if a UE transmits multiple PUSCHs in a slot on respective serving cells and the UE would multiplex UCI in one of the multiple PUSCHs and the UE does not multiplex aperiodic CSI in any of the multiple PUSCHs, the UE may multiplex the UCI in a PUSCH of the serving cell with the smallest ServCellIndex subject to the conditions for UCI multiplexing being fulfilled. If the UE transmits more than one PUSCHs in the slot on the serving cell with the smallest ServCellIndex that fulfil the conditions for UCI multiplexing, the UE may multiplex the UCI in the earliest PUSCH that the UE transmits in the slot.

In an example, if a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions for multiplexing the HARQ-ACK and/or CSI information, the UE may multiplex the HARQ-ACK and/or CSI information in the PUSCH transmission in the one or more slots. The UE may not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

In an example, if a UE transmits a PUSCH with repetition Type B and the UE would transmit a PUCCH with HARQ-ACK and/or CSI information over a single slot that overlaps with the PUSCH transmission in one or more slots, the UE may expect actual repetitions of the PUSCH transmission that would overlap with the PUCCH transmission to fulfill the conditions for multiplexing the HARQ-ACK and/or CSI information, and the UE may multiplex the HARQ-ACK and/or CSI information in the earliest actual PUSCH repetition of the PUSCH transmission that would overlap with the PUCCH transmission and includes more than one symbol. The UE may not expect that actual repetitions that would overlap with the PUCCH transmission do not include more than one symbol.

In an example, if the PUSCH transmission over the multiple slots is scheduled by a DCI format that includes a DAI field, the value of the DAI field may be applicable for multiplexing HARQ-ACK information in the PUSCH transmission in any slot from the multiple slots where the UE multiplexes HARQ-ACK information.

In an example, when a UE would multiplex HARQ-ACK information in a PUSCH transmission that is configured by a ConfiguredGrantConfig, and includes CG-UCI, the UE may multiplex the HARQ-ACK information in the PUSCH transmission if the UE is provided cg-UCI-Multiplexing; otherwise, the UE may not transmit the PUSCH and may multiplex the HARQ-ACK information in a PUCCH transmission or in another PUSCH transmission.

In an example, offset values may be defined for a UE to determine a number of resources for multiplexing HARQ-ACK information and for multiplexing CSI reports in a PUSCH. Offset values may also be defined for multiplexing CG-UCI in a CG-PUSCH. The offset values may be signaled to a UE either by a DCI format scheduling the PUSCH transmission or by higher layers.

In an example, if a DCI format that does not include a beta_offset indicator field schedules the PUSCH transmission from the UE and the UE is provided betaOffsets=‘semiStatic’, the UE may apply the β_{offset}^{HARQ-ACK}, β_{offset}^{CSI-1}, and β_{offset}^{CSI-2} values that are provided by betaOffsets=‘semiStatic’ for the corresponding HARQ-ACK information, Part 1 CSI reports and Part 2 CSI reports.

In an example, if the PUSCH transmission is with a configured grant and the UE is provided CG-UCI-OnPUSCH=‘semiStatic’, the UE may apply the β_{offset}^{HARQ-ACK}, β_{offset}^{CSI-1}, and β_{offset}^{CSI-2} values that are provided by CG-UCI-OnPUSCH=‘semiStatic’ for the corresponding HARQ-ACK information, Part 1 CSI reports and Part 2 CSI reports.

In an example, if the PUSCH is scheduled by DCI format 0_0 and the UE is provided betaOffsets=‘dynamic’, the UE may apply the β_{offset}^{HARQ-ACK}, β_{offset}^{CSI-1}, and β_{offset}^{CSI-2} values that are determined form the first value of betaOffsets=‘dynamic’.

In an example, if the PUSCH is a configured grant Type 2 PUSCH activated by DCI format 0_0 and the UE is provided CG-UCI-OnPUSCH=‘dynamic’, the UE may apply the β_{offset}^{HARQ-ACK}, β_{offset}^{CSI-1}, and β_{offset}^{CSI-2} values that are determined from the first value of CG-UCI-OnPUSCH=‘dynamic’.

In an example, there may be two types of transmission without dynamic grant: configured grant Type 1 where an uplink grant may be provided by RRC, and may be stored as configured uplink grant; and configured grant Type 2 where an uplink grant may be provided by PDCCH, and may be stored or cleared as configured uplink grant based on L1 signalling indicating configured uplink grant activation or deactivation.

In an example, Type 1 and Type 2 may be configured by RRC for a Serving Cell per BWP. Multiple configurations may be active simultaneously in the same BWP. For Type 2, activation and deactivation may be independent among the Serving Cells. For the same BWP, the MAC entity may be configured with both Type 1 and Type 2.

In an example, RRC may configure one o more of the following parameters when the configured grant Type 1 is configured: cs-RNTI: CS-RNTI for retransmission; periodicity: periodicity of the configured grant Type 1; timeDomainOffset: Offset of a resource with respect to SFN=timeReferenceSFN in time domain; timeDomainAllocation: Allocation of configured uplink grant in time domain which may contain startSymbolAndLength (e.g., SLIV) or startSymbol (e.g., S); nrofHARQ-Processes: the number of HARQ processes for configured grant; harq-ProcID-Offset: offset of HARQ process for configured grant for operation with shared spectrum channel access; harq-ProcID-Offset2: offset of HARQ process for configured grant; timeReferenceSFN: SFN used for determination of the offset of a resource in time domain. The UE may use the closest SFN with the indicated number preceding the reception of the configured grant configuration.

In an example, RRC may configure one or more of the following parameters when the configured grant Type 2 is configured: cs-RNTI: CS-RNTI for activation, deactivation, and retransmission; periodicity: periodicity of the configured grant Type 2; nrofHARQ-Processes: the number of HARQ processes for configured grant; harq-ProcID-Offset: offset of HARQ process for configured grant for operation with shared spectrum channel access; harq-ProcID-Offset2: offset of HARQ process for configured grant.

In an example, RRC may configure the following parameters when retransmissions on configured uplink grant is configured: cg-RetransmissionTimer: the duration after a configured grant (re)transmission of a HARQ process when the UE may not autonomously retransmit that HARQ process.

In an example, upon configuration of a configured grant Type 1 for a BWP of a Serving Cell by upper layers, the MAC entity may: store the uplink grant provided by upper layers as a configured uplink grant for the indicated BWP of the Serving Cell; initialize or re-initialize the configured uplink grant to start in the symbol according to timeDomainOffset, timeReferenceSFN, and S (derived from SLIV or provided by startSymbol), and to reoccur with periodicity.

In an example, after an uplink grant is configured for a configured grant Type 1, the MAC entity may consider sequentially that the N^{th} (N>=0) uplink grant occurs in the symbol for which: [(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot).

In an example, after an uplink grant is configured for a configured grant Type 2, the MAC entity may consider sequentially that the N^{th} (N>=0) uplink grant occurs in the symbol for which: [(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity] modulo (1024×numberOfSlotsPerFrame×numberOfSymbolsPerSlot).

where SFN_{start time}, slot_{start time}, and symbol_{start time} may be the SFN, slot, and symbol, respectively, of the first transmission opportunity of PUSCH where the configured uplink grant was (re-)initialized.

In an example, if cg-nrofPUSCH-InSlot or cg-nrofSlots is configured for a configured grant Type 1 or Type 2, the MAC entity may consider the uplink grants occur in those additional PUSCH allocations.

In an example, in case of unaligned SFN across carriers in a cell group, the SFN of the concerned Serving Cell may be used to calculate the occurrences of configured uplink grants.

In an example, when the configured uplink grant is released by upper layers, the corresponding configurations may be released and all corresponding uplink grants may be cleared.

In an example, retransmissions may use: repetition of configured uplink grants; or received uplink grants addressed to CS-RNTI; or configured uplink grants with cg-RetransmissionTimer configured.

Example embodiments enhance PUSCH based on processing a transport block (TB) over multi-slot PUSCH, e.g., based on transmission of the TB/PUSCH via radio resources of a plurality of slots. Example embodiments may apply to FR1 and/or FR2 (e.g., cells operating in FR1 and/or FR2 frequency range) as well as to TDD and FDD. In an example, a transport block size (TBS) may be determined based on multiple slots and the TB may be transmitted over multiple slots. A TB transmitted/scheduled for transmission over multiple slots and via multi-slot PUSCH may be referred to as a TB over multiple slots (TBoMS) transport block.

In an example, for TBS determination of TBoMS: N_{ohpRB} may be configured by an xOverhead configuration parameter and may represent the overhead per slot. For TBS determination of TBoMS, N_{ohpRB} may be assumed to be the same for all the slots over which the TBoMS transmission is allocated.

In an example, time domain resource determination for TBoMS may be performed via PUSCH repetition Type A like time domain resource allocation (TDRA), e.g., the number of allocated symbols may be the same in each slot of the plurality of slots of the TBoMS.

In an example, allocating resources for TBoMS in the special slot in TDD may be possible.

In an example, a transmission occasion for TBoMS (e.g., referred to as TOT) may be constituted of at least one slot or multiple consecutive physical slots for UL transmission.

In an example, the TBoMS may be based on a single redundancy version (RV). The single RV may not be constrained to have the same coded bits in each slot or in each TOT.

In an example, for rate-matching for TBoMS, rate-matching may be performed per slot. The time unit for the bit selection and bit interleaving may be a slot.

In an example, for rate-matching for TBoMS, rate matching may be performed continuously across the allocated slot(s) per TOT. The time unit for the bit selection and bit interleaving may be the allocated slots per TOT.

In an example, for rate-matching for TBoMS, rate matching may be performed continuously across the allocated slots/TOTs for TBoMS. The time unit for the bit selection and bit interleaving may be the allocated slots/TOTs for TBoMS.

In an example, the number of slots allocated for TBoMS may be determined by using a row index of a TDRA list, configured via RRC.

In an example, the following approach may be used to calculate N_{Info} for TBoMS: based on the number of REs determined in the first L symbols over which the TBoMS transmission is allocated, scaled by K≥1. L may be the number of symbols determined using the slot and length indicator value (SLIV) of PUSCH indicated via TDRA.

In an example, the symbols over which the TBoMS transmission is allocated may be the same as the symbols over which the TBoMS transmission is performed.

In an example, the symbols over which the TBoMS transmission is allocated may be different from the symbols over which the TBoMS transmission is performed.

In an example, non-consecutive physical slots for UL transmission may be used to transmit TBoMS at least for unpaired spectrum.

In an example, non-consecutive physical slots for UL transmission may be used to transmit TBoMS for paired spectrum and SUL band as well.

In an example, a transmission occasion for TBoMS (TOT) may be constituted of time domain resources which may or may not span multiple slots.

In an example, multiple slots which constitute a TOT may be consecutive or non-consecutive physical slots for UL transmissions.

In an example, one TOT may be determined for a TBoMS. The TB may be transmitted on the TOT using a single RV. In an example, the single RV may be rate matched across the TOT e.g., based on continuous rate matching across the TOT In an example, the single RV may be rate matched for each slot.

In an example, one TOT may be determined for a TBoMS. The TB may be transmitted on the TOT using different RVs. In an example, the RV index may be refreshed within the TOT e.g. after each slot boundary, at every jump between two non-contiguous resources, if any.

In an example, multiple TOTs may be determined for a TBoMS. The TB may be transmitted on the multiple TOTs using a single RV. In an example, the single RV may be rate matched across single or multiple TOTs, e.g., rate matched for each TOT rate matched for all the TOTs, rate matched for each slot and so on.

In an example, multiple TOTs may be determined for a TBoMS. The TB may be transmitted on the multiple TOTs using different RVs. In an example, the RV index may be refreshed within one TOT e.g., after each slot boundary, at every jump between two non-contiguous resources, if any.

In an example, a single TBoMS can be repeated.

In an example, consecutive physical slots for UL transmission may be used for TBoMS for unpaired spectrum.

In an example, for TBoMS for unpaired spectrum, non-consecutive physical slots for UL transmission may be used.

In an example, consecutive physical slots for UL transmission may be used for TBoMS for paired spectrum and the SUL band.

In an example, for TBoMS for paired spectrum and the SUL band, non-consecutive physical slots for UL transmission may be used.

In an example, the same number of PRBs per symbol may be allocated across slots for TBoMS transmission.

In an example, to calculate N_{ohPRB} for TBoMS, N_{ohPRB} may be assumed to be the same for the slots over which the TBoMS transmission is allocated and may be configured by xOverhead.

In an example, to calculate N_{ohPRB} for TBoMS, N_{ohPRB} may be calculated depending on both xOverhead and the number of symbols or slots over which the TBoMS transmission is allocated.

In an example, the number of slots allocated for TBoMS may be counted based on the available slots for UL transmission.

In an example, TBoMS may be based on a dynamic grant, e.g., based on receiving a DCI indicating scheduling information for the TBoMS.

In an example, TBoMS may be based on configured grant. A wireless device may receive configured grant configuration parameters and the generation and/or transmission of the TBoMS may be based on the configured grant configuration parameters.

In an example, to calculate N_{info} for TBS determination, at least the scaling factor value K=N may be supported, where N may be the number of allocated slots for a single TBoMS.

In an example, a single TBoMS may be repeated. The number of repetitions may be denoted by M, i.e., the total number of allocated slots for TBoMS repetition may be M*N. The number and location of allocated symbols within an allocated slot for TBoMS transmission are the same among all repeated single TBoMS.

In an example, the UE may determine whether or not to drop a slot determined as available for TBoMS transmission based on PUSCH dropping rules, where the dropped slot is still counted in the N allocated slots for the single TBoMS transmission.

In an example, the N allocated slots for the single TBoMS may be defined as the number of slots after available slot determination for a single TBoMS transmission, before dropping rules are applied. In an example, the number of final transmitted slots for the single TBoMS may be lower than N, depending on dropping rules for TBoMS transmission.

In an example, the transmission power determination of TBoMS may be based on the resource elements (REs) allocated in one available slot for the TBoMS transmission, excluding the overhead of reference signals.

In an example, the transmission power determination of TBoMS may be based on the REs allocated in the N available slots for the TBoMS transmission, excluding the overhead of reference signals.

In an example, the number of MIMO layers (rank) for TBoMS transmission may be limited to 1.

In an example, the number N of allocated slots for TBoMS may be indicated via a column of the TDRA table configured via PUSCH-TimeDomainAllocationList. The column for configuring the number of repetitions in the TDRA for PUSCH repetition Type A, i.e., numberOfRepetitions, may be used for indicating the number of repetitions M of a single TBoMS, when TBoMS transmission is enabled.

For the repetition of a single TBoMS transmission, redundancy versions (RVs) may be cycled across the TBoMS repetitions.

In an example, at least the following values may be supported for the number N of allocated slots for the single TBoMS: {2, 4, 8}.

In an example, the following values may be supported for the number M of repetitions of the single TBoMS: {1, 2, 3, 4, 7, 8, 12, 16}.

In an example, for TBoMS, bit interleaving may be performed per slot. The index of the starting coded bit for each transmitted slot may be predetermined prior to the start of the TBoMS transmission.

In an example, UCI multiplexing bits or cancellation/dropping of coded bits, if any, may be known prior to the determination of the index of the starting coded bit for each transmitted slot or not.

In an example, for the bit selection for each transmitted slot for TBoMS and for determining the index of the starting coded bit in the circular buffer, the index of the starting coded bit in the circular buffer may be the index continuous from the position of the last bit selected in the previous allocated slot.

In an example, for the bit selection for each transmitted slot for TBoMS and for determining the index of the starting coded bit in the circular buffer, the index of the starting coded bit in the circular buffer may be the index continuous from the position of the last bit selected in the previous allocated slot, regardless of whether UCI multiplexing occurred in the previous allocated slot or not.

In an example, dropping/cancellation rules may not be considered for the starting bit position determination.

In an example, for TBoMS transmission, TBoMS feature may be enabled (or disabled) by configuring (or not) the number of allocated slots for a single TBoMS (N) in a row of the TDRA table. TBoMS transmission may be enabled when N>1, where N may be the number of allocated slots for a single TBoMS. Single-slot PUSCH transmission may be enabled when N=1. Supported combinations of N and M that can be configured in the TDRA table.

A wireless device may be scheduled for transmission of a transport block (TB) over multiple slots. A TB scheduled for transmission over multiple slots may be referred to as a TBoMS. Existing wireless device processes when a TB is scheduled for transmission over multiple slots may lead to degraded and inefficient wireless device processes. There is a need to enhance existing wireless device processes when the wireless device is scheduled for transmission of a TB over multiple slots. Example embodiments enhance the existing wireless device processes when the wireless device is scheduled for transmission of a TB over multiple slots.

In example embodiments, a wireless device may receive one or more messages (e.g., one or more RRC messages) comprising configuration parameters. The one or more messages may comprise configuration parameters of a cell or a plurality of cells (e.g., in case of carrier aggregation or dual connectivity operation). The plurality of cells may be provided by a single base station or by multiple base stations (e.g., in case of dual connectivity). The plurality of cells may be grouped into one or more cell groups (e.g., timing advance groups (TAGs)). In an example, the configuration parameters of a cell may indicate a cell group (e.g., a TAG) associated with the cell (e.g., may comprise an identifier of the cell group (e.g., TAG) associated with the cell). The configuration parameters may comprise one or more parameters to be used by the wireless device in transmission of a transport block (TB) over multiple slots (TBoMS). The wireless device may transmit a TBoMS in a plurality of slots. In an example, the plurality of slots may comprise consecutive/adjacent slots. In an example, the plurality of slots may comprise non-consecutive/non-adjacent slots.

A mapping process may map a plurality of bits in the TB/TBoMS to radio resources (e.g., radio resources of a serving cell) in the plurality of slots. In an example, the mapping process may be type A mapping. In an example, the mapping process may be type B mapping. In an example, the symbol numbers of each slot of the plurality of slots (that the TBoMS is scheduled for transmission) to which data is mapped may be the same across the plurality of slots. In an example, the symbol numbers, to which data is mapped, may be different in a first slot of the plurality of slots from a second slot of the plurality of slots.

In example embodiments, transmission of a TBoMS may be based on a dynamic grant, e.g., based on a scheduling DCI comprising an uplink grant for transmission of the TBoMS. The uplink grant may comprise transmission parameter (e.g., scheduling information) for transmission of the TBoMS. For example, the wireless device may receive a scheduling DCI comprising transmission parameters (e.g., time domain/frequency domain resource allocation, HARQ parameters, power control parameter(s), etc.) for transmission of the TBoMS. The scheduling DCI may comprise a field (e.g., a time domain resource allocation/assignment (TDRA) field) with a value indicating a number of the plurality of slots of the scheduled TB/TBoMS. The wireless device may determine the time domain resource allocation parameters including the number of the plurality of slots of the scheduled TB/TBoMS based on the value of the time domain resource allocation/assignment field of the scheduling DCI.

In example embodiments, the wireless device may determine the number of the plurality of slots of the scheduled TB/TBoMS based on a TDRA table, wherein the table may be pre-configured/pre-determined or may be configurable (e.g., via a PUSCH-TimeDomainAllocationList IE for a time domain resource allocation list indicating the TDRA table). For example, a column of the TDRA table may be associated with the number of the slots of a TB/TBoMS.

In example embodiments, a scheduling DCI of the TB/TBoMS may comprise a time domain resource assignment field. A value of the time domain resource assignment field may indicate a row of the TDRA table for determination of time domain resource allocation/assignment parameters of the TB/TBoMS (e.g., number of slots of the TB/TBoMS, number of repetitions, starting symbol parameter (e.g., starting symbol used for transmission in a slot of the multiple slots of the TB/TBoMS), length parameter (e.g., length in number of symbols used for transmission in a slot of the multiple slots of the TB/TBoMS), etc.). The wireless device may determine a number of slots of the TB/TBoMS based on a row of the TDRA table (e.g., the TDRA table indicated by the scheduling DCI) and the column of the TDRA table that is associated with number of slots in a TB/TBoMS.

In example embodiments, transmission of a TB/TBoMS may be based on a configured uplink grant. For a Type 2 configured grant configuration, the wireless device may further receive an activation DCI indicating activation of the configured grant configuration. For example, transmission of a TB/TBoMS may be based on configuration parameters of a configured grant configuration and/or the activation DCI indicating activation of the configured grant configuration. In example embodiments, the activation DCI may comprise a time domain resource assignment field. A value of the time domain resource assignment field may indicate a row of the TDRA table for determination of time domain resource allocation/assignment parameters of the TB/TBoMS (e.g., number of slots of the TB/TBoMS, number of repetitions, starting symbol parameter (e.g., starting symbol used for transmission in a slot of the multiple slots of the TB/TBoMS), length parameter (e.g., length in number of symbols used for transmission in a slot of the multiple slots of the TB/TBoMS), etc.). The wireless device may determine a number of slots of the TB/TBoMS based on a row of the TDRA table (e.g., the TDRA table indicated by the activation DCI) and the column of the TDRA table that is associated with number of slots in a TB/TBoMS.

In example embodiments, the transmission of the TB (e.g., the TBoMS) may be via multi-slot PUSCH, e.g., PUSCH using radio resources in a plurality of slots. For example, the resources in the plurality of slots may be pooled for transmission of the TBoMS.

In example embodiments, the one or more messages may comprise configuration parameters of one or more serving cells comprising one or more timing advance groups (TAGs). A MAC-CellGroupConfig information element may be used to configure MAC parameters for a master cell group (MCG) or a secondary cell group (e.g., SCG). The MAC-CellGroupConfig information element may comprise one or more TAG-config IEs used to configure parameters of one or more TAGs. A TAG-config IE may comprise a tag-Id parameter indicating an identifier associated with the TAG. The configuration parameters of a serving cell (e.g., received via/based on a ServingCellConfig IE) may comprise the tag-Id parameter indicating the TAG that the serving cell belongs to/is associated with.

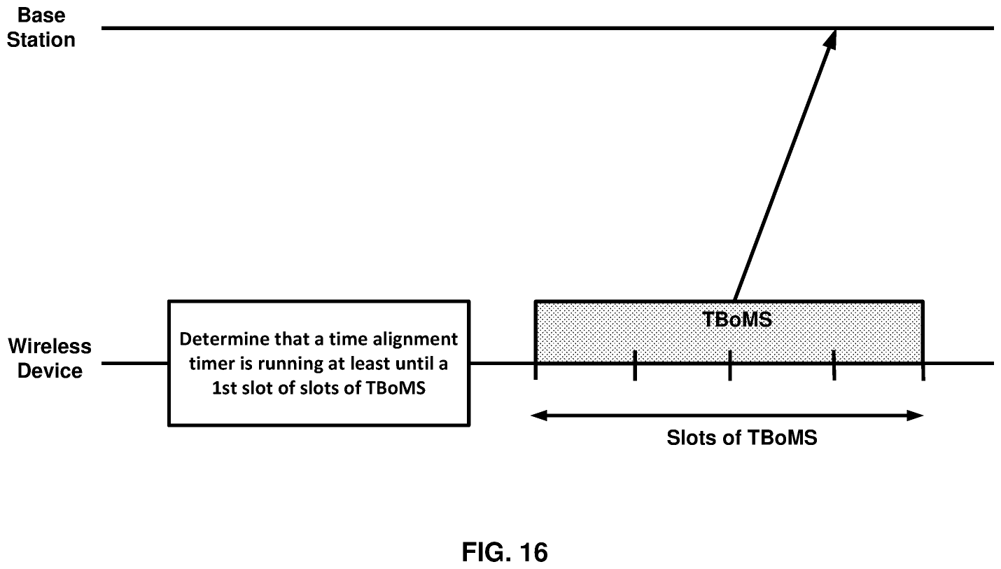

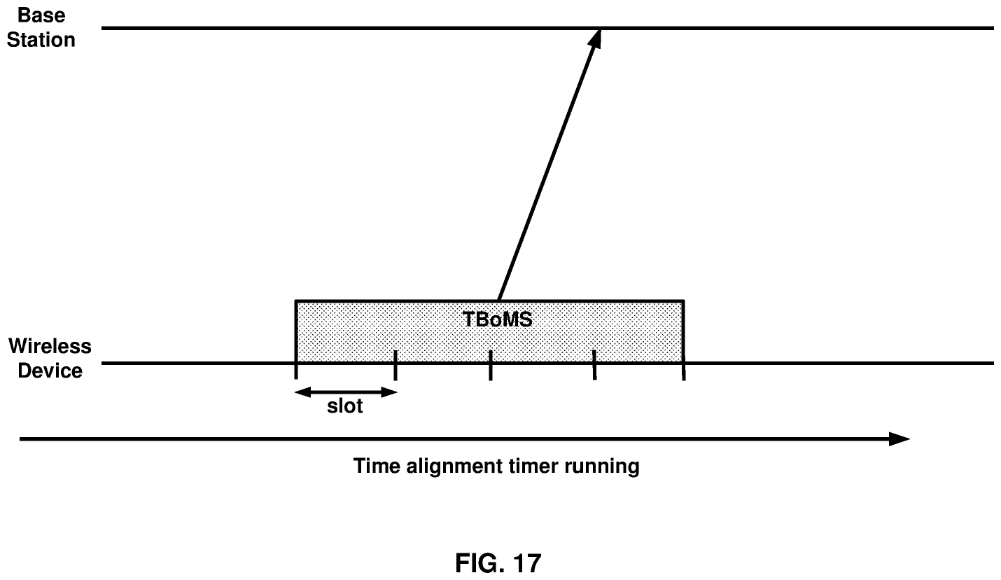

In an example embodiment as shown in FIG. 16, a wireless device may determine that a time alignment timer associated with a serving cell (e.g., associated with a TAG comprising the serving cell) is running at least until a first slot of the plurality of slots of a scheduled transport block (e.g., a scheduled TBoMS). The transport block may be scheduled for transmission in the plurality of slots via radio resources of the serving cell in the plurality of slots. In an example, the wireless device may make the determination whether the time alignment timer, associated with the serving cell, is running at least until the first slot of the plurality of slots of the scheduled transport block prior to creating/generating the transport block. The wireless device may transmit the transport block (e.g., the TBoMS) in the plurality of slots via the radio resources of the serving cell. An example transmission of the TBoMS, based on/in response to the determination that the time alignment timer is running at least until the first slot of the plurality of slots, is shown in FIG. 17. The wireless device may transmit the transport block (e.g., the TBoMS) via the radio resources of the serving cell in the plurality of slots based on (e.g., in response to) the determination that the time alignment timer associated with the serving cell (e.g., associated with a TAG comprising the serving cell) is running at least until the first slot of the plurality of slots.

In an example embodiment, the first slot of the plurality of slots of the scheduled transport block (e.g., the TBoMS) may be an earliest/beginning slot of the plurality of slots. Based on (e.g., in response to) the time alignment timer associated with the serving cell (e.g., associated with a TAG comprising the serving cell) running at least until the earliest/beginning slot of the plurality of slots, the wireless device may transmit the transport block (e.g., the TBoMS) in the plurality of slots.

In an example embodiment, the first slot of the plurality of slots of the scheduled transport block (e.g., the TBoMS) may be the last/latest slot of the plurality of slots. Based on (e.g., in response to) the time alignment timer associated with the serving cell (e.g., associated with a TAG comprising the serving cell) running at least until the last/latest slot of the plurality of slots, the wireless device may transmit the transport block (e.g., the TBoMS) in the plurality of slots.

In an example embodiment, the wireless device may determine the first slot of the plurality of slots based on one or more configuration parameters. The one or more messages (e.g., the one or more RRC messages) may comprise the one or more configuration parameters used in the determination of the first slot. In an example, the one or more configuration parameters may indicate the first slot in the plurality of slots.

In an example embodiment, the first slot in the plurality of slots may be between the earliest/beginning slot of the plurality of slots and the last/latest slot of the plurality of slots of the scheduled transport block (e.g., the scheduled TBoMS). In an example, the wireless device may receive a first configuration parameter (e.g., the one or more messages may comprise the first configuration parameter) indicating the first slot of the plurality of slots. The wireless device may determine the first slot in the plurality of slots based on the first configuration parameter.

In an example, the time alignment timer associated with the serving cell may not be running after the first slot of the plurality of slots of the scheduled transport block (e.g., the scheduled TBoMS). For example, the time alignment timer may not be running in a second slot of the plurality of slots of the scheduled transport block (e.g., the scheduled TBoMS) and the second slot may be after the first slot and may be one of the plurality of slots of the scheduled transport block (e.g., the scheduled TBoMS).

In an example, the determination of the first slot in the plurality of slots may be based on a type of PUSCH and/or a mapping type of PUSCH for the scheduled transmission of the transport block (e.g., PUSCH type and/or mapping type A or PUSCH type and/or mapping type B). In an example, the transmitting the TB may be based on the type of the PUSCH and/or a mapping type of the PUSCH for the scheduled transmission of the transport block (e.g., PUSCH type/mapping type A or PUSCH type/mapping type B).

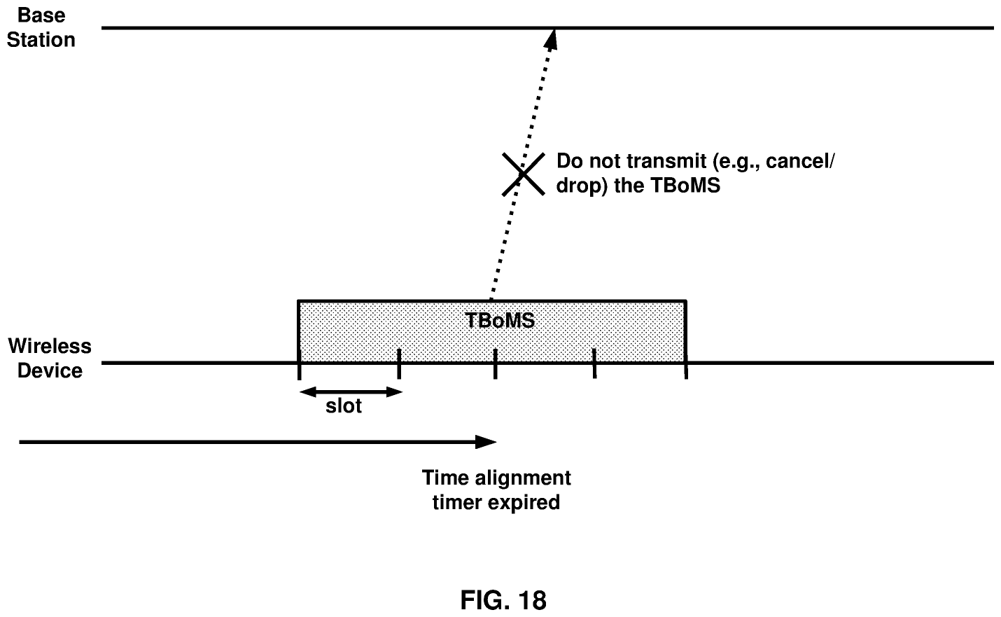

In an example embodiment, a wireless device may determine that a time alignment timer associated with a serving cell (e.g., associated with a TAG comprising the serving cell) is not running (e.g., is expired) on (e.g., on or before) a first slot of the plurality of slots of a scheduled transport block (e.g., a scheduled TBoMS). The transport block may be scheduled for transmission in the plurality of slots via radio resources of the serving cell in the plurality of slots. In an example, the wireless device may make the determination whether the time alignment timer, associated with the serving cell, is running at least until the first slot of the plurality of slots of the scheduled transport block prior to creating/generating the transport block. The wireless device may not transmit (e.g., may cancel/drop) the scheduled transport block (e.g., the scheduled TBoMS). An example cancelling/dropping of the TBoMS, based on/in response to the determination that the time alignment timer is not running (e.g., is expired) on (e.g., on or before) the first slot of the plurality of slots, is shown in FIG. 18. The wireless device may not transmit (e.g., may cancel/drop) the scheduled transport block (e.g., the scheduled TBoMS) based on (e.g., in response to) the determination that the time alignment timer associated with the serving cell (e.g., associated with a TAG comprising the serving cell) is not running (e.g., is expired) on (e.g., on or before) the first slot of the plurality of slots.

In an example embodiment, the first slot of the plurality of slots of the scheduled transport block (e.g., the TBoMS) may be an earliest/beginning slot of the plurality of slots. Based on (e.g., in response to) the time alignment timer associated with the serving cell (e.g., associated with a TAG comprising the serving cell) not running (e.g., being expired) on (e.g., on or before) the earliest/beginning slot of the plurality of slots, the wireless device may not transmit (e.g., may cancel/drop) the transport block (e.g., the TBoMS).

In an example embodiment, the first slot of the plurality of slots of the scheduled transport block (e.g., the TBoMS) may be the last/latest slot of the plurality of slots. Based on (e.g., in response to) the time alignment timer associated with the serving cell (e.g., associated with a TAG comprising the serving cell) not running (e.g., being expired) on (e.g., on or before) the last/latest slot of the plurality of slots, the wireless device may not transmit (e.g., may cancel/drop) the transport block (e.g., the TBoMS).

In an example embodiment, the wireless device may determine the first slot of the plurality of slots based on one or more configuration parameters. The one or more messages (e.g., the one or more RRC messages) may comprise the one or more configuration parameters used in the determination of the first slot. In an example, the one or more configuration parameters may indicate the first slot in the plurality of slots.

In an example embodiment, the first slot in the plurality of slots may be between the earliest/beginning slot of the plurality of slots and the last/latest slot of the plurality of slots of the scheduled transport block (e.g., the scheduled TBoMS). In an example, the wireless device may receive a first configuration parameter (e.g., the one or more messages may comprise the first configuration parameter) indicating the first slot of the plurality of slots. The wireless device may determine the first slot in the plurality of slots based on the first configuration parameter.

In an example, the time alignment timer associated with the serving cell may not be running after the first slot of the plurality of slots of the scheduled transport block (e.g., the scheduled TBoMS). For example, the time alignment timer may not be running in a second slot of the plurality of slots of the scheduled transport block (e.g., the scheduled TBoMS) and the second slot may be after the first slot and may be one of the plurality of slots of the scheduled transport block (e.g., the scheduled TBoMS).

In an example, the determination of the first slot in the plurality of slots may be based on a type of PUSCH and/or a mapping type of PUSCH for the scheduled transmission of the transport block (e.g., PUSCH type and/or mapping type A or PUSCH type and/or mapping type B). In an example, the canceling/dropping the TB may be based on the type of the PUSCH and/or a mapping type of the PUSCH for the scheduled transmission of the transport block (e.g., PUSCH type/mapping type A or PUSCH type/mapping type B).

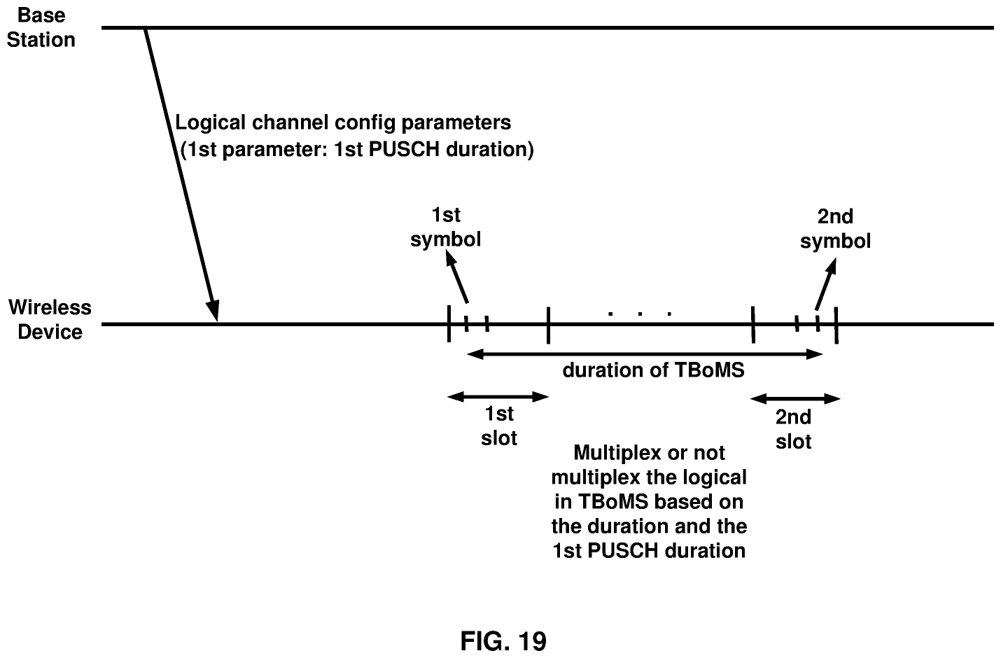

In an example embodiment as shown in FIG. 19, the one or more messages (e.g., the one or more RRC messages) comprising the configuration parameters may comprise first configuration parameters of a first logical channel. The first configuration parameters of the first logical channel may comprise a first configuration parameter indicating a first physical uplink shared channel (PUSCH) duration (e.g., a maximum PUSCH duration). The wireless device may determine a duration associated with a scheduled transmission of a transport block (TB) in a plurality of slots (e.g., a duration associated with the TBoMS). The duration of the scheduled transmission of the TB/TBoMS may be used in a logical channel selection process for a determination of whether to multiplex the first logical channel in TB/TBoMS or not multiplex the first logical channel in the TB/TBoMS. The wireless device may multiplex data of the first logical channel in the TB/TBoMS based on the duration associated with the scheduled transmission of the TB/TBoMS. For example, the wireless device may multiplex data of the first logical channel in the TB/TBoMS based on the duration associated with the scheduled transmission of the TB/TBoMS being smaller than the first PUSCH duration (e.g., maximum PUSCH duration) indicated by the first configuration parameter.

In an example, the plurality of slots in which the TB/TBoMS is scheduled for transmission may comprise a first slot (e.g., the earliest/beginning slot of the plurality of slots) and a second slot (e.g., the last/latest slot of the plurality of slots). The wireless device may determine the duration associated with the scheduled transmission of the TB/TBoMS based on a first timing of a first symbol of the first slot (e.g., ith symbol (symbol no. i) of the first slot) and a second timing of a second symbol of the second slot (e.g., jth symbol (symbol no. j) of the second slot). In an example, the wireless device may determine the duration associated with the scheduled transmission of the TB/TBoMS based on a difference between the first timing of the first symbol of the first slot and a second timing of the second symbol of the second slot. In an example, the wireless device may determine the duration associated with the scheduled transmission of the TB/TBoMS based on a difference between the first timing and the second timing excluding one or more gaps. The scheduled transmission of the TB/TBoMS may not be/occur during the one or more gaps. For example, the scheduled transmission of the TB/TBoMS may not occur from (j+1)th symbol (symbol no. j+1) of a slot, in the plurality of slots of the scheduled TB/TBoMS, until (i−1)th symbol (symbol no. i−1) of a subsequent slot in the plurality of slots of the scheduled TB/TBoMS. For example, transmission of the scheduled TB/TBoMS in each slot of the plurality of slots of the scheduled TB/TBoMS may be from ith symbol (e.g., symbol no. i) until jth symbol (e.g., symbol number j) of the slot. A gap, in the one or more gaps, may be from (j+1)th symbol of a slot, in the plurality of slots of the scheduled TB/TBoMS, until (i−1)th symbol of a subsequent slot in the plurality of slots of the scheduled TB/TBoMS.

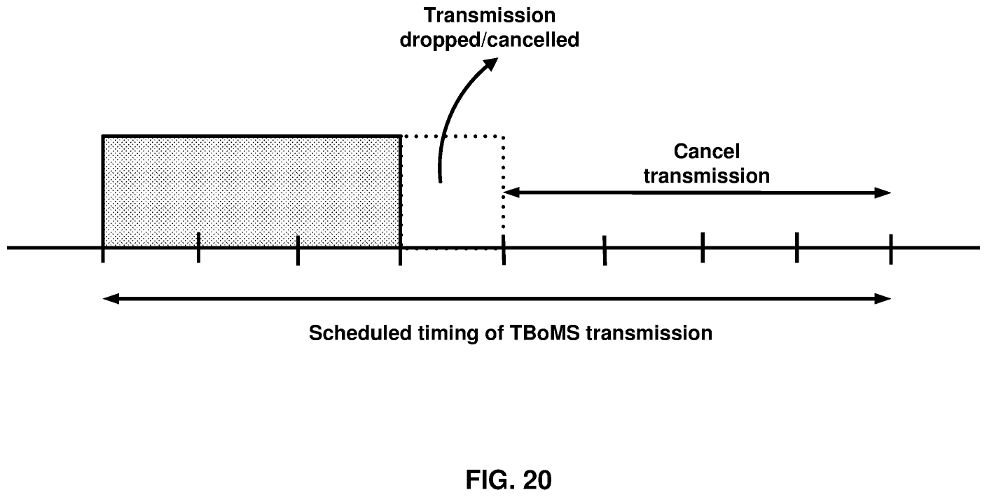

In an example embodiment as shown in FIG. 20, a wireless device may generate/create a transport block (TB) (e.g., a TB over multiple slots (TBoMS)) for scheduled transmission in a plurality of slots. The wireless device may be scheduled for transmission of the TB/TBoMS via radio resources of a serving cell in the plurality of slots. The wireless device may cancel and/or drop transmission of a first portion of the TB/TBoMS in at least a first slot of the plurality of slots in which the wireless device is scheduled for transmission. For example, the wireless device may cancel and/or drop transmission of the first portion of the TB/TBoMS in one or more symbols of the first slot. For example, the cancelling and/or dropping of the first portion of the TB/TBoMS in the first slot (e.g., the one or more symbols of the first slot) may be based on an overlap with a high priority channel/signal (e.g., a high priority PUSCH or a high priority uplink control channel (e.g., a high priority PUCCH)). For example, the cancelling and/or dropping of the first portion of the TB/TBoMS in the first slot (e.g., the one or more symbols of the first slot) may be based on receiving a cancellation indication (e.g., based on receiving a cancellation indication DCI, associated with a cancelation indication RNTI (CI-RNTI), comprising the cancellation indication). The wireless device may cancel transmission of the TB in one or more second slots (e.g., one or more second slots that are after the first slot) of the plurality of slots in which the TB/TBoMS is scheduled for transmission. The wireless device may cancel the transmission of the TB/TBoMS in the one or more second slots of the plurality of slots based on (e.g., in response to) the transmission of the TB/TBoMS being cancelled/dropped in the first slot of the plurality of slots.

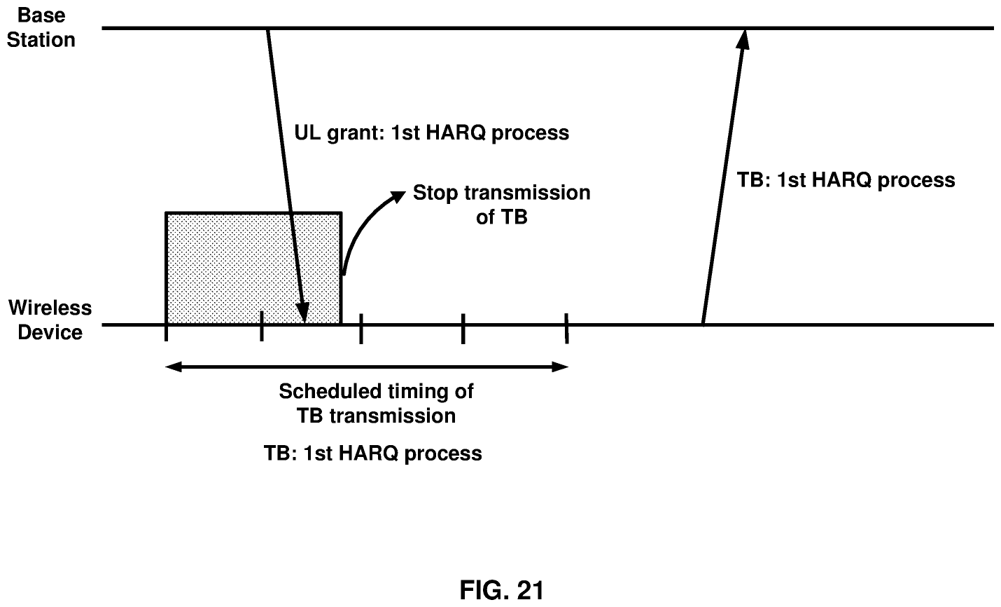

In an example embodiment as shown in FIG. 21, a wireless device may generate/create a first transport block (TB) (e.g., a first TB over multiple slots (TBoMS)) for scheduled transmission in a plurality of slots. The wireless device may be scheduled for transmission of the first TB/TBoMS via radio resources of a serving cell in the plurality of slots. Before transmission of the first TB/TBoMS in the plurality of slots ends (e.g., while transmission of the first TB/TBoMS in the first slot is ongoing, e.g., before the latest/last slot in the plurality of slots), the wireless device may receive a DCI comprising an uplink grant associated with the first HARQ process (e.g., same HARQ process as that of the first TB/TBoMS with ongoing transmission). The DCI may comprise a HARQ process number field with a value indicating the first HARQ process (e.g., same HARQ process as that of the first TB/TBoMS with ongoing transmission). The wireless device may stop the transmission of the first TB/TBoMS. The wireless device may stop the transmission of the first TB/TBoMS based on (e.g., in response to) the receiving DCI/uplink grant associated with the first HARQ process (e.g., same HARQ process as that of the first TB/TBoMS with ongoing transmission). In an example, stopping the transmission of the first TB/TBoMS associated with the first HARQ process may comprise flushing a HARQ buffer associated with the first HARQ process. The wireless device may flush the HARQ buffer associated with the first HARQ process based on (e.g., in response to) the receiving DCI/uplink grant associated with the first HARQ process. In an example, the uplink grant may indicate a new transmission (e.g., an NDI indicated by the DCI may be toggled). The wireless device may transmit a second TB associated with the first HARQ process based on the uplink grant. In an example, the uplink grant may indicate a retransmission of the first TB (e.g., an NDI indicated by the DCI may not be toggled). The wireless device may transmit a retransmission of the first TB based on the uplink grant. In an example, the second TB or the retransmission of the first TB may over multiple slots (e.g., may be a TBoMS) or may be over a single slot. In an example, the stopping the transmission of the first TB may be based on the transmission of the second TB or the retransmission of the first TB being in a single slot and/or being based on single-slot PUSCH.

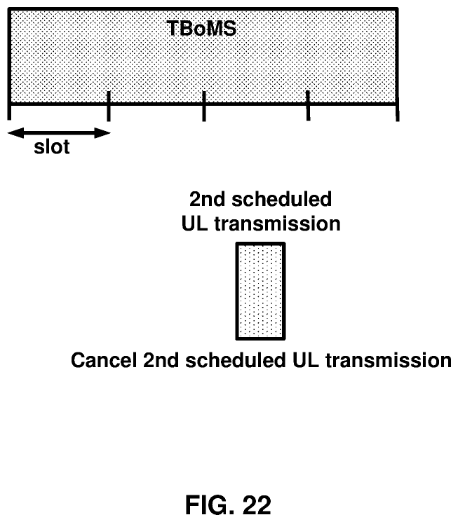

In an example embodiment as shown in FIG. 22, a wireless device may generate/create a first transport block (TB) (e.g., a first TB over multiple slots (TBoMS)) for scheduled transmission in a plurality of slots. The wireless device may be scheduled for transmission of the first TB/TBoMS via radio resources of a serving cell in the plurality of slots. The wireless device may determine that there is an overlap between the scheduled transmission of the first TB/TBoMS in one or more symbols of a first slot of the plurality of slots in which the TB/TBoMS is scheduled for transmission and a second scheduled uplink transmission in the first slot. The wireless device may drop/cancel the second scheduled uplink transmission. The wireless device may drop/cancel the second scheduled uplink transmission based on (e.g., in response to) the determining that there is the overlap between the scheduled transmission of the first TB/TBoMS in the one or more symbols of a first slot and the second scheduled uplink transmission in the first slot. In an example, the dropping/canceling of the second uplink transmission may be based on the overlap being with a TB that is scheduled for transmission in a plurality of slots (e.g., the overlap being with a TB that is TBoMS).

In an example, the wireless device may receive a DCI comprising scheduling information for the second uplink transmission. For example, the second uplink transmission may be via PUSCH. In an example, the second uplink transmission may be based on a configured grant. For example, the wireless device may receive second configuration parameters of a second configured grant configuration and the scheduled transmission of the second uplink transmission may be based on the second configuration parameters of the second configured grant configuration. For example, the wireless device may receive an activation DCI indicating activation of the second configured grant configuration.

In an example, the second uplink transmission may be for transmission of a second transport block comprising one or more logical channels. The wireless device may cancel/drop the second scheduled uplink transmission based on the one or more logical channels (e.g., priorities associated with the one or more logical channels) with data multiplexed in the second transport block.

In an example, the second uplink transmission may be for transmission of a second transport block comprising one or more logical channels. The canceling/dropping the second scheduled uplink transmission may be independent of the one or more logical channels multiplexed in the second transport block. The canceling/dropping the second scheduled uplink transmission may be based on the overlap being with a TB that is scheduled for transmission in a plurality of slots (e.g., the overlap being with a TB that is TBoMS).

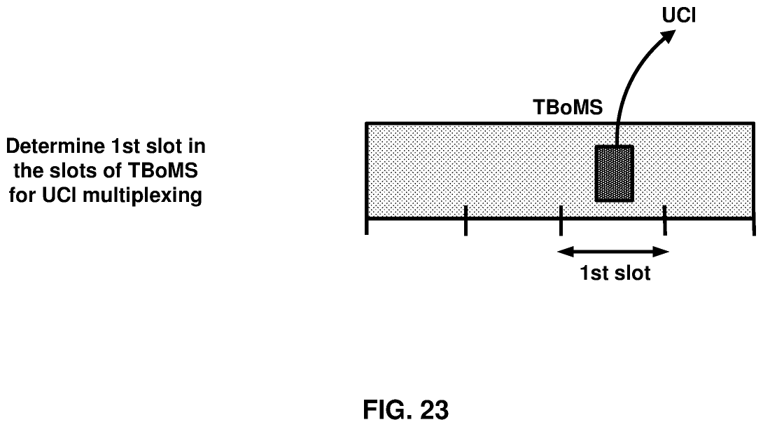

In an example embodiment as shown in FIG. 23, a wireless device may generate/create a transport block (TB) (e.g., a TB over multiple slots (TBoMS)) for scheduled transmission in a plurality of slots. The wireless device may be scheduled for transmission of the TB/TBoMS via radio resources of a serving cell in the plurality of slots. The wireless device may determine to multiplex first uplink control information (UCI) with the TB for transmission via the radio resources of the serving cell. The wireless device may determine at least one first slot of the plurality of slots, in which the TB/TBoMS is scheduled for transmission, for transmission/multiplexing the first UCI. In an example, the first UCI may comprise HARQ information (e.g., HARQ process ID, new data indicator (NDI), redundancy version (RV), etc.) associated with the TB/TBoMS. For example, the transmission of a TB/TBoMS may be based on a configured grant configuration configured for an unlicensed cell (e.g., shared spectrum) and the first UCI multiplexed in the first slot may be autonomously selected by the wireless device. The wireless device may transmit/multiplex the first UCI with the TB in the first slot (e.g., via first radio resources in the first slot). In an example, the at least one first slot, determined by the wireless device for multiplexing the first UCI, may comprise an earliest/beginning slot of the plurality of slots in which the TB/TBoMS is scheduled for transmission. In an example, the determining the at least one first slot, for multiplexing the first UCI, may be based on one or configuration parameters. The one or more messages (e.g., the one or more RRC messages) received by the wireless device may comprise the one or more configuration parameters to be used by the wireless device for determination of at least one first slot of the plurality of slots for multiplexing the first UCI. In an example, the determination of the at least one first slot, in the plurality of slots in which the TB/TBoMS is scheduled for transmission, for multiplexing the first UCI may be based on the type of the first UCI.

In an example, the determination of the at least one first slot, in the plurality of slots in which the TB/TBoMS is scheduled for transmission, for multiplexing the first UCI may be based on one or more characteristics of the at least one first slot (e.g., number of symbols available for uplink transmission/slot format of the at least one first slot, etc.).

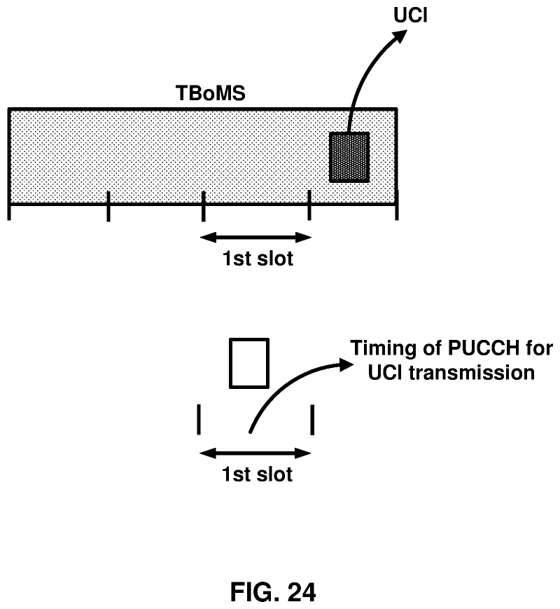

In an example embodiment as shown in FIG. 24, a wireless device may generate/create a transport block (TB) (e.g., a TB over multiple slots (TBoMS)) for scheduled transmission in a plurality of slots. The wireless device may be scheduled for transmission of the TB/TBoMS via radio resources of a serving cell in the plurality of slots. The wireless device may determine that a first scheduled timing of first uplink control information for transmission via an uplink control channel (e.g., PUCCH) is in a first slot of the plurality of cells in which the TB/TBoMS is scheduled for transmission. The wireless device may determine a second slot of the plurality of slots, in which the TB/TBoMS is scheduled for transmission, for multiplexing the first uplink control information. The determination of the second slot, by the wireless device, may be based on a rule and/or characteristics of the first slot and the second slot (e.g., number of available symbols, e.g., for uplink transmission of the first UCI), etc. The wireless device may multiplex the first uplink control information with the TB/TBoMS in the second slot of the plurality of slots. In an example, the second slot may be the first slot. In an example, the second slot may be different from the first slot. The wireless device may multiplex the first uplink control information in one of the plurality of slots in which the TB/TBoMS is scheduled for transmission.

In an example embodiment, a wireless device may determine that a time alignment timer associated with a serving cell is running at least until a first slot of a plurality of slots. A transport block (TB) may be scheduled for transmission in the plurality of slots via radio resources of the serving cell. The wireless device may transmit the TB in the plurality of slots via the radio resources of the serving cell.

In an example, the TB may be a TB over multiple slots (TBoMS).

In an example, the transmitting the TB may be based on multi-slot physical uplink shared channel (PUSCH). In an example, the multi-slot PUSCH may utilize resources in the plurality of slots.

In an example, the wireless device may receive a downlink control information (DCI) comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table.

In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a configured grant configuration, wherein the transmitting the TB may be based on the configuration parameters. In an example, the wireless device may receive a configuration parameter indicating activation of the configured grant configuration. In an example, the wireless device may receive configuration parameters of a time domain resource allocation list (e.g., PUSCH-TimeDomainAllocationList IE) indicating a time domain resource allocation (TDRA) table wherein a column of the TDRA table may indicate a plurality of numbers of the plurality of slots. In an example, the activation DCI may comprise a time domain resource assignment field with a value indicating a row of the TDRA table.

In an example, the first slot may be the latest/last slot in the plurality of slots in which the TB is scheduled for transmission.

In an example, the first slot may be the earliest/beginning slot in the plurality of slots in which the TB is scheduled for transmission.

In an example, the first slot may be between the earliest/beginning slot and the latest/last slot of the plurality of slots in which the TB is scheduled for transmission.

In an example, the wireless device may receive a first configuration parameter. The wireless device may determine the first slot, in the plurality of slots in which the TB is scheduled for transmission, based on the first configuration parameter.

In an example, the transmitting the TB may be based on (e.g., in response to) the time alignment timer running at least until the first slot of the plurality of slots. In an example, the transmitting the TB may be based on (e.g., in response to) the determining that the time alignment timer running at least until the first slot of the plurality of slots. In an example, the transmitting the TB may further be based on a type of PUSCH and/or a PUSCH mapping type used for scheduled transmission of the TB. In an example, the type of PUSCH and/or the PUSCH mapping type is type A. In an example, the type of PUSCH and/or the PUSCH mapping type is type B.

In an example, the time alignment timer may be associated with a first timing advance group (TAG) comprising the serving cell. In an example, the wireless device may receive configuration parameters of the serving cell, wherein the configuration parameters comprise a first parameter indicating an identifier of the first TAG associated with the serving cell.

In an example, the time alignment timer may not be running in a second slot after the first slot. The second slot may be one of the plurality of slots of the TB.

In an example, the plurality of slots, of the TB, may comprise consecutive slots.

In an example, the plurality of slots, of the TB, may comprise non-consecutive slots.

In an example embodiment, a wireless device may determine that a time alignment timer associated with a serving cell is not running (e.g., is expired) on (e.g., on or before) a first slot of a plurality of slots. A transport block (TB) may be scheduled for transmission in the plurality of slots via radio resources of the serving cell. The wireless device may cancel/drop the TB.

In an example, the TB may be a TB over multiple slots (TBoMS).

In an example, the TB may be scheduled for transmission based on multi-slot physical uplink shared channel (PUSCH). In an example, the multi-slot PUSCH may utilize resources in the plurality of slots.

In an example, the wireless device may receive a downlink control information (DCI) comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table.

In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a configured grant configuration, wherein the scheduled transmission of the TB may be based on the configuration parameters. In an example, the wireless device may receive a configuration parameter indicating activation of the configured grant configuration. In an example, the wireless device may receive configuration parameters of a time domain resource allocation list (e.g., PUSCH-TimeDomainAllocationList IE) indicating a time domain resource allocation (TDRA) table wherein a column of the TDRA table may indicate a plurality of numbers of the plurality of slots. In an example, the activation DCI may comprise a time domain resource assignment field with a value indicating a row of the TDRA table.

In an example, the first slot may be the latest/last slot in the plurality of slots in which the TB is scheduled for transmission.

In an example, the first slot may be the earliest/beginning slot in the plurality of slots in which the TB is scheduled for transmission.

In an example, the first slot may be between the earliest/beginning slot and the latest/last slot of the plurality of slots in which the TB is scheduled for transmission.

In an example, the wireless device may receive a first configuration parameter. The wireless device may determine the first slot, in the plurality of slots in which the TB is scheduled for transmission, based on the first configuration parameter.

In an example, the cancelling/dropping the TB may be based on (e.g., in response to) the time alignment timer not running (e.g., being expired) on (e.g., on or before) the first slot of the plurality of slots. In an example, the transmitting the TB may be based on (e.g., in response to) the determining that the time alignment timer running at least until the first slot of the plurality of slots. In an example, the transmitting the TB may further be based on a type of PUSCH and/or a PUSCH mapping type used for scheduled transmission of the TB. In an example, the type of PUSCH and/or the PUSCH mapping type is type A. In an example, the type of PUSCH and/or the PUSCH mapping type is type B.

In an example, the time alignment timer may be associated with a first timing advance group (TAG) comprising the serving cell. In an example, the wireless device may receive configuration parameters of the serving cell, wherein the configuration parameters comprise a first parameter indicating an identifier of the first TAG associated with the serving cell.

In an example, the plurality of slots, of the TB, may comprise consecutive slots.

In an example, the plurality of slots, of the TB, may comprise non-consecutive slots.

In an example embodiment, a wireless device may receive configuration parameters of a first logical channel comprising a first configuration parameter indicating a first physical uplink shared channel (PUSCH) duration. The wireless device may determine a duration associated with scheduled transmission of a transport block (TB) in a plurality of slots based on a difference between a first timing of a first symbol (e.g., ith symbol) of a first slot of the plurality of slots and a second timing of a second symbol (e.g., jth symbol) of a second slot of the plurality of slots. The wireless device may multiplex the first logical channel in the TB based on the duration and the first PUSCH duration.

In an example, the duration may be based on the difference between the first timing and the second timing excluding one or more gaps. In an example, the scheduled transmission of the TB may not be during the one or more gaps. In an example, a gap, of the one or more gaps, may be between the jth symbol of a slot of the plurality of slots to the ith symbol of a subsequent slot.

In an example, the first slot may be the earliest/beginning slot of the plurality of slots in which the TB is scheduled for transmission.

In an example, the second slot may be the latest/last/ending slot of the plurality of slots in which the TB is scheduled for transmission.

In an example, the scheduled transmission of the TB, in each slot of the plurality of slots, may be from the ith symbol to the jth symbol of the corresponding slot.

In an example, the TB may be a TB over multiple slots (TBoMS).

In an example, the multiplexing the first logical channel in the TB may be based on the duration being smaller than or equal to the first PUSCH duration. In an example, the first PUSCH duration may be a maximum PUSCH duration.

In an example, the transmission of the TB may be based on multi-slot PUSCH. In an example, the multi-slot PUSCH may utilize resources from the plurality of slots.

In an example, the wireless device may transmit the TB in the plurality of slots. In an example, the wireless device may receive a downlink control information (DCI) comprising transmission parameters (e.g., scheduling information) of the TB. The transmitting the TB may be based on the transmission parameters (e.g., the scheduling information). The determining the duration may be based on the DCI. The DCI may comprise a field (e.g., a time domain resource assignment field) with a value indicating a number of the plurality of slots of the TB. The value of the field may indicate the first slot, the first symbol, the second slot and the second symbol. In an example, a column of a time domain resource allocation/assignment (TDRA) table may be associated with number slots for transmission of a TB/TBoMS. In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, the DCI may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may transmit the TB in the plurality of slots. In an example, the wireless device may receive configuration parameters of a configured grant configuration. The transmitting the TB may be based on the configuration parameters. In an example, the wireless device may receive an activation DCI indicating activation of the configured grant configuration. In an example, the wireless device may determine the first slot, the first symbol, the second slot and the second symbol based on the value of the field of the activation DCI. In an example, the wireless device may receive configuration parameters of a time domain resource allocation list (e.g., PUSCH-TimeDomainAllocationList IE) indicating a time domain resource allocation (TDRA) table. A column of the TDRA table may indicate a plurality of numbers of the plurality of slots. In an example, the activation DCI may comprise a time domain resource assignment field with a value indicating a row of the TDRA table.

In an example, transmitting the TB may further be based on a type of PUSCH and/or PUSCH mapping type used for scheduled transmission of the TB. In an example, the wireless device may transmit the TB in the plurality of slots. In an example, the type of PUSCH and/or the PUSCH mapping type may be type A. In an example, the type of PUSCH and/or the PUSCH mapping type may be type B.

In an example embodiment, a wireless device may generate a transport block (TB) for scheduled transmission in a plurality of slots. The wireless device may drop/cancel transmission of a first portion of the TB in a first slot of the plurality of slots. The wireless device may cancel transmission of the TB over one or more second slots of the plurality of slots.

In an example, the TB may be a TB over multiple slots (TBoMS).

In an example, the first portion of the TB may be scheduled for transmission in one or more symbols of the first slot.

In an example, the canceling the transmission of the TB over the one or more second slots may be based on (e.g., in response to) the dropping/canceling the transmission of the first portion of the TB in the first slot.

In an example, the one or more second slots may be after (e.g., subsequent to) the first slot.

In an example, the dropping/cancelling the transmission of the first portion of the TB in the first slot may be based on an overlap (e.g., overlap in one or more symbols) with a high priority uplink transmission. In an example, the high priority uplink transmission may be a high priority PUSCH. In an example, the high priority uplink transmission may be a high priority uplink control channel.

In an example, the dropping/cancelling the transmission of the first portion of the TB in the first slot may be in response to receiving a cancellation indication. In an example, the receiving the cancellation indication may be based on receiving a cancellation indication DCI comprising the cancellation indication. In an example, the cancellation indication DCI is associated with a cancellation indication radio network temporary identifier (CI-RNTI).

In an example, the wireless device may receive configuration parameters of a configured grant configuration. The transmission of the TB may be based on the configuration parameters. In an example, the wireless device may receive an activation DCI indicating activation of the configured grant configuration.

In an example, the scheduled transmission of the TB may be based on multi-slot PUSCH. In an example, the multi-slot PUSCH may utilize resources from a plurality of slots.

In an example, the wireless device may receive a DCI comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, a wireless device may receive configuration parameters of a configured grant configuration. The transmitting the TB may be based on the configuration parameters. In an example, the wireless device may receive an activation DCI indicating activation of the configured grant configuration. In an example, the wireless device may receive configuration parameters of a time domain resource allocation list (e.g., PUSCH-TimeDomainAllocationList IE) indicating a time domain resource allocation (TDRA) table. A column of the TDRA table may indicate a plurality of numbers of the plurality of slots. In an example, the activation DCI may comprise a time domain resource assignment field with a value indicating a row of the TDRA table.

In an example embodiment, a wireless device may generate a first transport block (TB) associated with a first hybrid automatic repeat request (HARQ) process for transmission in a plurality of slots. The wireless device may, before transmission of the first TB in the plurality of slots ends (e.g., while transmission of the first TB is ongoing, e.g., before a latest/last slot in the plurality of slots) a DCI comprising an uplink grant associated with the first HARQ process. The wireless device may stop the transmission of the first TB. The wireless device may transmit a second TB based on the uplink grant.

In an example embodiment, a wireless device may generate a first transport block (TB) associated with a first hybrid automatic repeat request (HARQ) process for transmission in a plurality of slots. The wireless device may, before transmission of the first TB in the plurality of slots ends (e.g., while transmission of the first TB is ongoing, e.g., before a latest/last slot in the plurality of slots) a DCI comprising an uplink grant associated with the first HARQ process. The wireless device may stop the transmission of the first TB. The wireless device may transmit a retransmission of the first TB based on the uplink grant.

In an example, the TB may be a TB over multiple slots (TBoMS).

In an example, the stopping the transmission of the first TB may be based on (e.g., in response to) receiving the uplink grant associated with the first HARQ process (e.g., the HARQ process of/associated with the first TB).

In an example, the wireless device may flush a HARQ buffer associated with the first HARQ process in response to receiving the uplink grant associated with the first HARQ process (e.g., the HARQ process of/associated with the first TB).

In an example, a new data indicator (NDI) field of the DCI may indicate an initial transmission of the second TB. In an example, the NDI field of the DCI may be toggled.

In an example, a new data indicator (NDI) field of the DCI may indicate a retransmission of the first TB. In an example, the NDI field of the DCI may not be toggled.

In an example, the DCI may indicate transmission of the second TB in a single slot. The stopping the transmission of the first TB may be based on the transmission of the second TB being in a single slot.

In an example, the DCI may indicate retransmission of the first TB in a single slot. The stopping the transmission of the first TB may be based on the retransmission of the first TB being in a single slot.

In an example, the DCI may comprise a HARQ process number field indicating an identifier of the first HARQ process.

In an example, the wireless device may receive configuration parameters of a configured grant configuration. The scheduled transmission of the TB may be based on the configuration parameters. In an example, the wireless device may receive an activation DCI indicating activation of the configured grant configuration.

In an example, the scheduled transmission of the TB may be based on multi-slot PUSCH. In an example, the multi-slot PUSCH may utilize resources from a plurality of slots.

In an example, the wireless device may receive a scheduling DCI comprising transmission parameters (e.g., scheduling information) of the TB. In an example, the scheduling DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the scheduling DCI) and the column of the TDRA table associated with the number of the slots.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the scheduling DCI) and the column of the TDRA table associated with the number of the slots.

In an example, the wireless device may receive configuration parameters of a configured grant configuration. The transmitting the TB may be based on the configuration parameters. In an example, the wireless device may receive an activation DCI indicating activation of the configured grant configuration. In an example, the wireless device may receive configuration parameters of a time domain resource allocation list (e.g., PUSCH-TimeDomainAllocationList IE) indicating a time domain resource allocation (TDRA) table. A column of the TDRA table may indicate a plurality of numbers of the plurality of slots. In an example, the activation DCI may comprise a time domain resource assignment field with a value indicating a row of the TDRA table.

In an example embodiment, a wireless device may generate a transport block (TB) for transmission in a plurality of slots. The wireless device may determine an overlap, in one or more symbols, between a scheduled transmission of the TB in a first slot of the plurality of slots and a second scheduled uplink transmission in the first slot. The wireless device may drop/cancel the second scheduled uplink transmission.

In an example, the TB may be a TB over multiple slots (TBoMS).

In an example, the transmission of the TB may be via multi-slot physical uplink shared channel (PUSCH). In an example, the multi-slot PUSCH may utilize resources in the plurality of slots.

In an example, the dropping/cancelling the second uplink transmission may be based on the overlap being with a TBoMS.

In an example, the wireless device may receive a first DCI comprising transmission parameters (e.g., scheduling information) of the TBoMS.

In an example, the wireless device may receive first configuration parameters of a first configured grant configuration. The transmission of the TBoMS may be based on the first configuration parameters.

In an example, the wireless device may receive a second DCI comprising transmission parameters of the second uplink transmission.

In an example, the wireless device may receive second configuration parameters of a second configured grant configuration. The transmission of the second uplink transmission may be based on the second configuration parameters.

In an example, the wireless device may receive second configuration parameters of a second configured grant configuration. The transmission of the second uplink transmission may be based on the second configuration parameters.

In an example, the second scheduled uplink transmission may be for transmission of a second transport block comprising one or more logical channels. The dropping/cancelling the second scheduled uplink transmission may be based on the one or more logical channels. In an example, the dropping/cancelling the second scheduled uplink transmission may be based on priorities associated with the one or more logical channels.

In an example, the wireless device may receive configuration parameters of a configured grant configuration. The transmission of the TB may be based on the configuration parameters. In an example, an activation DCI may indicate activation of the configured grant configuration.

In an example, the scheduled transmission of the TB may be based on multi-slot PUSCH. In an example, the multi-slot PUSCH may utilize resources from a plurality of slots.

In an example, the wireless device may receive a DCI comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a configured grant configuration. The transmitting the TB may be based on the configuration parameters. In an example, the wireless device may receive an activation DCI indicating activation of the configured grant configuration. In an example, the wireless device may receive configuration parameters of a time domain resource allocation list (e.g., PUSCH-TimeDomainAllocationList IE) indicating a time domain resource allocation (TDRA) table. A column of the TDRA table may indicate a plurality of numbers of the plurality of slots. The activation DCI may comprise a time domain resource assignment field with a value indicating a row of the TDRA table.

In an example embodiment, a wireless device may generate a transport block (TB) for transmission in a plurality of slots via radio resources of a serving cell. The wireless device may determine at least one first slot of the plurality of slots for multiplexing first uplink control information (UCI). The wireless device may transmit/multiplex the first UCI with the TB in the first slot.

In an example, the TB may be a TB over multiple slots (TBoMS).

In an example, the at least one first slot may be the earliest/beginning slot of the plurality of slots.

In an example, the wireless device may receive a configuration parameter. The determining the at least one first slot may be based on the configuration parameter.

In an example, the wireless device may receive configuration parameters of a configured grant configuration. The transmission of the TBoMS may be based on the configuration parameters. In an example, the first UCI may comprise HARQ information associated with the TBoMS. In an example, the HARQ information may comprise one or more of a HARQ process ID, RV and NDI.

In an example, the determining the first slot may be based on a type of the first UCI.

In an example, the determining the first slot may be based on characteristics of the first slot.

In an example, the wireless device may receive configuration parameters of a configured grant configuration. The transmission of the TB may be based on the configuration parameters. In an example, the wireless device may receive an activation DCI indicating activation of the configured grant configuration.

In an example, the scheduled transmission of the TB may be based on multi-slot PUSCH. In an example, the multi-slot PUSCH may utilize resources from a plurality of slots.

In an example, the wireless device may receive a DCI comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a configured grant configuration, wherein the transmitting the TB may be based on the configuration parameters. In an example, the wireless device may receive an activation DCI indicating activation of the configured grant configuration. In an example, the wireless device may receive configuration parameters of a time domain resource allocation list (e.g., PUSCH-TimeDomainAllocationList IE) indicating a time domain resource allocation (TDRA) table wherein a column of the TDRA table indicates a plurality of numbers of the plurality of slots. In an example, the activation DCI may comprise a time domain resource assignment field with a value indicating a row of the TDRA table.

In an example embodiment, a wireless device may generate a transport block (TB) for transmission in a plurality of slots. The wireless device may determine that a first scheduled timing of first uplink control information for transmission via an uplink control channel is in a first slot of the plurality of cells. The wireless device may multiplex the first uplink control information with the TB in one of the plurality of slots.

In an example, the TB is a TB over multiple slots (TBoMS).

In an example, the wireless device may determine a second slot of the plurality of slots for multiplexing the first uplink control information.

In an example, the wireless device may transmit the TB in the plurality of slots. In an example, the transmitting the TB may be based on multi-slot physical uplink shared channel (PUSCH). In an example, the multi-slot PUSCH may utilize resources in the plurality of slots.

In an example, the wireless device may receive a downlink control information (DCI) comprising transmission parameters (e.g., scheduling information) of the TB. In an example, the DCI may comprise a field (e.g., a time domain resource assignment field) with a value indicating a number of the plurality of slots of the TB.

In an example, a column of a time domain resource allocation/assignment (TDRA) table (e.g., a pre-configured TDRA table) may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a time domain resource allocation list (e.g., PUSCH-TimeDomainAllocationList IE) indicating a TDRA table. A column of the TDRA table may be associated with number slots for transmission of a TB/TBoMS. In an example, a scheduling DCI of the TB may comprise a time domain resource assignment field with a value indicating a row of the TDRA table. In an example, the wireless device may determine a number of the plurality of the slots of the TB/TBoMS based on the row of the TDRA table (e.g., the TDRA table indicated by the DCI) and the column of the TDRA table associated with the number of the slots.

In an example, the wireless device may receive configuration parameters of a configured grant configuration. The transmitting the TB may be based on the configuration parameters. In an example, the wireless device may receive an activation DCI indicating activation of the configured grant configuration. In an example, the wireless device may receive configuration parameters of a time domain resource allocation list (e.g., PUSCH-TimeDomainAllocationList IE) indicating a time domain resource allocation (TDRA) table. A column of the TDRA table may indicate a plurality of numbers of the plurality of slots. In an example, the activation DCI may comprise a time domain resource assignment field with a value indicating a row of the TDRA table.

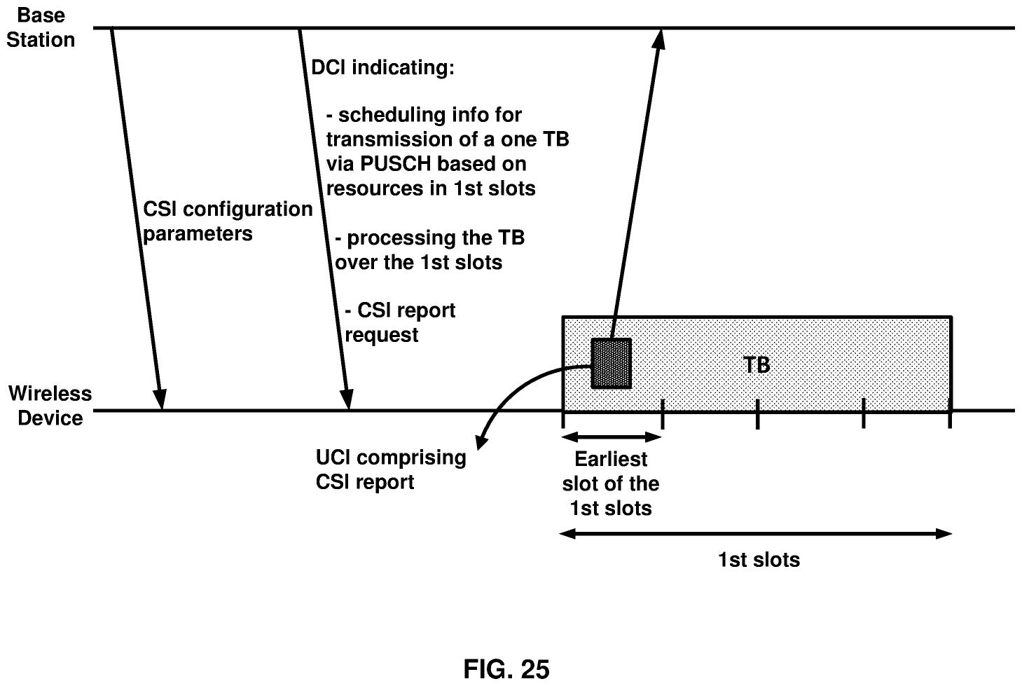

In an example embodiment as shown in FIG. 25, a wireless device may receive one or more messages comprising configuration parameters. The one or more messages may comprise one or more RRC messages. The configuration parameters may comprise RRC configuration parameters. The configuration parameters (e.g., RRC configuration parameters) may comprise channel state information (CSI) configuration parameters. For example, the CSI configuration parameters may comprise CSI reference signal (CSI-RS) configuration parameters. The CSI-RS configuration parameters may indicate radio resources of CSI-RS reference signals. The wireless device may use the CSI-RS configuration parameters and may measure the CSI-RS reference signals for generating CSI reports.

The wireless device may receive downlink control information. The downlink control information may be associated with a DCI format, e.g., an uplink scheduling DCI format such as DCI format 0_1 or DCI format 0_2. The downlink control information may indicate a dynamic grant or may be an activation DCI indicating activation of a configured grant configuration. In the latter case, the wireless device may receive configuration parameters of a configured grant configuration and the activation DCI may indicate activation of a plurality of configured grants, associated with the configured grant configuration, comprising a first configured grant used for transmission of a TB over multiple slots. In the former case, the downlink control information may comprise an uplink grant/scheduling information indicating resource allocation for transmission of a transport block over multiple slots (e.g., a first plurality of slots). The scheduling information may be for transmission (a single transmission) of one transport block (a single transport block) based on radio resources in the multiple slots (the first plurality of slots) and via a physical uplink shared channel (PUSCH). The downlink control information may indicate processing the TB over the multiple slots (e.g., the first plurality of slots). The TB transmitted over multiple slots may be referred to as a TB over multiple slots (TBoMS). The transmission of the TB may be limited to one MIMO layer. Based on the TB being processed over the multiple slots, the transmission of the TB may be limited to one/a single MIMO layer. In an example, the downlink control information (e.g., the DCI format 0_1 or the DCI format 0_1) may comprise a resource allocation field (e.g., a TDRA fields) with a value indicating a row of a resource allocation table. The wireless device may receive configuration parameters (e.g., RRC configuration parameters) indicating the resource allocation table. The resource allocation table may indicate the symbols, in each slot of first plurality of slots, that are used for transmission of the TB. In an example, the symbol numbers in each slot of the multiple slots that are used for transmission of the TB may be the same. The row, indicated by the downlink control information, of the resource allocation table may indicate a number of the first plurality of slots. For example, the wireless device may receive a configuration parameter indicating the number of slots in a TBoMS. The wireless device may use the number to determine a transport block size. The TBoMS, scheduled by the downlink control information, may itself be repeated in case the downlink control information also indicates repetition of the TBoMS. For example, a repetition of the TBoMS may be transmitted over a second plurality of slots that are after the first plurality of slots. The downlink control information (e.g., a value of a field of the DCI format) may indicate a request for CSI report. The downlink control information may indicate a request for transmission of the CSI report with the TB, e.g., via first radio resources of the radio resources indicated by the downlink control information for transmission of the TB.

The CSI report may be based on the CSI configuration parameters. The wireless device may generate the CSI report based on the CSI configuration parameters. The wireless device may measure CSI-RS reference signals, indicated by the CSI configuration parameters, and may generate the CSI report based on the CSI-RS measurements. The wireless device may determine to transmit the CSI report, requested by the downlink control information, in a first slot of the multiple slots (a first slot of the first plurality of slots). The first slot may be the earliest/beginning slot of the multiple slots (the first plurality of slots). The wireless device may transmit the CSI report in the earliest/beginning slot of the multiple slots (the first plurality of slots) based on the downlink control information indicating processing the transport block over multiple/a plurality of slots (e.g., based on the TB being a TBoMS). The wireless device may transmit the CSI report via the first radio resource (e.g., first radio resources that are in the earliest/beginning slot of the first plurality of slots) of the radio resources indicated by the downlink control information. The wireless device may transmit the CSI report using the first radio resources in the earliest/beginning slot of the multiple slots (the first plurality of resources) based on a puncturing process or a based on a rate matching process.

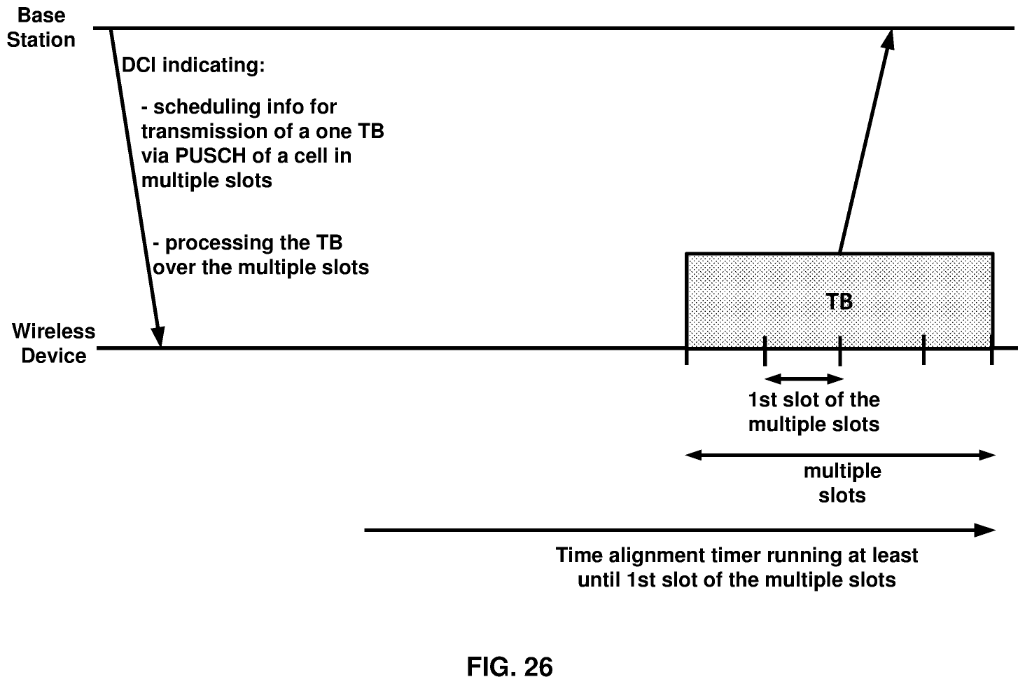

In an example embodiment as shown in FIG. 26, a wireless device may receive a downlink control information. The downlink control information may be associated with a DCI format, e.g., an uplink scheduling DCI format such as DCI format 0_1 or DCI format 0_2. The downlink control information may indicate a dynamic grant or may be an activation DCI indicating activation of a configured grant configuration. In the latter case, the wireless device may receive configuration parameters of a configured grant configuration and the activation DCI may indicate activation of a plurality of configured grants, associated with the configured grant configuration, comprising a first configured grant used for transmission of a TB via a PUSCH of a cell and using radio resources of the cell over multiple slots. In the former case, the downlink control information may comprise an uplink grant/scheduling information indicating resource allocation for transmission of a transport block over multiple slots via PUSCH of a cell and using radio resources of the cell in the multiple slots. The scheduling information may be for transmission (a single transmission) of one transport block (a single transport block) based on radio resources in the multiple slots. The downlink control information may indicate processing the TB over the multiple slots. The TB transmitted over multiple slots may be referred to as a TB over multiple slots (TBoMS). The transmission of the TB may be limited to one MIMO layer. Based on the TB being processed over the multiple slots, the transmission of the TB may be limited to one/a single MIMO layer. In an example, the downlink control information (e.g., the DCI format 0_1 or the DCI format 0_1) may comprise a resource allocation field (e.g., a TDRA field) with a value indicating a row of a resource allocation table. The wireless device may receive configuration parameters (e.g., RRC configuration parameters) indicating the resource allocation table. The resource allocation table may indicate the symbols, in each slot of the multiple slots, that are used for transmission of the TB. In an example, the symbol numbers in each slot of the multiple slots that are used for transmission of the TB may be the same. The row, indicated by the downlink control information, of the resource allocation table may indicate a number of the multiple slots. For example, the wireless device may receive a configuration parameter indicating the number of slots in a TBoMS. The wireless device may use the number to determine a transport block size. The TBoMS, scheduled by the downlink control information, may itself be repeated in case the downlink control information also indicates repetition of the TBoMS. For example, a repetition of the TBoMS may be transmitted over second multiple slots that are after (e.g., subsequent to) the multiple slots.

The cell, for which the scheduling information/downlink control information is received and on which the TBoMS is scheduled, may belong to timing advance group (TAG). The cells within the TAG may be associated with the same timing advance (TA). A TAG or a cell within the TAG may be associated with a time alignment timer. The wireless device may determine whether the time alignment timer associated with the cell/TAG is running at least until a first slot of the multiple slots that the TBoMS is scheduled for transmission. In an example, the first slot may be the earliest/beginning slot of the multiple slots. In an example, the first slot may be the latest/last slot of the multiple slots. In an example, the first slot may be a slot after the earliest/beginning slot and before the latest/last slot. In some cases, the time alignment timer may be running in the first slot of the multiple slots and may not be running in a second slot of the multiple slots (e.g., a second slot after the first slot, e.g., a second slot after the first slot and within the multiple slots). In an example, the first slot may be based on a configuration parameter. The wireless device may receive the configuration parameter indicating the first slot. The wireless device may determine the first slot based the configuration parameter.

The determining, by the wireless, may indicate that the time alignment timer, associated with the cell, is running at least until the first slot of the multiple slots. Based on/in response to the time alignment timer running (e.g., the determining indicating that the time alignment timer is running) at least until the first slot of the multiple slots, the wireless device may transmit the transport block over the multiple slots via the PUSCH of the cell and using the radio resources of the cell in the multiple slots.

In accordance with various exemplary embodiments in the present disclosure, a device (e.g., a wireless device, a base station and/or alike) may include one or more processors and may include memory that may store instructions. The instructions, when executed by the one or more processors, cause the device to perform actions as illustrated in the accompanying drawings and described in the specification. The order of events or actions, as shown in a flow chart of this disclosure, may occur and/or may be performed in any logically coherent order. In some examples, at least two of the events or actions shown may occur or may be performed at least in part simultaneously and/or in parallel. In some examples, one or more additional events or actions may occur or may be performed prior to, after, or in between the events or actions shown in the flow charts of the present disclosure.

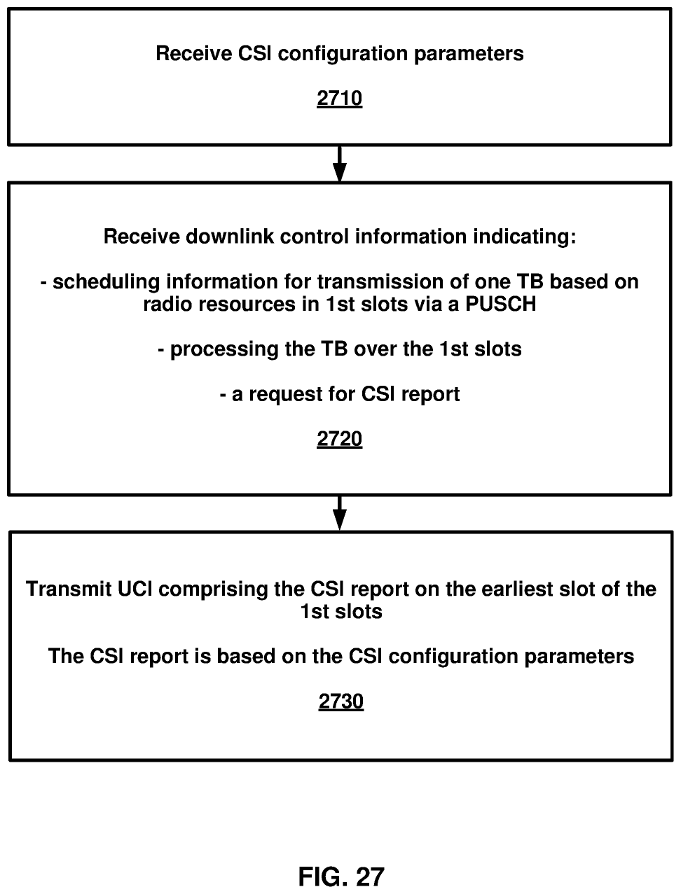

FIG. 27 shows an example flow diagram in accordance with several of various embodiments of the present disclosure. At 2710, a wireless device may receive channel state information configuration parameters. At 2720, the wireless device may receive downlink control information indicating: scheduling information for transmission of one transport block based on radio resources in a first plurality of slots and via a physical uplink shared channel, processing the transport block over the first plurality of slots, and a request for channel state information report. At 2730, based on the downlink control information indicating processing the transport block over a plurality of slots, the wireless device may transmit uplink control information comprising the channel state information report on the earliest slot of the first plurality of slots. The channel state information report may be based on the channel state information configuration parameters.

In an example embodiment, the downlink control information, received at 2720, may indicate a single transmission of a single transport block over the plurality of slots.

In an example embodiment, the first plurality of slots may be consecutive slots.

In an example embodiment, a number of the first plurality of slots may be based on a row of a resource allocation table. In an example embodiment, the wireless device may receive first configuration parameters indicating the resource allocation table. In an example embodiment, downlink control information, received at 2720, may comprise a field with a value indicating the row of the resource allocation table. In an example embodiment, the wireless device may determine a transport block size based on the number. In an example embodiment, one or more allocated symbols in each slot of the plurality of slots may be based on the resource allocation table. In an example embodiment, symbol numbers of allocated symbols in each slot of the first plurality of slots may be the same.

In an example embodiment, the channel state information configuration parameters, received at 2710, may indicate radio resources of one or more channel state information reference signals. The channel state information report, transmitted at 2730, may be based on measuring the one or more channel state information reference signals.

In an example embodiment, the downlink control information, received at 2720, may indicate transmission of a repetition of the transport block over a second plurality of slots after the first plurality of slots.

In an example embodiment, the downlink control information, received at 2720, may indicate a dynamic grant.

In an example embodiment, the wireless device may receive configured grant configuration parameters of a configured grant configuration, wherein the transmission of the transport block may be based on the configured grant configuration parameters.

In an example embodiment, based on the downlink control information indicating processing the transport block over a plurality of slots, the transmission of the transport block may be limited to one transmission layer.

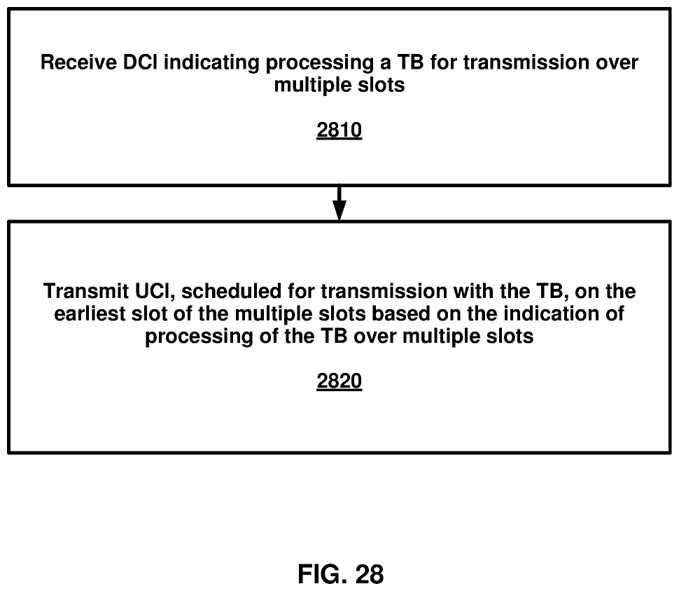

FIG. 28 shows an example flow diagram in accordance with several of various embodiments of the present disclosure. At 2810, a wireless device may receive downlink control information (DCI) indicating processing a transport block for transmission over multiple slots. At 2820, the wireless device may transmit uplink control information, scheduled for transmission with the transport block, on the earliest slot of the multiple slots based on the indication of processing of the transport block being over multiple slots.

In an example embodiment, the uplink control information, transmitted at 2820, may comprise a channel state information (CSI) report. In an example embodiment, the DCI, received at 2810, may indicate a request for transmission of the CSI report. In an example embodiment, the wireless device may receive CSI configuration parameters, wherein the CSI report may be based on the CSI configuration parameters. In an example embodiment, the CSI configuration parameters may indicate radio resources of one or more CSI reference signals. The CSI report may be based on measuring the one or more CSI reference signals.

In an example embodiment, the downlink control information, received at 2810, may indicate a single transmission of a single transport block over the multiple slots and via radio resources in the multiple slots.

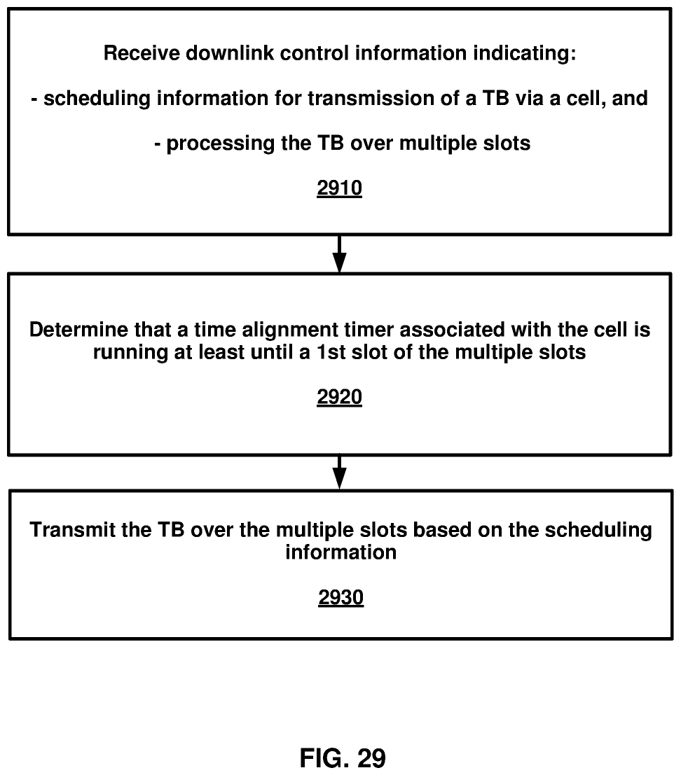

FIG. 29 shows an example flow diagram in accordance with several of various embodiments of the present disclosure. At 2910, a wireless device may receive downlink control information indicating: scheduling information for transmission of a transport block via a cell; and processing the transport block over multiple slots. At 2920, the wireless device may determine that a time alignment timer associated with the cell is running at least until a first slot of the multiple slots. At 2930, the wireless device may transmit the transport block over the multiple slots based on the scheduling information.

In an example embodiment, the transmitting the transport block over the multiple slots, at 2930, may be based on the time alignment timer running at least until the first slot of the multiple slots.

In an example embodiment, the downlink control information, received at 2910, may indicate a single transmission of a single transport block over the multiple slots and via radio resources in the multiple slots.

In an example embodiment, the transmitting the transport block, at 2930, may be via a physical uplink shared channel.

In an example embodiment, a number of the multiple slots may be based on a row of a resource allocation table. In an example embodiment, the wireless device may receive configuration parameters indicating the resource allocation table. In an example embodiment, the wireless device may determine a transport block size based on the number. In an example embodiment, the downlink control information, received at 2910, may comprise a field with a value indicating the row of the resource allocation table.

In an example embodiment, the wireless device may receive configured grant configuration parameters of a configured grant configuration, wherein the transmission of the transport block may be based on the configured grant configuration parameters. In an example embodiment, the downlink control information, received at 2910, may be an activation downlink control information indicating activation of the configured grant configuration.

In an example embodiment, the first slot may be the latest/last slot in the multiple slots.

In an example embodiment, the first slot may be the earliest/beginning slot in the multiple slots.

In an example embodiment, the wireless device may receive a configuration parameter. The wireless device may determine the first slot, in the multiple slots, based on the configuration parameter.

In an example embodiment, the transmitting, at 2930, the transport block may be based on the determining, at 2920, indicating that the time alignment timer is running at least until the first slot.

In an example embodiment, the time alignment timer may be associated with a time alignment group comprising the cell.

In an example embodiment, the time alignment timer may not be running in a second slot of the multiple slots.

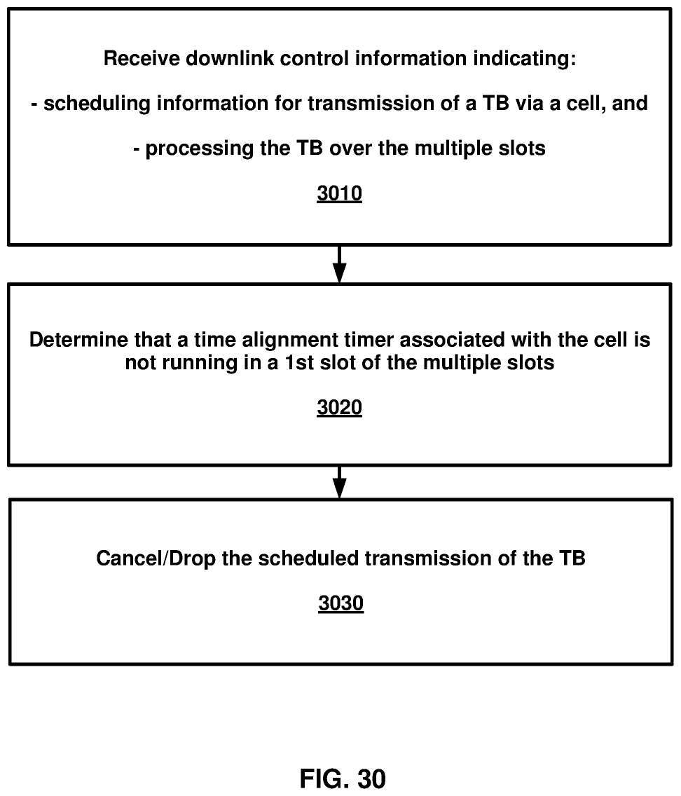

FIG. 30 shows an example flow diagram in accordance with several of various embodiments of the present disclosure. At 3010, a wireless device may receive downlink control information indicating: scheduling information for transmission of a transport block via a cell; and processing the transport block over multiple slots. At 3020, the wireless device may determine that a time alignment timer associated with the cell is not running in a first slot of the multiple slots. At 3030, the wireless device may cancel/drop the scheduled transmission of the transport block.

In an example embodiment, the scheduled transmission of the transport block may be via a physical uplink shared channel.

In an example embodiment, the downlink control information, received at 3010, may indicate a single transmission of a single transport block over the multiple slots and via radio resources in the multiple slots.

In an example embodiment, a number of the multiple slots may be based on a row of a resource allocation table. In an example embodiment, the wireless device may receive configuration parameters indicating the resource allocation table. In an example embodiment, downlink control information, received at 3010, may comprise a field with a value indicating the row of the resource allocation table.

In an example embodiment, the wireless device may receive configured grant configuration parameters of a configured grant configuration, wherein the scheduled transmission of the transport block may be based on the configured grant configuration parameters. In an example embodiment, the downlink control information, received at 3010, may be an activation downlink control information indicating activation of the configured grant configuration.

In an example embodiment, the first slot may be the latest slot in the multiple slots.

In an example embodiment, the first slot may be the earliest/beginning slot in the multiple slots.

In an example embodiment, the wireless device may receive a configuration parameter. The wireless device may determine the first slot based on the configuration parameter.

In an example embodiment, the cancelling/dropping, at 3030, the scheduled transmission of the transport block may be based on the determining indicating that the time alignment timer is not running in the first slot.

In an example embodiment, the time alignment timer may be associated with a time alignment group comprising the cell.

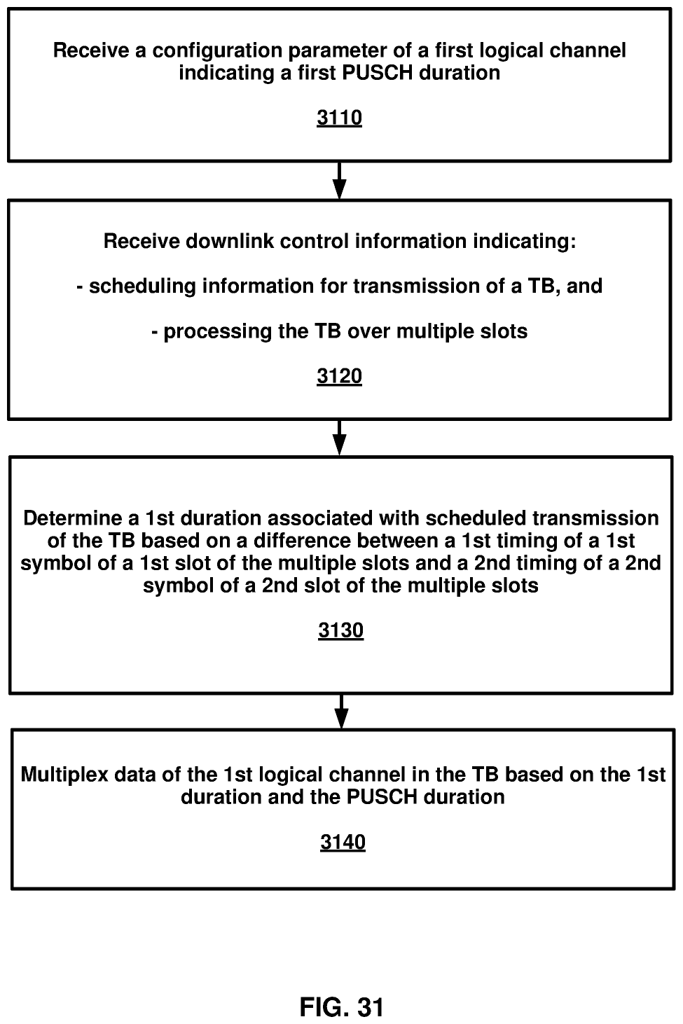

FIG. 31 shows an example flow diagram in accordance with several of various embodiments of the present disclosure. At 3110, a wireless device may receive a configuration parameter of a first logical channel indicating a first physical uplink shared channel (PUSCH) duration. At 3120, the wireless device may receive downlink control information indicating: scheduling information for transmission of a transport block; and processing the transport block over multiple slots. At 3130, the wireless device may determine a first duration associated with scheduled transmission of the transport block based on a difference between a first timing of a first symbol of a first slot of the multiple slots and a second timing of a second symbol of a second slot of the multiple slots. At 3140, the wireless device may multiplex data of the first logical channel in the transport block based on the first duration and the PUSCH duration.

In an example embodiment, the first slot may be the earliest/beginning slot in the multiple slots.

In an example embodiment, the second slot may be the latest/ending slot in the multiple slots.

In an example embodiment, the multiplexing data of the first logical channel, at 3140, may be based on the first duration being smaller than or equal to the PUSCH duration.

In an example embodiment, the wireless device may transmit the transport block via radio resources in the multiple slots. In an example embodiment, the scheduling information, indicated by the downlink control information received at 3120, may indicate the radio resources in the multiple slots.

In an example embodiment, a number of the multiple slots may be based on a row of a resource allocation table. In an example embodiment, the wireless device may receive configuration parameters indicating the resource allocation table. In an example embodiment, the wireless device may determine a transport block size based on the number. In an example embodiment, the downlink control information, received at 3120, may comprise a field with a value indicating the row of the resource allocation table.

In an example embodiment, the wireless device may receive configured grant configuration parameters of a configured grant configuration, wherein transmission of the transport block may be based on the configured grant configuration parameters. In an example embodiment, the downlink control information, received at 3120, may be an activation downlink control information indicating activation of the configured grant configuration.

In an example embodiment, the downlink control information, received at 3120, may indicate a single transmission of a single transport block over radio resources in the multiple slots.

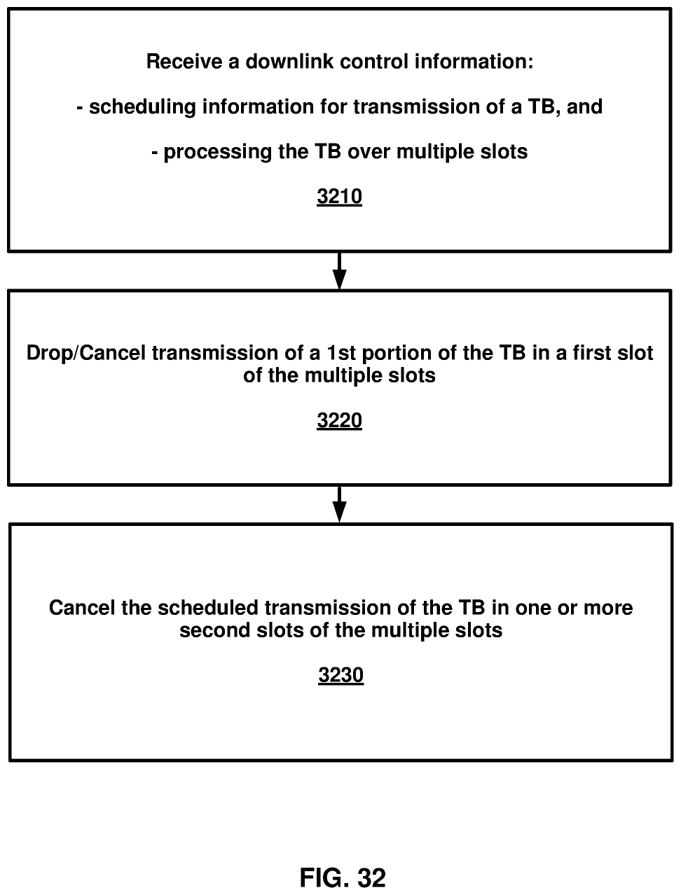

FIG. 32 shows an example flow diagram in accordance with several of various embodiments of the present disclosure. At 3210, a wireless device may receive downlink control information indicating: scheduling information for transmission of a transport block; and processing the transport block over multiple slots. At 3220, the wireless device may drop/cancel transmission of a first portion of the transport block in a first slot of the multiple slots. At 3230, the wireless device may cancel the scheduled transmission of the transport block in one or more second slots of the multiple slots.

In an example embodiment, the first portion of the transport block, dropped/cancelled at 3220, may be scheduled for transmission in one or more symbols of the first slot.

In an example embodiment, the cancelling the scheduled transmission of the transport block, at 3230, may be based on/in response to the dropping/cancelling the transmission of the transport block in the first slot.

In an example embodiment, the one or more second slots, in which the scheduled transmission of the transport block is cancelled at 3230, may be after (e.g., subsequent to) the first slot.

In an example embodiment, the dropping/canceling, at 3220, the transmission of the first portion of the transport block in the first slot may be based on an overlap with a high priority uplink transmission. In an example embodiment, the high priority uplink transmission may be a high priority physical uplink shared channel (PUSCH). In an example embodiment, the high priority uplink transmission may be a high priority uplink control channel.

In an example embodiment, the dropping/cancelling, at 3220, the transmission of the first portion of the transport block in the first slot may be in response to receiving the cancellation indication. In an example embodiment, the receiving the cancellation indication may be based on receiving a cancellation indication downlink control information comprising the cancellation indication. In an example embodiment, the cancellation indication downlink control information may be associated with a cancellation indication radio network temporary identifier.

In an example embodiment, the wireless device may receive configured grant configuration parameters of a configured grant configuration, wherein transmission of the transport block may be based on the configured grant configuration parameters. In an example embodiment, the downlink control information may be an activation downlink control information indicating activation of the configured grant configuration.

In an example embodiment, a number of the multiple slots may be based on a row of a resource allocation table. In an example embodiment, the wireless device may receive first configuration parameters indicating the resource allocation table. In an example embodiment, the wireless device may determine a transport block size based on the number. In an example embodiment, the downlink control information, received at 3210, may comprise a field with a value indicating the row of the resource allocation table.

In an example embodiment, the downlink control information, received at 3210, may indicate a single transmission of a single transport block over the multiple slots and via radio resources in the multiple slots.

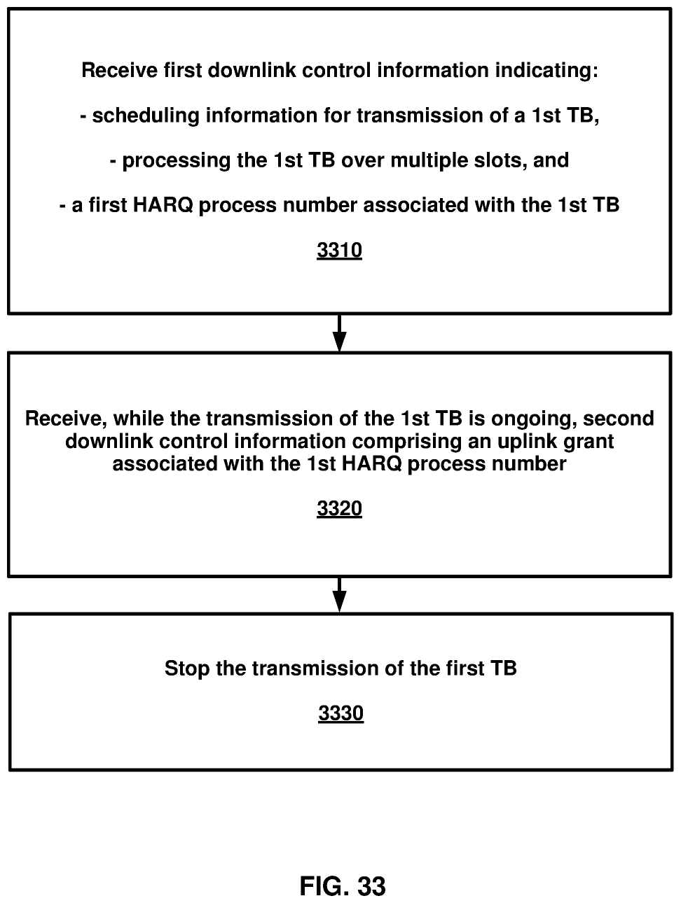

FIG. 33 shows an example flow diagram in accordance with several of various embodiments of the present disclosure. At 3310, a wireless device may receive first downlink control information indicating: scheduling information for transmission of a first transport block; processing the first transport block over multiple slots; and a first hybrid automatic repeat request (HARD) process number associated with the first transport block. At 3320, the wireless device may receive, while the transmission of the first transport block is ongoing, second downlink control information comprising an uplink grant associated with the first HARQ process number. At 3330, the wireless device may stop the transmission of the first transport block.

In an example embodiment, the wireless device may transmit a second transport block based on the uplink grant.

In an example embodiment, the stopping the transmission of the first transport block, at 3330, may be based on (e.g., in response to): receiving, at 3320, the uplink grant while the transmission of the first transport block is ongoing; and the uplink grant being associated with the same HARQ process as the first transport block.

In an example embodiment, the wireless device may flush a HARQ buffer associated with the first HARQ process number in response to receiving the uplink grant at 3320.

In an example embodiment, the second downlink control information, received at 3320, may comprise a new data indicator field with a value indicating an initial transmission of the second transport block.

In an example embodiment, the second downlink control information, received at 3320, may comprise a new data indicator field indicating a retransmission of the first transport block.

In an example embodiment, a number of the multiple slots may be based on a row of a resource allocation table. In an example embodiment, the wireless device may receive first configuration parameters indicating the resource allocation table. In an example embodiment, the wireless device may determine a transport block size based on the number. In an example embodiment, the first downlink control information may comprise a field with a value indicating the row of the resource allocation table.

In an example embodiment, the downlink control information, received at 3310, may indicate a single transmission of a single transport block over the multiple slots and via radio resources in the multiple slots.

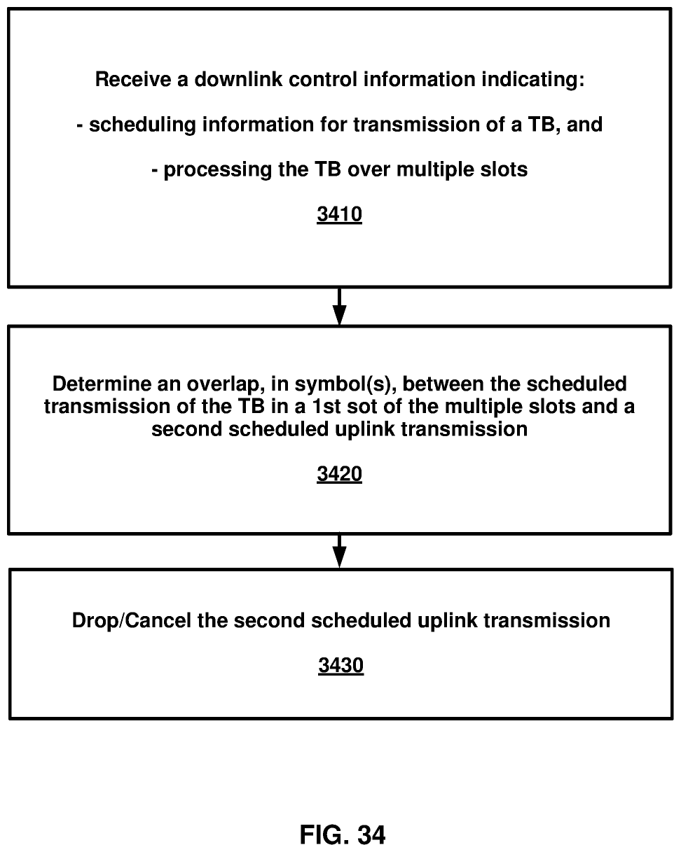

FIG. 34 shows an example flow diagram in accordance with several of various embodiments of the present disclosure. At 3410, a wireless device may receive a downlink control information indicating: scheduling information for transmission of a transport block; and processing the transport block over multiple slots. At 3420, the wireless device may determine an overlap, in one or more symbols, between the scheduled transmission of the transport block in a first slot of the multiple slots and a second scheduled uplink transmission in the first slot. At 3430, the wireless device may drop/cancel the second scheduled uplink transmission.

In an example embodiment, the downlink control information, received at 3410, may indicate a single transmission of a single transport block over the multiple slots and via radio resources in the multiple slots.

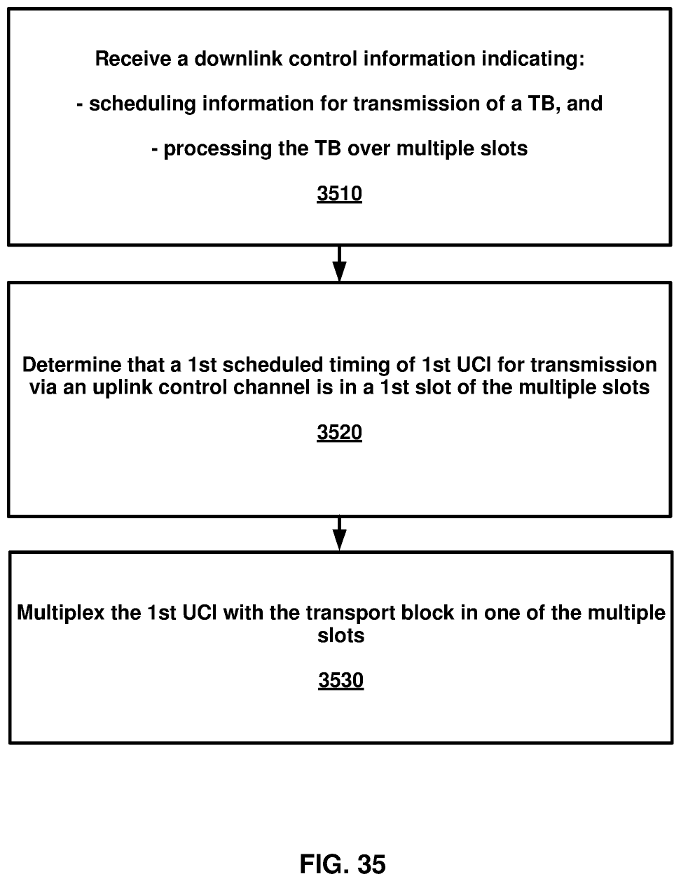

FIG. 35 shows an example flow diagram in accordance with several of various embodiments of the present disclosure. At 3510, a wireless device may receive a downlink control information indicating: scheduling information for transmission of a transport block; and processing the transport block over multiple slots. At 3520, the wireless device may determine that a first scheduled timing of first uplink control information for transmission via an uplink control channel is in a first slot of the multiple slots. At 3530, the wireless device may multiplex the first uplink control information with the transport block in one of the multiple slots.

In an example embodiment, the wireless device may determine a second slot of the multiple slots for multiplexing the first uplink control information.

In an example embodiment, the downlink control information, received at 3510, may indicate a single transmission of a single transport block over the multiple slots and via radio resources in the multiple slots.

Various exemplary embodiments of the disclosed technology are presented as example implementations and/or practices of the disclosed technology. The exemplary embodiments disclosed herein are not intended to limit the scope. Persons of ordinary skill in the art will appreciate that various changes can be made to the disclosed embodiments without departure from the scope. After studying the exemplary embodiments of the disclosed technology, alternative aspects, features and/or embodiments will become apparent to one of ordinary skill in the art. Without departing from the scope, various elements or features from the exemplary embodiments may be combined to create additional embodiments. The exemplary embodiments are described with reference to the drawings. The figures and the flowcharts that demonstrate the benefits and/or functions of various aspects of the disclosed technology are presented for illustration purposes only. The disclosed technology can be flexibly configured and/or reconfigured such that one or more elements of the disclosed embodiments may be employed in alternative ways. For example, an element may be optionally used in some embodiments or the order of actions listed in a flowchart may be changed without departure from the scope.

An example embodiment of the disclosed technology may be configured to be performed when deemed necessary, for example, based on one or more conditions in a wireless device, a base station, a radio and/or core network configuration, a combination thereof and/or alike. For example, an example embodiment may be performed when the one or more conditions are met. Example one or more conditions may be one or more configurations of the wireless device and/or base station, traffic load and/or type, service type, battery power, a combination of thereof and/or alike. In some scenarios and based on the one or more conditions, one or more features of an example embodiment may be implemented selectively.

In this disclosure, the articles “a” and “an” used before a group of one or more words are to be understood as “at least one” or “one or more” of what the group of the one or more words indicate. The use of the term “may” before a phrase is to be understood as indicating that the phrase is an example of one of a plurality of useful alternatives that may be employed in an embodiment in this disclosure.

In this disclosure, an element may be described using the terms “comprises”, “includes” or “consists of” in combination with a list of one or more components. Using the terms “comprises” or “includes” indicates that the one or more components are not an exhaustive list for the description of the element and do not exclude components other than the one or more components. Using the term “consists of” indicates that the one or more components is a complete list for description of the element. In this disclosure, the term “based on” is intended to mean “based at least in part on”. The term “based on” is not intended to mean “based only on”. In this disclosure, the term “and/or” used in a list of elements indicates any possible combination of the listed elements. For example, “X, Y, and/or Z” indicates X; Y; Z; X and Y; X and Z; Y and Z; or X, Y, and Z.

Some elements in this disclosure may be described by using the term “may” in combination with a plurality of features. For brevity and ease of description, this disclosure may not include all possible permutations of the plurality of features. By using the term “may” in combination with the plurality of features, it is to be understood that all permutations of the plurality of features are being disclosed. For example, by using the term “may” for description of an element with four possible features, the element is being described for all fifteen permutations of the four possible features. The fifteen permutations include one permutation with all four possible features, four permutations with any three features of the four possible features, six permutations with any two features of the four possible features and four permutations with any one feature of the four possible features.

Although mathematically a set may be an empty set, the term set used in this disclosure is a nonempty set. Set B is a subset of set A if every element of set B is in set A. Although mathematically a set has an empty subset, a subset of a set is to be interpreted as a non-empty subset in this disclosure. For example, for set A={subcarrier1, subcarrier2}, the subsets are {subcarrier1}, {subcarrier2} and {subcarrier1, subcarrier2}.

In this disclosure, the phrase “based on” may be used equally with “based at least on” and what follows “based on” or “based at least on” indicates an example of one of plurality of useful alternatives that may be used in an embodiment in this disclosure. The phrase “in response to” may be used equally with “in response at least to” and what follows “in response to” or “in response at least to” indicates an example of one of plurality of useful alternatives that may be used in an embodiment in this disclosure. The phrase “depending on” may be used equally with “depending at least on” and what follows “depending on” or “depending at least on” indicates an example of one of plurality of useful alternatives that may be used in an embodiment in this disclosure. The phrases “employing” and “using” and “employing at least” and “using at least” may be used equally in this in this disclosure and what follows “employing” or “using” or “employing at least” or “using at least” indicates an example of one of plurality of useful alternatives that may be used in an embodiment in this disclosure.

The example embodiments disclosed in this disclosure may be implemented using a modular architecture comprising a plurality of modules. A module may be defined in terms of one or more functions and may be connected to one or more other elements and/or modules. A module may be implemented in hardware, software, firmware, one or more biological elements (e.g., an organic computing device and/or a neurocomputer) and/or a combination thereof and/or alike. Example implementations of a module may be as software code configured to be executed by hardware and/or a modeling and simulation program that may be coupled with hardware. In an example, a module may be implemented using general-purpose or special-purpose processors, digital signal processors (DSPs), microprocessors, microcontrollers, application-specific integrated circuits (ASICs), programmable logic devices (PLDs) and/or alike. The hardware may be programmed using machine language, assembly language, high-level language (e.g., Python, FORTRAN, C, C++ or the like) and/or alike. In an example, the function of a module may be achieved by using a combination of the mentioned implementation methods.

What is claimed is:

1. A method comprising:
receiving, by a wireless device, downlink control information indicating:
scheduling information for transmission of one transport block via a physical uplink shared channel of a cell and using radio resources of the cell in multiple slots; and
processing the transport block over the multiple slots;
determining that a time alignment timer associated with the cell is running at least until a first slot of the multiple slots; and
based on the time alignment timer running at least until the first slot of the multiple slots, transmitting the transport block over the multiple slots via the physical uplink shared channel of the cell and based on the scheduling information.

2. The method of claim 1, wherein a number of the multiple slots is based on a row of a resource allocation table.

3. The method of claim 2, further comprising receiving configuration parameters indicating the resource allocation table.

4. The method of claim 2, further comprising determining a transport block size based on the number.

5. The method of claim 2, wherein the downlink control information comprises a field with a value indicating the row of the resource allocation table.

6. The method of claim 1, wherein the first slot is the latest slot in the multiple slots.

7. The method of claim 1, wherein the first slot is the earliest slot in the multiple slots.

8. The method of claim 1, wherein the time alignment timer is not running in a second slot of the multiple slots.

9. The method of claim 1, further comprising receiving configured grant configuration parameters of a configured grant configuration, wherein the transmission of the transport block is based on the configured grant configuration parameters.

10. The method of claim 1, further comprising:
receiving a configuration parameter; and
determining the first slot, in the multiple slots, based on the configuration parameter.

11. A wireless device comprising:
one or more processors; and
memory storing instructions that, when executed by the one or more processors, cause the wireless device to:
receive downlink control information indicating:
scheduling information for transmission of one transport block via a physical uplink shared channel of a cell and using radio resources of the cell in multiple slots; and
processing the transport block over the multiple slots;
determine that a time alignment timer associated with the cell is running at least until a first slot of the multiple slots; and
based on the time alignment timer running at least until the first slot of the multiple slots, transmit the transport block over the multiple slots via the physical uplink shared channel of the cell and based on the scheduling information.

12. The wireless device of claim 11, wherein a number of the multiple slots is based on a row of a resource allocation table.

13. The wireless device of claim 12, wherein the instructions, when executed by the one or more processors, further cause the wireless device to receive configuration parameters indicating the resource allocation table.

14. The wireless device of claim 12, wherein the instructions, when executed by the one or more processors, further cause the wireless device to determine a transport block size based on the number.

15. The wireless device of claim 12, wherein the downlink control information comprises a field with a value indicating the row of the resource allocation table.

16. The wireless device of claim 11, wherein the first slot is the latest slot in the multiple slots.

17. The wireless device of claim 11, wherein the first slot is the earliest slot in the multiple slots.

18. The wireless device of claim 11, wherein the time alignment timer is not running in a second slot of the multiple slots.

19. The wireless device of claim 11, wherein the instructions, when executed by the one or more processors, further cause the wireless device to receive configured grant configuration parameters of a configured grant configuration, wherein the transmission of the transport block is based on the configured grant configuration parameters.

20. A system comprising:
a base station; and
a wireless device comprising: one or more processors; and memory storing instructions that, when executed by the one or more processors, cause the wireless device to: receive, from the base station, downlink control information indicating: scheduling information for transmission of one transport block via a physical uplink shared channel of a cell and using radio resources of the cell in multiple slots; and processing the transport block over the multiple slots; determine that a time alignment timer associated with the cell is running at least until a first slot of the multiple slots; and based on the time alignment timer running at least until the first slot of the multiple slots, transmit the transport block over the multiple slots via the physical uplink shared channel of the cell and based on the scheduling information.
